(19) United States
(12) Patent Application Publication
(10) Pub. No.: US 2017/0094251 A1
(43) Pub. Date: Mar. 30, 2017

(54) THREE-DIMENSIONAL IMAGER THAT INCLUDES A DICHROIC CAMERA

(71) Applicant: FARO Technologies, Inc., Lake Mary, FL (US)

(72) Inventors: Matthias Wolke, Korntal-Münchingen (DE); Denis Wohlfeld, Ludwigsburg (DE); Rolf Heidemann, Stuttgart (DE); Robert E. Bridges, Kennett Square, PA (US)

(21) Appl. No.: 15/268,749

(22) Filed: Sep. 19, 2016

Related U.S. Application Data
(60) Provisional application No. 62/234,739, filed on Sep. 30, 2015.
(60) Provisional application No. 62/234,796, filed on Sep. 30, 2015.
(60) Provisional application No. 62/234,869, filed on Sep. 30, 2015.
(60) Provisional application No. 62/234,914, filed on Sep. 30, 2015.
(60) Provisional application No. 62/234,951, filed on Sep. 30, 2015.
(60) Provisional application No. 62/234,973, filed on Sep. 30, 2015.
(60) Provisional application No. 62/234,987, filed on Sep. 30, 2015.
(60) Provisional application No. 62/235,011, filed on Sep. 30, 2015.

(51) Int. Cl. H04N 13/02; G02B 27/10; G06T 7/00

(52) U.S. Cl. CPC H04N 13/025; H04N 13/0253; H04N 13/0257; G06T 7/0075; G02B 27/1013

(57) ABSTRACT

A three-dimensional measuring system includes a body, an internal projector attached to the body, and a dichroic camera assembly, the dichroic camera assembly including a first beam splitter that directs a first portion of incoming light into a first channel leading to a first photosensitive array and a second portion of the incoming light into a second channel leading to a second photosensitive array.

### CROSS REFERENCE TO RELATED APPLICATIONS

This application claims the benefit of U.S. Provisional Patent Application No. 62/234,739, filed on Sep. 30, 2015, U.S. Provisional Patent Application No. 62/234,796, filed on Sep. 30, 2015, U.S. Provisional Patent Application No. 62/234,869, filed on Sep. 30, 2015, U.S. Provisional Patent Application No. 62/234,914, filed on Sep. 30, 2015, U.S. Provisional Patent Application No. 62/234,951, filed on Sep. 30, 2015, U.S. Provisional Patent Application No. 62/234,973, filed on Sep. 30, 2015, U.S. Provisional Patent Application No. 62/234,987, filed on Sep. 30, 2015, and U.S. Provisional Patent Application No. 62/235,011, filed on Sep. 30, 2015, the entire contents all of which are incorporated herein by reference.

### FIELD OF THE INVENTION

The subject matter disclosed herein relates in general to devices such as three-dimensional (3D) imagers and stereo cameras that use triangulation to determine 3D coordinates.

### BACKGROUND OF THE INVENTION

Three-dimensional imagers and stereo cameras use a triangulation method to measure the 3D coordinates of points on an object. A 3D imager usually includes a projector that projects onto a surface of the object either a pattern of light as a line or a pattern of light covering an area. A camera is coupled to the projector in a fixed relationship. The light emitted from the projector is reflected off of the object surface and detected by the camera. A correspondence is determined among points on a projector plane and points on a camera plane. Since the camera and projector are arranged in a fixed relationship, the distance to the object may be determined using trigonometric principles. A correspondence among points observed by two stereo cameras may likewise be used with a triangulation method to determine 3D coordinates. Compared to coordinate measurement devices that use tactile probes, triangulation systems provide advantages in quickly acquiring coordinate data over a large area. As used herein, the resulting collection of 3D coordinate values or data points of the object being measured by the triangulation system is referred to as point-cloud data or simply a point cloud.

There are a number of areas in which existing triangulation devices may be improved: combining 3D and color information, capturing 3D and motion information from multiple perspectives and over a wide field-of-view, calibrating/compensating 3D imagers, and registering 3D imagers.

Accordingly, while existing triangulation-based 3D imager devices that use photogrammetry methods are suitable for their intended purpose, the need for improvement remains.

### BRIEF DESCRIPTION OF THE INVENTION

According to an embodiment of the present invention, a three-dimensional (3D) measuring system includes: a body; an internal projector fixedly attached to the body, the internal projector configured to project an illuminated pattern of light onto an object; and a first dichroic camera assembly fixedly attached to the body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the illuminated pattern on the object, the second photosensitive array being configured to capture a second channel image of the illuminated pattern on the object, the first dichroic camera assembly having a first pose relative to the internal projector, wherein the 3D measuring system is configured to determine 3D coordinates of a first point on the object based at least in part on the illuminated pattern, the second channel image, and the first pose.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIGS. 1A and 1B are schematic representations of a 3D imager and a stereo camera pair, respectively, according to an embodiment;

FIG. 1C is a schematic representation of a projector that includes a diffractive optical element to produce a projected pattern of light according to an embodiment;

FIG. 2 is a schematic representation of a 3D imager having two cameras and a projector according to an embodiment;

FIG. 3 is a perspective view of a 3D imager having two cameras and a projector according to an embodiment;

FIGS. 4A and 4B show epipolar geometry for two reference planes and three reference planes, respectively, according to an embodiment;

FIGS. 5A and 5B show two implementations of a two-sensor dichroic camera assembly according to embodiments;

FIG. 6A is a block diagram of a 3D imager having a two-sensor dichroic camera according to an embodiment;

FIG. 6B is a block diagram of a stereo camera assembly having a plurality of two-sensor dichroic cameras according to an embodiment;

FIG. 7A is a block diagram of a 3D imager including a two-sensor dichroic camera and an auxiliary projector according to an embodiment;

FIG. 7B is a block diagram of a 3D imager that includes two two-sensor dichroic cameras according to an embodiment;

FIG. 8A is a block diagram of a 3D imager having a two-sensor dichroic camera used in combination with an external projector according to an embodiment;

FIG. 8B is a block diagram of a 3D imager having two two-sensor dichroic cameras used in combination with an internal projector and an external projector;

FIG. 9 is a perspective view of an 3D measuring device meant to represent the generic category of 3D imagers and stereo cameras that include at least one two-sensor dichroic camera according to an embodiment;

FIGS. 10A and 10B are perspective drawings showing an external projector assisting in registration of a generic 3D imager device located in a first position and a second position, respectively, according to an embodiment;

FIG. 11 shows an external projector assisting in registration of a generic 3D imager device carried by a mobile robotic arm according to an embodiment;

FIG. 12A is a block diagram of a 3D imager having separated projector and two-sensor dichroic camera according to an embodiment;

FIG. 12B is a block diagram of a stereo camera assembly having two separated two-sensor dichroic cameras according to an embodiment;

FIG. 12C is a block diagram of a 3D imager having separated triangulation projector, two-sensor dichroic camera, and auxiliary projector according to an embodiment;

FIG. 12D is a block diagram of a 3D imager having two separated two-sensor dichroic cameras and a separated projector according to an embodiment;

FIG. 13 illustrates capturing 3D coordinates of a moving object by a plurality of two-sensor dichroic cameras used in combination with a plurality of projectors according to an embodiment;

FIG. 14 illustrates capturing of 3D coordinates of a moving object by plurality of rotating two-sensor dichroic cameras used in combination with a plurality of rotating projectors according to an embodiment;

FIG. 15 is a perspective view of a rotating camera mounted on a motorized stand according to an embodiment;

FIG. 16 illustrates obtaining 3D coordinates by tracking a moving object with two rotating two-sensor dichroic cameras used in combination with a rotating projector according to an embodiment;

FIG. 17A illustrates a method of calibrating/compensating two rotatable stereo cameras using a calibration target mounted on a motorized stand according to an embodiment;

FIG. 17B illustrates a method of calibrating/compensating a 3D imager that includes a rotatable stereo camera in combination with a rotatable projector, the calibration/compensation performed with a calibration target mounted on a motorized stand according to an embodiment;

FIG. 17C illustrates a method of calibrating/compensating a 3D imager that includes two rotatable stereo cameras in combination with a rotatable projector, the calibration/compensation performed with a calibration target mounted on a motorized stand according to an embodiment;

FIGS. 18A and 18B illustrate a method of calibrating/compensating a 3D imager that includes two rotatable stereo cameras performed with a calibration target fixedly mounted according to an embodiment;

FIG. 19 illustrates a method of calibrating/compensating two rotatable cameras mounted on motorized stands by measuring targets fixed in relation to each of the cameras according to an embodiment;

FIG. 20 illustrates a method of calibrating/compensating two rotatable cameras by measuring targets located on a bar and moved by a mobile robotic arm according to an embodiment;

FIG. 21A illustrates propagation of light rays through a camera lens entrance and exit pupils onto a photosensitive array;

FIG. 21B illustrates a simplified model representing propagation of light rays through a perspective center;

FIGS. 22A and 22B illustrate a method for cooperatively using videogrammetry and pattern projection to determine 3D coordinates of objects according to an embodiment;

FIG. 23 illustrates a method of capturing 3D coordinates of a moving object from a variety of different perspectives according to an embodiment;

FIG. 24 is a perspective view of a generic 3D imager that further includes multiple registration targets according to an embodiment;

FIG. 25A illustrates a method of determining the pose of the generic 3D imager by using two rotating cameras according to an embodiment;

FIG. 25B is a perspective view of a handheld generic 3D imager according to an embodiment;

FIG. 26A illustrates projection of a coarse sine-wave pattern according to an embodiment;

FIG. 26B illustrates reception of the coarse sine-wave pattern by a camera lens according to an embodiment;

FIG. 26C illustrates projection of a finer sine-wave pattern according to an embodiment;

FIG. 26D illustrates reception of the finer sine-wave pattern according to an embodiment;

FIG. 27 illustrates how phase is determined from a set of shifted sine waves according to an embodiment;

FIG. 28A is a perspective view of a handheld tactile probe measuring 3D coordinates of an object surface through tracking of probe targets by two rotatable cameras according to an embodiment;

FIG. 28B is a perspective view of a handheld laser line scanner measuring 3D coordinates of an object surface through tracking of probe targets by two rotatable cameras according to an embodiment;

FIG. 28C is a perspective view of a handheld tactile probe and laser line scanner measuring 3D coordinates of an object surface through tracking of probe targets by two rotatable cameras according to an embodiment;

FIG. 29 illustrates the principle of operation of a laser line scanner according to an embodiment;

FIG. 30 is a perspective view of a handheld tactile probe measuring 3D coordinates of an object surface through tracking of probe targets by two rotatable cameras and a projector according to an embodiment;

FIG. 31 is a perspective view of a system for measuring 3D coordinates of an object surface by projecting and imaging light from a rotating camera-projector and also imaging the light by rotating camera according to an embodiment;

FIG. 32 is a schematic illustration of cameras and projectors measuring a fine pattern to determine their angles of rotation according to an embodiment; and

FIG. 33 is a block diagram of a computing system according to an embodiment.

The detailed description explains embodiments of the invention, together with advantages and features, by way of example with reference to the drawings.

### DETAILED DESCRIPTION OF THE INVENTION

Embodiments of the present invention provide advantages in combining 3D and color information, capturing 3D and motion information from multiple perspectives and over a wide field-of-view, calibrating/compensating 3D imagers, and registering 3D imagers.

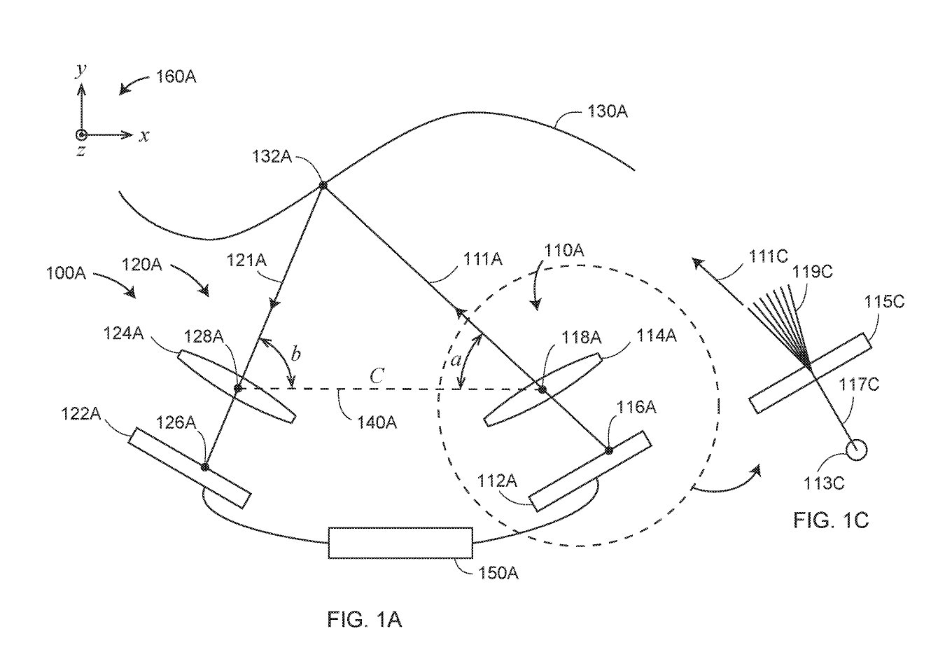

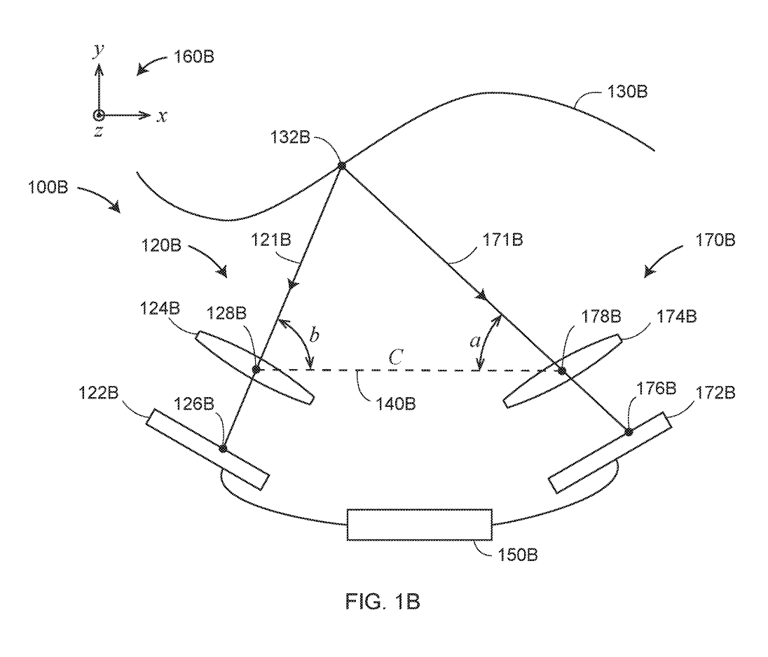

FIG. 1A shows a triangulation scanner (3D imager) 100A that projects a pattern of light over an area on a surface 130A. Another name for a structured light triangulation scanner is a 3D imager. The scanner 100A, which has a frame of reference 160A, includes a projector 110A and a camera 120A. In an embodiment, the projector 110A includes an illuminated projector pattern generator 112A, a projector lens 114A, and a perspective center 118A through which a ray of light 111A emerges. The ray of light 111A emerges from a corrected point 116A having a corrected position on the pattern generator 112A. In an embodiment, the point 116A has been corrected to account for aberrations of the projector, including aberrations of the lens 114A, in order to cause the ray to pass through the perspective center 118A, thereby simplifying triangulation calculations.

In an alternative embodiment shown in FIG. 1C, the projector includes a light source 113C and a diffractive optical element 115C. The light source emits a beam of light 117C, which might for example be a collimated beam of laser light. The light 117C passes through the diffractive optical element 115C, which diffracts the light into a diverging pattern of light 119C. In an embodiment, the pattern includes a collection of illuminated elements that are projected in two dimensions. In an embodiment, the pattern includes a two-dimensional grid of spots, each of the spots essentially the same as the other projected spots except in their direction of propagation. In another embodiment, the projected spots are not identical. For example, the diffractive optical element may be configured to produce some spots that are brighter than others. One of the projected rays of light 111C has an angle corresponding to the angle a in FIG. 1A.

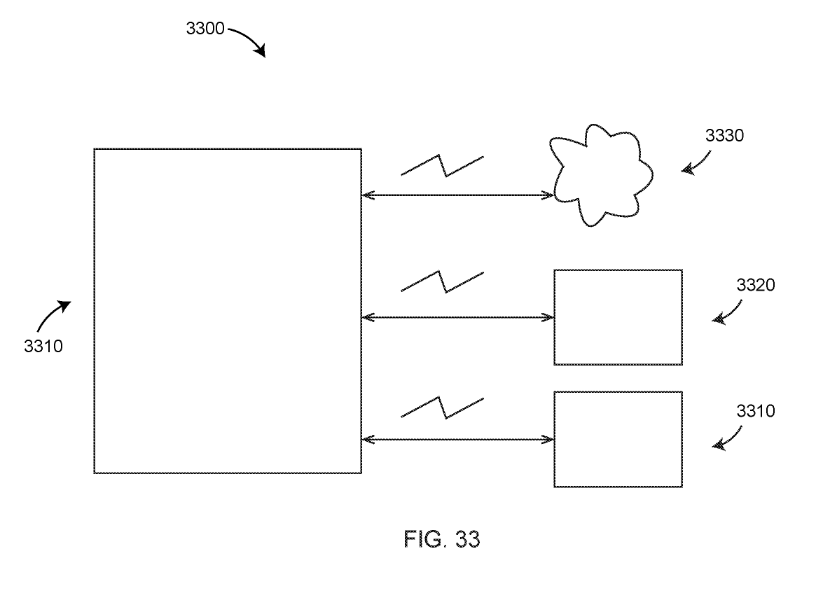

The ray of light 111A intersects the surface 130A in a point 132A, which is reflected (scattered) off the surface and sent through the camera lens 124A to create a clear image of the pattern on the surface 130A on the surface of a photosensitive array 122A. The light from the point 132A passes in a ray 121A through the camera perspective center 128A to form an image spot at the corrected point 126A. The position of the image spot is mathematically adjusted to correct for aberrations in the camera lens. A correspondence is obtained between the point 126A on the photosensitive array 122A and the point 116A on the illuminated projector pattern generator 112A. As explained herein below, the correspondence may be obtained by using a coded or an uncoded pattern of projected light. In some cases, the pattern of light may be projected sequentially. Once the correspondence is known, the angles a and b in FIG. 1A may be determined. The baseline 140A, which is a line segment drawn between the perspective centers 118A and 128A, has a length C. Knowing the angles a, b and the length C, all the angles and side lengths of the triangle 128A-132A-118A may be determined. Digital image information is transmitted to a processor 150A, which determines 3D coordinates of the surface 130A. The processor 150A may also instruct the illuminated pattern generator 112A to generate an appropriate pattern. The processor 150A may be located within the scanner assembly, or it may be in an external computer, or a remote server, as discussed further herein below in reference to FIG. 33.

FIG. 1B shows a stereo camera 100B that receives a pattern of light from an area on a surface 130B. The stereo camera 100B, which has a frame of reference 160B, includes a first camera 120B and a second camera 170B. The first camera 120B includes a first camera lens 124B and a first photosensitive array 122B. The first camera 120B has a first camera perspective center 128B through which a ray of light 121B passes from a point 132B on the surface 130B onto the first photosensitive array 122B as a corrected image spot 126B. The position of the image spot is mathematically adjusted to correct for aberrations in the camera lens.

The second camera 170B includes a second camera lens 174B and a second photosensitive array 172B. The second camera 170B has a second camera perspective center 178B through which a ray of light 171B passes from the point 132B onto the second photosensitive array 172B as a corrected image spot 176B. The position of the image spot is mathematically adjusted to correct for aberrations in the camera lens.

A correspondence is obtained between the point 126B on the first photosensitive array 122B and the point 176B on the second photosensitive array 172B. As explained herein below, the correspondence may be obtained, for example, using “active triangulation” based on projected patterns or fiducial markers or on “passive triangulation” in which natural features are matched on each of the camera images. Once the correspondence is known, the angles a and b in FIG. 1B may be determined. The baseline 140B, which is a line segment drawn between the perspective centers 128B and 178B, has a length C. Knowing the angles a, b and the length C, all the angles and side lengths of the triangle 128B-132B-178B may be determined. Digital image information is transmitted to a processor 150B, which determines 3D coordinates of the surface 130B. The processor 150B may be located within the stereo camera assembly, or it may be in an external computer, or a remote server, as discussed further herein below in reference to FIG. 33.

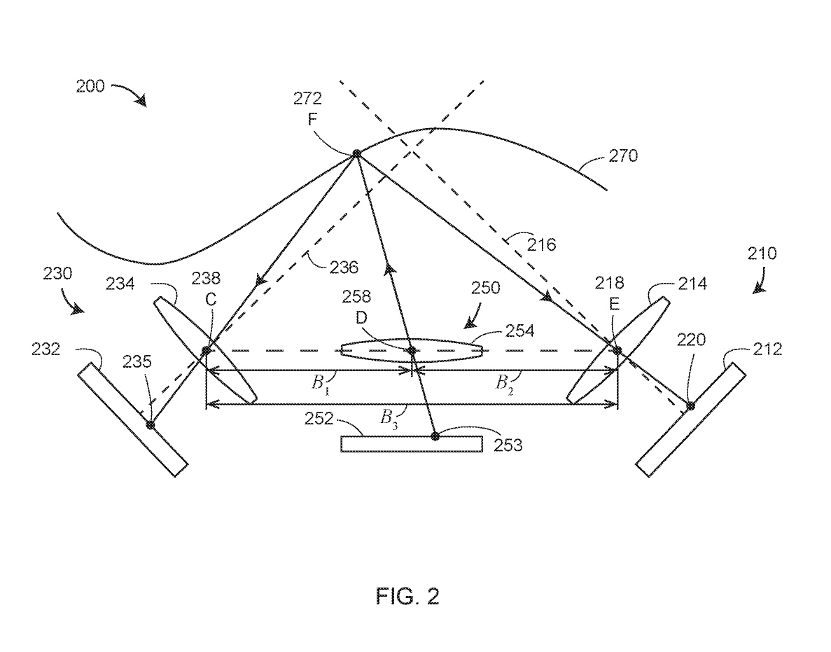

FIG. 2 shows a structured light triangulation scanner 200 having a projector 250, a first camera 210, and a second camera 230. The projector 250 creates a pattern of light on a pattern generator plane 252, which it projects from a corrected point 253 on the pattern through a perspective center 258 (point D) of the lens 254 onto an object surface 270 at a point 272 (point F). The point 272 is imaged by the first camera 210 by receiving a ray of light from the point 272 through a perspective center 218 (point E) of a lens 214 onto the surface of a photosensitive array 212 of the camera as a corrected point 220. The point 220 is corrected in the read-out data by applying a correction factor to remove the effects of lens aberrations. The point 272 is likewise imaged by the second camera 230 by receiving a ray of light from the point 272 through a perspective center 238 (point C) of the lens 234 onto the surface of a photosensitive array 232 of the second camera as a corrected point 235. It should be understood that any reference to a lens in this document refers not only to an individual lens but to a lens system, including an aperture within the lens system.

The inclusion of two cameras 210 and 230 in the system 200 provides advantages over the device of FIG. 1A that includes a single camera. One advantage is that each of the two cameras has a different view of the point 272 (point F). Because of this difference in viewpoints, it is possible in some cases to see features that would otherwise be obscured—for example, seeing into a hole or behind a blockage. In addition, it is possible in the system 200 of FIG. 2 to perform three triangulation calculations rather than a single triangulation calculation, thereby improving measurement accuracy. A first triangulation calculation can be made between corresponding points in the two cameras using the triangle CEF with the baseline B₃. A second triangulation calculation can be made based on corresponding points of the first camera and the projector using the triangle DEF with the baseline B₂. A third triangulation calculation can be made based on corresponding points of the second camera and the projector using the triangle CDF with the baseline B₁. The optical axis of the first camera 220 is 216, and the optical axis of the second camera 230 is 236.

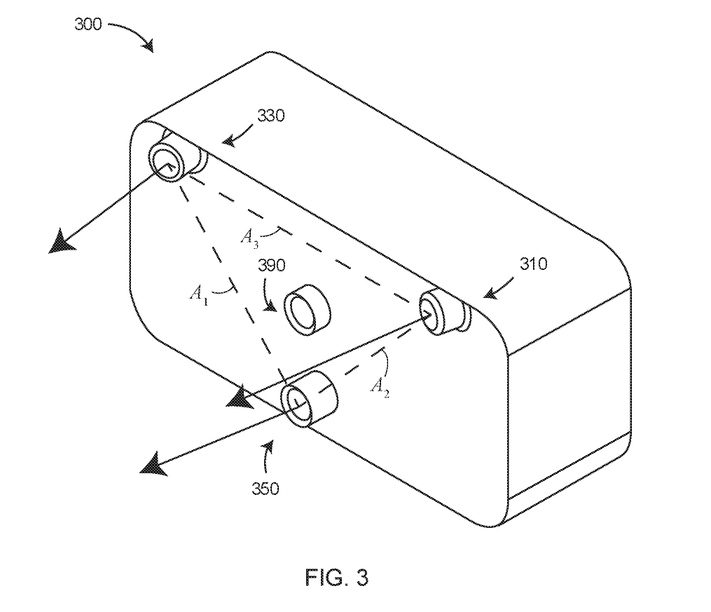

FIG. 3 shows 3D imager 300 having two cameras 310, 330 and a projector 350 arranged in a triangle A₁-A₂-A₃. In an embodiment, the 3D imager 300 of FIG. 3 further includes a camera 390 that may be used to provide color (texture) information for incorporation into the 3D image. In addition, the camera 390 may be used to register multiple 3D images through the use of videogrammetry.

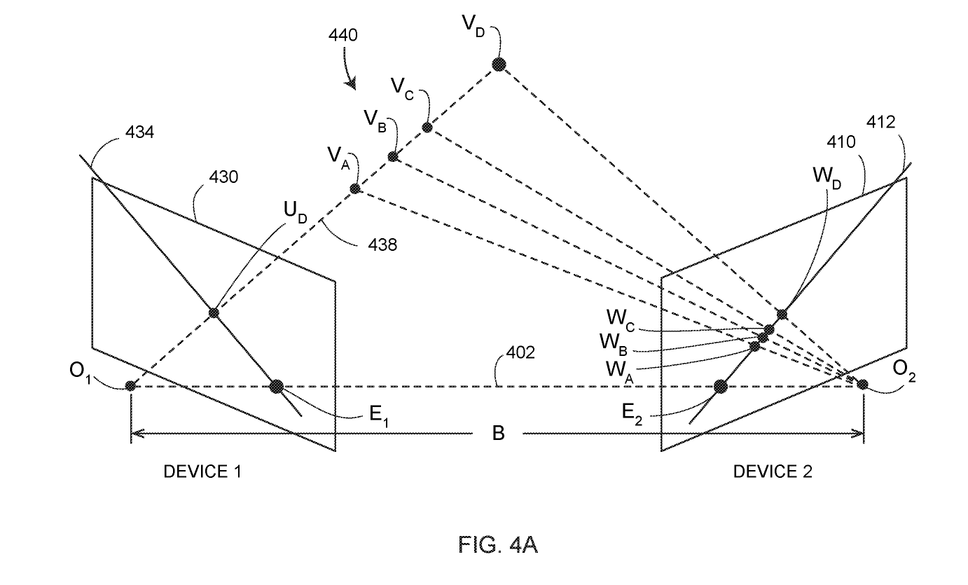

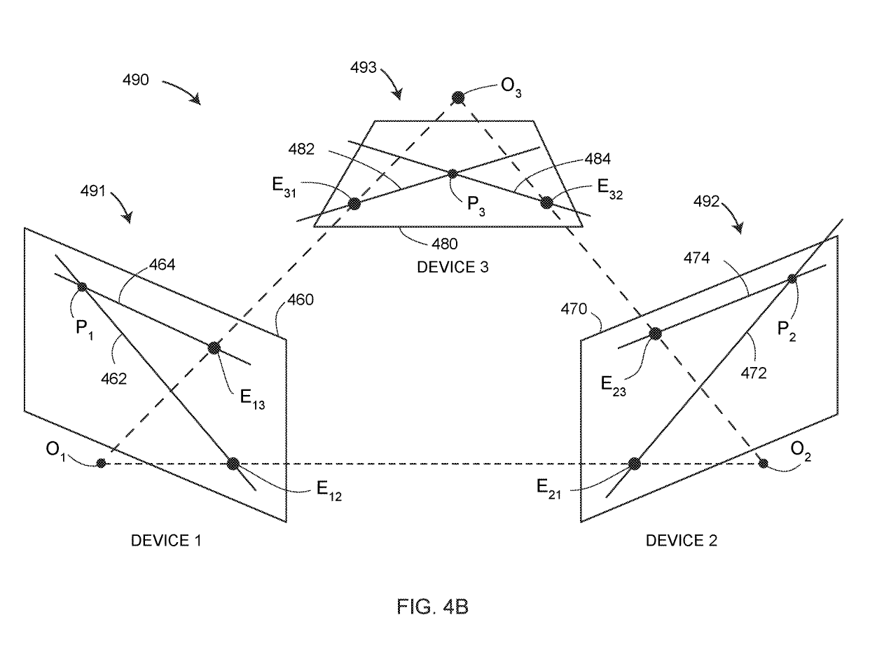

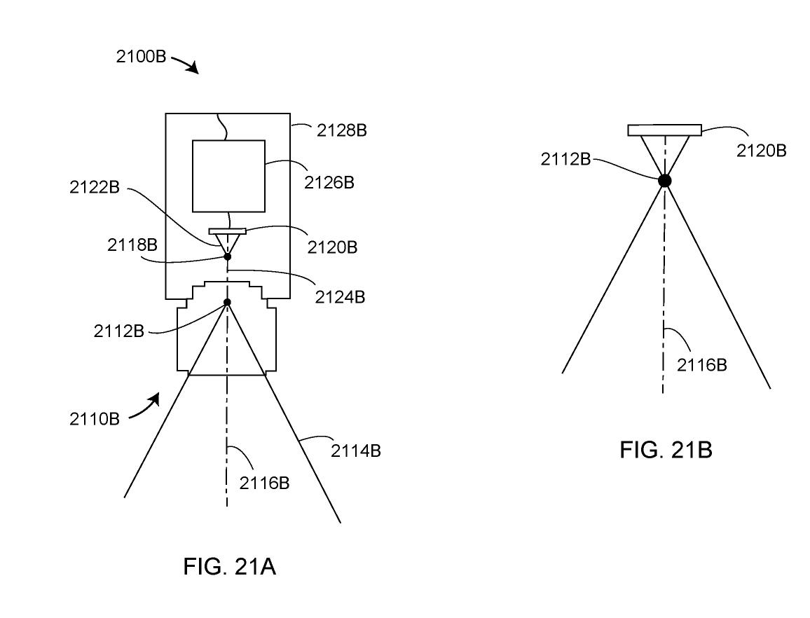

This triangular arrangement provides additional information beyond that available for two cameras and a projector arranged in a straight line as illustrated in FIG. 2. The additional information may be understood in reference to FIG. 4A, which explains the concept of epipolar constraints, and FIG. 4B, which explains how epipolar constraints are advantageously applied to the triangular arrangement of the 3D imager 300. In FIG. 4A, a 3D triangulation instrument 440 includes a device 1 and a device 2 on the left and right sides, respectively. Device 1 and device 2 may be two cameras or device 1 and device 2 may be one camera and one projector. Each of the two devices, whether a camera or a projector, has a perspective center, O₁ and O₂, and a reference plane, 430 or 410. The perspective centers are separated by a baseline distance B, which is the length of the line 402 between O₁ and O₂. The concept of perspective center is discussed in more detail in reference to FIGS. 21A and 21B. The perspective centers O₁, O₂ are points through which rays of light may be considered to travel, either to or from a point on an object. These rays of light either emerge from an illuminated projector pattern, such as the pattern on illuminated projector pattern generator 112A of FIG. 1A, or impinge on a photosensitive array, such as the photosensitive array 122A of FIG. 1A. As can be seen in FIG. 1A, the lens 114A lies between the illuminated object point 132A and plane of the illuminated object projector pattern generator 112A. Likewise, the lens 124A lies between the illuminated object point 132A and the plane of the photosensitive array 122A, respectively. However, the pattern of the front surface planes of devices 112A and 122A would be the same if they were moved to appropriate positions opposite the lenses 114A and 124A, respectively. This placement of the reference planes 430, 410 is applied in FIG. 4A, which shows the reference planes 430, 410 between the object point and the perspective centers O₁, O₂.

In FIG. 4A, for the reference plane 430 angled toward the perspective center O₂ and the reference plane 410 angled toward the perspective center O₁, a line 402 drawn between the perspective centers O₁ and O₂ crosses the planes 430 and 410 at the epipole points E₁, E₂, respectively. Consider a point U_{D} on the plane 430. If device 1 is a camera, it is known that an object point that produces the point U_{D} on the image must lie on the line 438. The object point might be, for example, one of the points V_{A}, V_{B}, V_{C}, or V_{D}. These four object points correspond to the points W_{A}, W_{B}, W_{C}, W_{D}, respectively, on the reference plane 410 of device 2. This is true whether device 2 is a camera or a projector. It is also true that the four points lie on a straight line 412 in the plane 410. This line, which is the line of intersection of the reference plane 410 with the plane of O₁-O₂-U_{D}, is referred to as the epipolar line 412. It follows that any epipolar line on the reference plane 410 passes through the epipole E₂. Just as there is an epipolar line on the reference plane of device 2 for any point on the reference plane of device 1, there is also an epipolar line 434 on the reference plane of device 1 for any point on the reference plane of device 2.

FIG. 4B illustrates the epipolar relationships for a 3D imager 490 corresponding to 3D imager 300 of FIG. 3 in which two cameras and one projector are arranged in a triangular pattern. In general, the device 1, device 2, and device 3 may be any combination of cameras and projectors as long as at least one of the devices is a camera. Each of the three devices 491, 492, 493 has a perspective center O₁, O₂, O₃, respectively, and a reference plane 460, 470, and 480, respectively. Each pair of devices has a pair of epipoles. Device 1 and device 2 have epipoles E₁₂, E₂₁ on the planes 460, 470, respectively. Device 1 and device 3 have epipoles E₁₃, E₃₁, respectively on the planes 460, 480, respectively. Device 2 and device 3 have epipoles E₂₃, E₃₂ on the planes 470, 480, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

Consider the situation of FIG. 4B in which device 3 is a projector, device 1 is a first camera, and device 2 is a second camera. Suppose that a projection point P₃, a first image point P₁, and a second image point P₂ are obtained in a measurement. These results can be checked for consistency in the following way.

To check the consistency of the image point P₁, intersect the plane P₃-E₃₁-E₁₃ with the reference plane 460 to obtain the epipolar line 464. Intersect the plane P₂-E₂₁-E₁₂ to obtain the epipolar line 462. If the image point P₁ has been determined consistently, the observed image point P₁ will lie on the intersection of the calculated epipolar lines 462 and 464.

To check the consistency of the image point P₂, intersect the plane P₃-E₃₂-E₂₃ with the reference plane 470 to obtain the epipolar line 474. Intersect the plane P₁-E₁₂-E₂₁ to obtain the epipolar line 472. If the image point P₂ has been determined consistently, the observed image point P₂ will lie on the intersection of the calculated epipolar lines 472 and 474.

To check the consistency of the projection point P₃, intersect the plane P₂-E₂₃-E₃₂ with the reference plane 480 to obtain the epipolar line 484. Intersect the plane P₁-E₁₃-E₃₁ to obtain the epipolar line 482. If the projection point P₃ has been determined consistently, the projection point P₃ will lie on the intersection of the calculated epipolar lines 482 and 484.

The redundancy of information provided by using a 3D imager 300 having a triangular arrangement of projector and cameras may be used to reduce measurement time, to identify errors, and to automatically update compensation/calibration parameters.

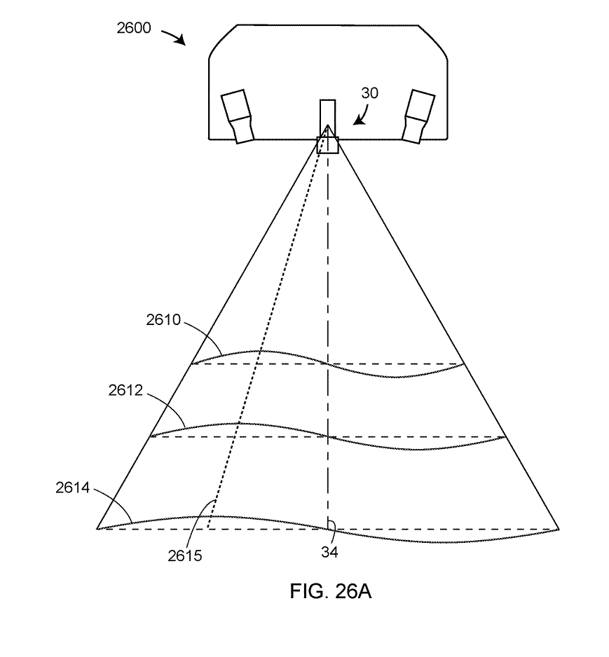

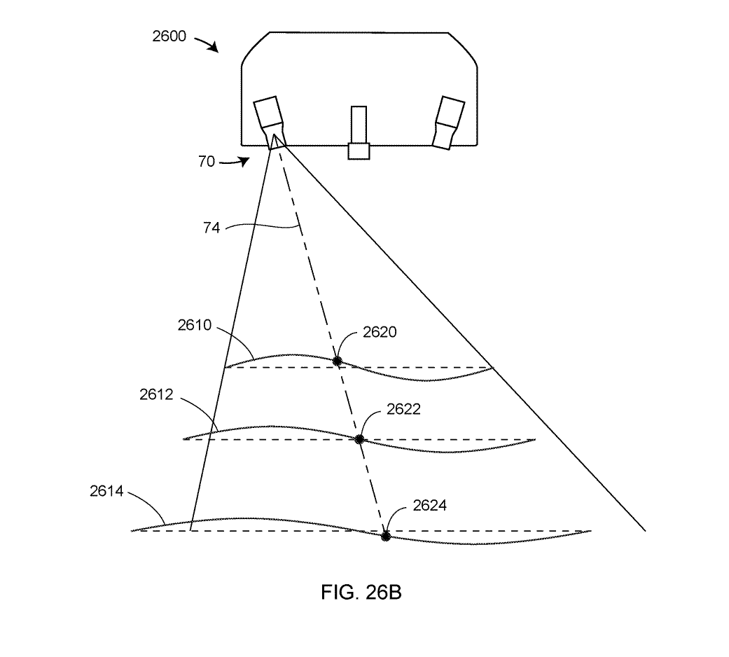

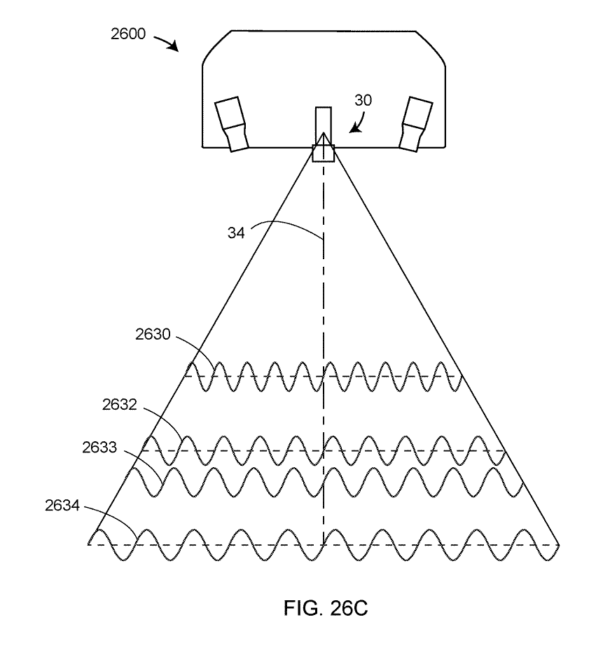

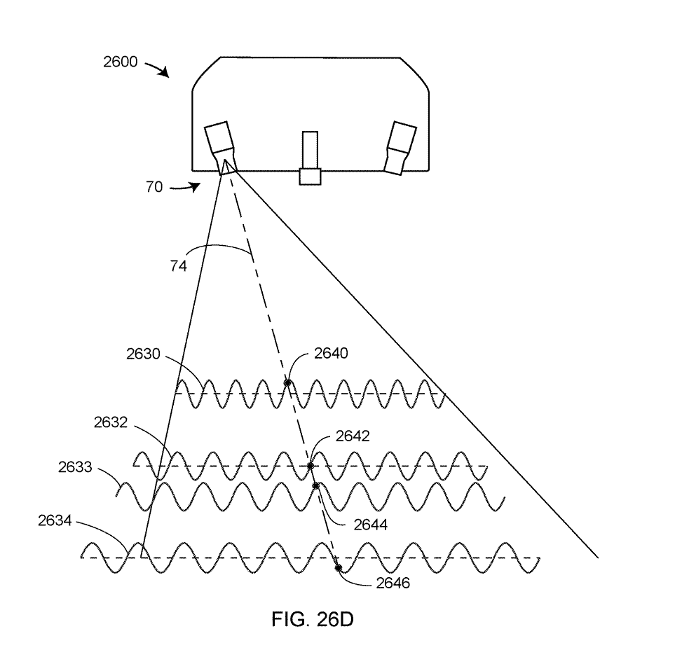

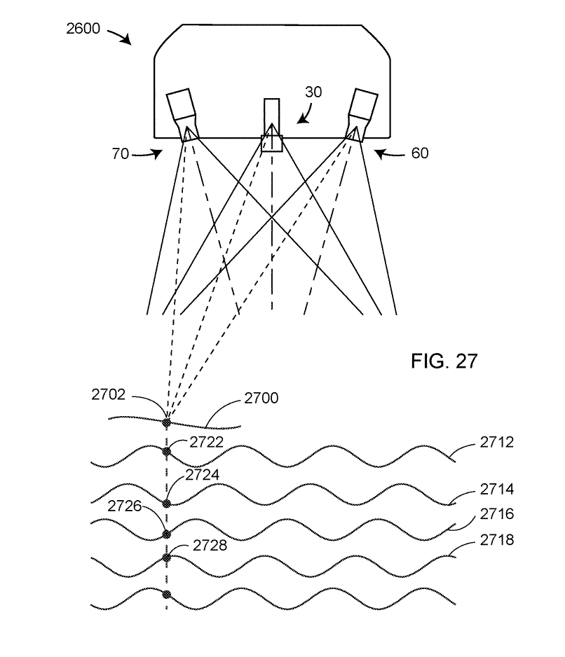

An example is now given of a way to reduce measurement time. As explained herein below in reference to FIGS. 26A-D and FIG. 27, one method of determining 3D coordinates is by performing sequential measurements. An example of such a sequential measurement method described herein below is to project a sinusoidal measurement pattern three or more times, with the phase of the pattern shifted each time. In an embodiment, such projections may be performed first with a coarse sinusoidal pattern, followed by a medium-resolution sinusoidal pattern, followed by a fine sinusoidal pattern. In this instance, the coarse sinusoidal pattern is used to obtain an approximate position of an object point in space. The medium-resolution and fine patterns used to obtain increasingly accurate estimates of the 3D coordinates of the object point in space. In an embodiment, redundant information provided by the triangular arrangement of the 3D imager 300 eliminates the need for a coarse phase measurement to be performed. Instead, the information provided on the three reference planes 460, 470, and 480 enables a coarse determination of object point position. One way to make this coarse determination is by iteratively solving for the position of object points based on an optimization procedure. For example, in one such procedure, a sum of squared residual errors is minimized to select the best-guess positions for the object points in space.

The triangular arrangement of 3D imager 300 may also be used to help identify errors. For example, a projector 493 in a 3D imager 490 of FIG. 4B may project a coded pattern onto an object in a single shot with a first element of the pattern having a projection point P₃. The first camera 491 may associate a first image point Pⱼ on the reference plane 460 with the first element. The second camera 492 may associate the first image point P₂ on the reference plane 470 with the first element. The six epipolar lines may be generated from the three points P₁, P₂, and P₃ using the method described herein above. The intersection of the epipolar lines must lie on the corresponding points P₁, P₂, and P₃ for the solution to be consistent. If the solution is not consistent, additional measurements or other actions may be advisable.

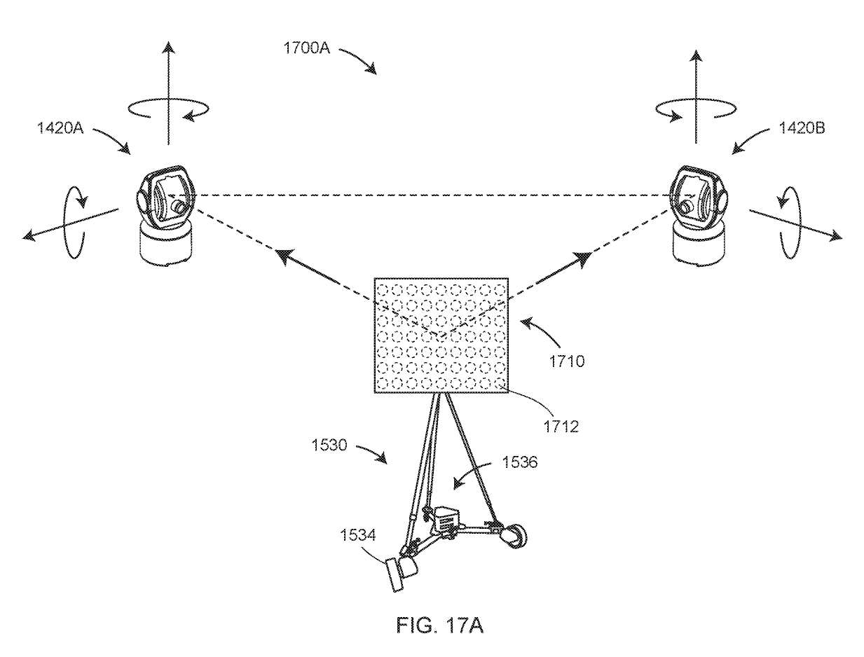

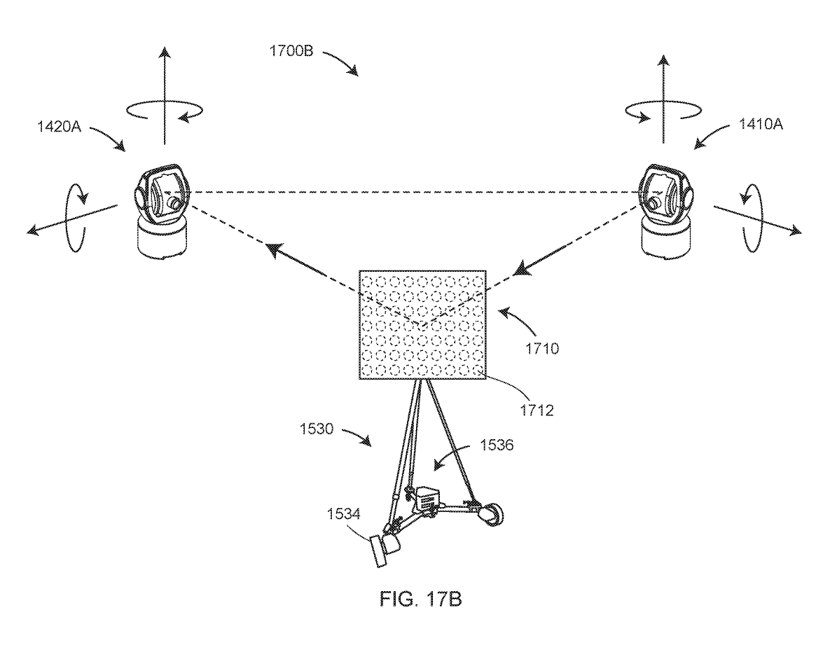

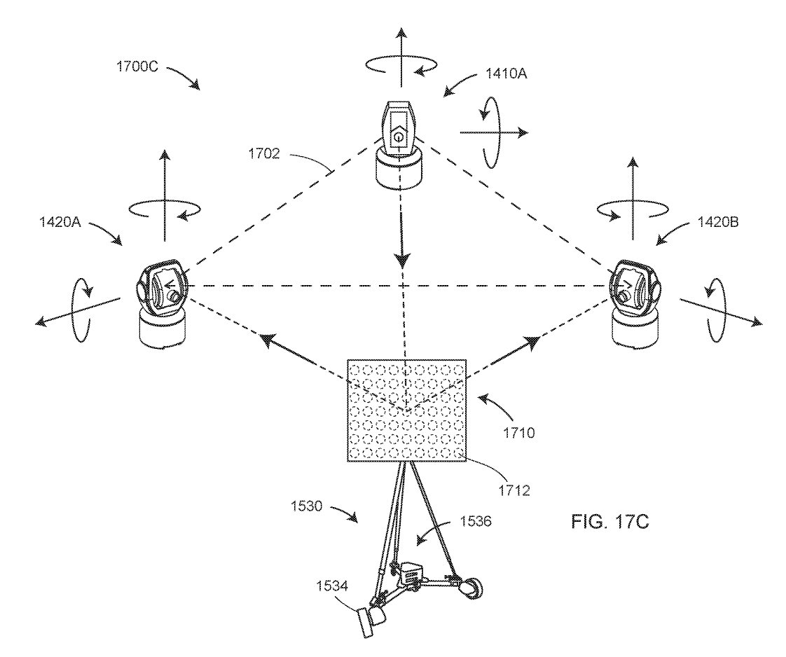

The triangular arrangement of the 3D imager 300 may also be used to automatically update compensation/calibration parameters. Compensation parameters are numerical values stored in memory, for example, in an internal electrical system of a 3D measurement device or in another external computing unit. Such parameters may include the relative positions and orientations of the cameras and projector in the 3D imager. The compensation parameters may relate to lens characteristics such as lens focal length and lens aberrations. They may also relate to changes in environmental conditions such as temperature. Sometimes the term calibration is used in place of the term compensation. Often compensation procedures are performed by the manufacturer to obtain compensation parameters for a 3D imager. In addition, compensation procedures are often performed by a user. User compensation procedures may be performed when there are changes in environmental conditions such as temperature. User compensation procedures may also be performed when projector or camera lenses are changed or after then instrument is subjected to a mechanical shock. Typically user compensations may include imaging a collection of marks on a calibration plate. A further discussion of compensation procedures is given herein below in reference to FIGS. 17-21.

Inconsistencies in results based on epipolar calculations for a 3D imager 490 may indicate a problem in compensation parameters, which are numerical values stored in memory. Compensation parameters are used to correct imperfections or nonlinearities in the mechanical, optical, or electrical system to improve measurement accuracy. In some cases, a pattern of inconsistencies may suggest an automatic correction that can be applied to the compensation parameters. In other cases, the inconsistencies may indicate a need to perform user compensation procedures.

It is often desirable to integrate color information into 3D coordinates obtained from a triangulations scanner (3D imager). Such color information is sometimes referred to as “texture” information since it may suggest the materials being imaged or reveal additional aspects of the scene such as shadows. Usually such color (texture) information is provided by a color camera separated from the camera in the triangulation scanner (i.e., the triangulation camera). An example of a separate color camera is the camera 390 in the 3D imager 300 of FIG. 3.

In some cases, it is desirable to supplement 3D coordinates obtained from a triangulation scanner with information from a two-dimensional (2D) camera covering a wider field-of-view (FOV) than the 3D imager. Such wide-FOV information may be used for example to assist in registration. For example, the wide-FOV camera may assist in registering together multiple images obtained with the triangulation camera by identifying natural features or artificial targets outside the FOV of the triangulation camera. For example, the camera 390 in the 3D imager 300 may serve as both a wide-FOV camera and a color camera.

If a triangulation camera and a color camera are connected together in a fixed relationship, for example, by being mounted onto a common base, then the position and orientation of the two cameras may be found in a common frame of reference. Position of each of the cameras may be characterized by three translational degrees-of-freedom (DOF), which might be for example x-y-z coordinates of the camera perspective center. Orientation of each of the cameras may be characterized by three orientational DOF, which might be for example roll-pitch-yaw angles. Position and orientation together yield the pose of an object. In this case, the three translational DOF and the three orientational DOF together yield the six DOF of the pose for each camera. A compensation procedure may be carried out by a manufacturer or by a user to determine the pose of a triangulation scanner and a color camera mounted on a common base, the pose of each referenced to a common frame of reference.

If the pose of a color camera and a triangulation camera are known in a common frame of reference, then it is possible in principle to project colors obtained from the color camera onto the 3D image obtained from the triangulation scanner. However, increased separation distance between the two cameras may reduce accuracy in juxtaposing the color information onto the 3D image. Increased separation distance may also increase complexity of the mathematics required to perform the juxtaposition. Inaccuracy in the projection of color may be seen, for example, as a misalignment of color pixels and 3D image pixels, particularly at object edges.

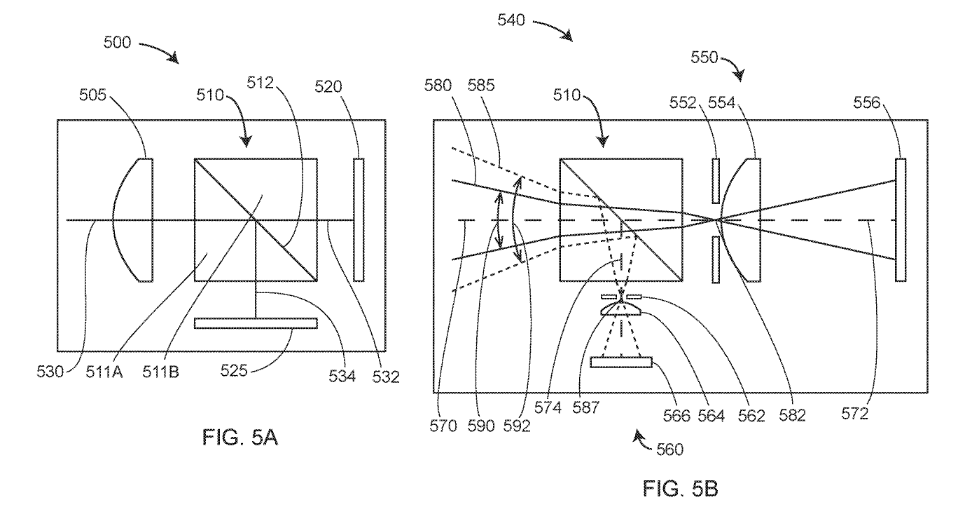

A way around increased error and complication caused by increased distance between a color camera and a triangulation camera is now described with reference to FIGS. 5A and 5B. FIG. 5A is a schematic representation of a dichroic camera assembly 500 that includes a lens 505, a dichroic beamsplitter 510, a first photosensitive array 520, and a second photosensitive array 525. The dichroic beamsplitter 510 is configured to split an incoming beam of light into a first collection of wavelengths traveling along a first path 532 and a second collection of wavelengths traveling along a second path 534. The terms first channel and second channel are used interchangeably with the terms first path and second path, respectively. The incoming beam of light travels in the direction of an optical axis 530 of the lens 505.

Although the lens 505 in FIG. 5A is represented as a single element, it should be understood that the lens 505 will in most cases be a collection of lenses. It is advantageous that the lens 505 of the dichroic camera assembly 500 correct for chromatic aberrations. Correction for chromatic aberration in two or more wavelengths requires a lens 505 having multiple lens elements. The lens 505 may also include an aperture to limit the light passing onto the photosensitive arrays 520 and 525.

The dichroic beamsplitter 510 may be of any type that separates light into two different beam paths based on wavelength. In the example of FIG. 5A, the dichroic beamsplitter 510 is a cube beamsplitter made of two triangular prismatic elements 511A, 511B having a common surface region 512. One type of common surface region 512 is formed by coating one or both of the glass surfaces at the region 512 to reflect and transmit selected wavelengths of light. Such a coating may be, for example, a coating formed of multiple thin layers of dielectric material. The two triangular prismatic elements 511A, 511B may be connected with optical cement or by optical contacting. The common surface region 512 may also be designed to reflect different wavelengths based on the principle of total internal reflection, which is sensitively dependent on the wavelength of incident light. In this case, the prismatic elements 511A, 511B are not brought in contact with one another but separated by an air gap.

In an alternative embodiment, a dichroic beamsplitter is constructed of prismatic elements that direct the light to travel in two directions that are not mutually perpendicular. In another embodiment, a dichroic beamsplitter is made using a plate (flat window) of glass rather than a collection of larger prismatic elements. In this case, a surface of the plate is coated to reflect one range of wavelengths and transmit another range of wavelengths.

In an embodiment, the dichroic beamsplitter 510 is configured to pass color (texture) information to one of the two photosensitive arrays and to pass 3D information to the other of the two photosensitive arrays. For example, the dielectric coating 512 may be selected to transmit infrared (IR) light along the path 532 for use in determining 3D coordinates and to reflect visible (color) light along the path 534. In another embodiment, the dielectric coating 512 reflects IR light along the path 534 while transmitting color information along the path 532.

In other embodiments, other wavelengths of light are transmitted or reflected by the dichroic beamsplitter. For example, in an embodiment, the dichroic beamsplitter may be selected to pass infrared wavelengths of light that may be used, for example, to indicate the heat of objects (based on characteristic emitted IR wavelengths) or to pass to a spectroscopic energy detector for analysis of background wavelengths. Likewise a variety of wavelengths may be used to determine distance. For example, a popular wavelength for use in triangulation scanners is a short visible wavelength near 400 nm (blue light). In an embodiment, the dichroic beamsplitter is configured to pass blue light onto one photosensitive array to determine 3D coordinates while passing visible (color) wavelengths except the selected blue wavelengths onto the other photosensitive array.

In other embodiments, individual pixels in one of the photosensitive arrays 520, 525 are configured to determine distance to points on an object, the distance based on a time-of-flight calculation. In other words, with this type of array, distance to points on an object may be determined for individual pixels on an array. A camera that includes such an array is typically referred to as a range camera, a 3D camera or an RGB-D (red-blue-green-depth) camera. Notice that this type of photosensitive array does not rely on triangulation but rather calculates distance based on another physical principle, most often the time-of-flight to a point on an object. In many cases, an accessory light source is configured to cooperate with the photosensitive array by modulating the projected light, which is later demodulated by the pixels to determine distance to a target.

In most cases, the focal length of the lens 505 is nearly the same for the wavelengths of light that pass through the two paths to the photosensitive arrays 520 and 525. Because of this, the FOV is nearly the same for the two paths. Furthermore, the image area is nearly the same for the photosensitive arrays 520 and 525.

FIG. 5B is a schematic representation of a dichroic camera assembly 540 that includes a first camera 550, a second camera 560, and a dichroic beam splitter 510. The dichroic beamsplitter 510 was described herein above. In FIG. 5B, the beamsplitter 510 separates the incoming beam of light into a first collection of wavelengths traveling as a first beam 580 along a first path and a second collection of wavelengths traveling as a second beam 585 along a second path. The first camera 550 includes a first aperture 552, a first lens 554, and a first photosensitive array 556. The second camera 560 includes a second aperture 562, a second lens 564, and a second photosensitive array 566. The first path corresponds to the optical axis 572 of the first camera 550, and the second path corresponds to the optical axis 574 of the second camera 560.

Although the lenses 554 and 564 in FIG. 5B are represented as single elements, it should be understood that each of these lenses 554, 564 will in most cases be a collection of lenses. The dichroic camera assembly 540 has several potential advantages over the dichroic camera assembly 500. A first potential advantage is that the first FOV 590 of the first camera 550 can be different than the second FOV 592 of the second camera 560. In the example of FIG. 5B, the first FOV 590 is smaller than the second FOV. In such an arrangement, the wide-FOV camera may be used to identify natural or artificial targets not visible to the narrow-FOV camera. In an embodiment, the narrow-FOV camera is a triangulation camera used in conjunction with a projector to determine 3D coordinates of an object surface. The targets observed by the wide-FOV camera may be used to assist in registration of multiple sets of 3D data points obtained by the narrow-FOV triangulation camera. A variety of natural targets may be recognized through image processing. Simple examples include object features such as edges. Artificial targets may include such features as reflective dots or point light sources such as light emitting diodes (LEDs). A wide-FOV camera used to identify natural or artificial targets may also be used to provide color (texture) information.

A second potential advantage of the dichroic camera assembly 540 over the dichroic camera assembly 500 is that one of the two photosensitive arrays 556 and 566 may be selected to have a larger sensor area than the other array. In the example of FIG. 5B, the photosensitive array 556 has a larger surface area than the photosensitive array 566. Such a larger sensor area corresponds to a greater distance from the lens 554 to the photosensitive array 556 than from the lens 564 to the photosensitive array 566. Note that the larger distance may occur on either the first path or the second path. Such a larger area of the photosensitive array 556 may enable resolution to be increased by increasing the number of pixels in the array. Alternatively, the larger area of the photosensitive array 556 may be used to increase the size of each pixel, thereby improving the signal-to-noise (SNR) of the received image. Reduced SNR may result in less noise and better repeatability in measured 3D coordinates.

A third potential advantage of the dichroic camera assembly 540 over the dichroic camera assembly 500 is that aberrations, especially chromatic aberrations, may be more simply and completely corrected using two separate lens assemblies 554, 564 than using a single lens assembly 505 as in FIG. 5A.

On the other hand, a potential advantage of the dichroic camera assembly 500 over the dichroic camera assembly 540 is a smaller size for the overall assembly. Another potential advantage is ability to use a single off-the-shelf lens—for example, a C-mount lens.

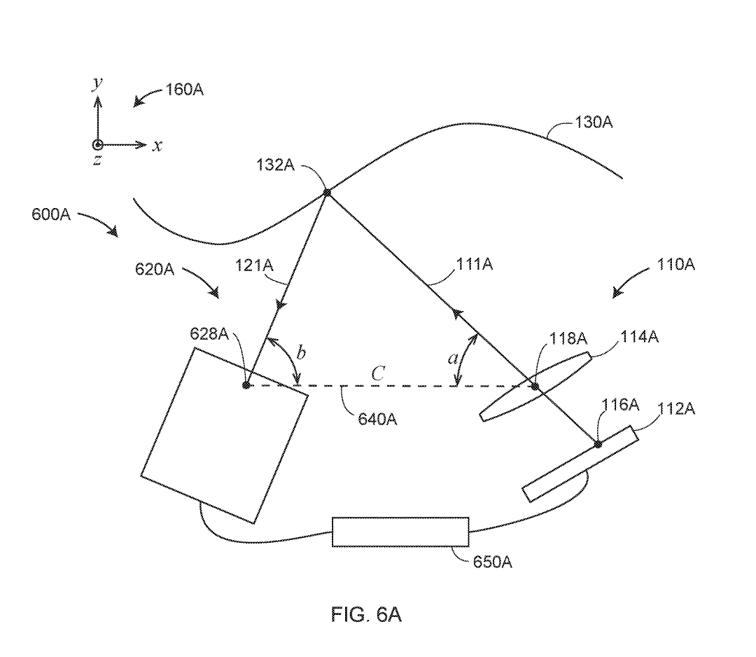

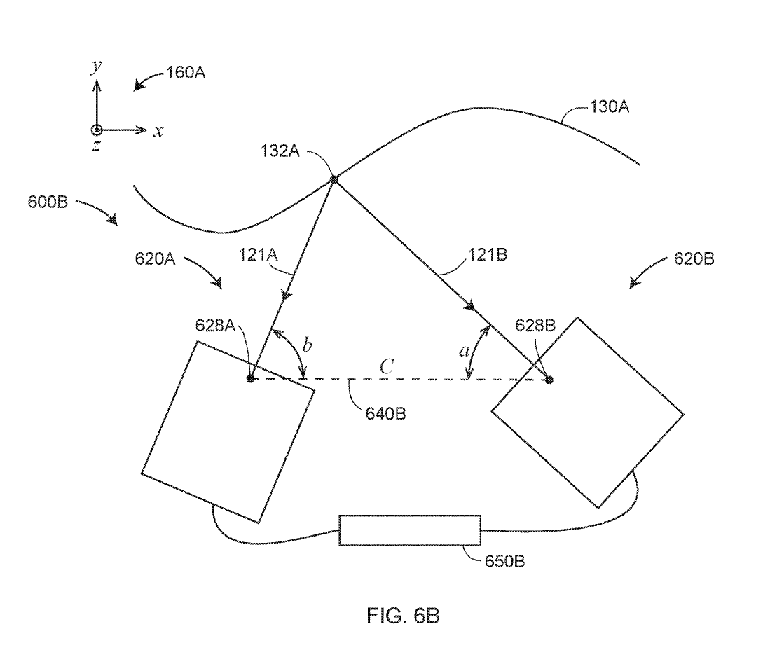

FIG. 6A is a schematic representation of a 3D imager 600A similar to the 3D imager 100A of FIG. 1A except that the camera 120A of FIG. 1A has been replaced by a dichroic camera assembly 620A. In an embodiment, the dichroic camera assembly 620A is the dichroic camera assembly 500 of FIG. 5A or the dichroic camera assembly 540 of FIG. 5B. The perspective center 628A is the perspective center of the lens that cooperates with the projector 110A to determine 3D coordinates of an object surface. The distance between the perspective center 628A and the perspective center 118A of the projector is the baseline distance 640A. A processor 650A provides processing support, for example, to obtain color 3D images, to register multiple images, and so forth.

FIG. 6B is a schematic representation of a stereo camera 600B similar to the stereo camera 100B of FIG. 1B except that the cameras 120B and 170B have been replaced by the dichroic camera assemblies 620A and 620B, respectively. In an embodiment, the dichroic camera assemblies 620A and 620B may each be either the dichroic camera assembly 500 or the dichroic camera assembly 540. The perspective centers 628A and 628B are the perspective centers of the lenses that cooperate to obtain 3D coordinates using a triangulation calculation. The distance between the perspective centers 628A and 628B is the baseline distance 640B. A processor 650B provides processing support, for example, to obtain color 3D images, to register multiple images, and so forth.

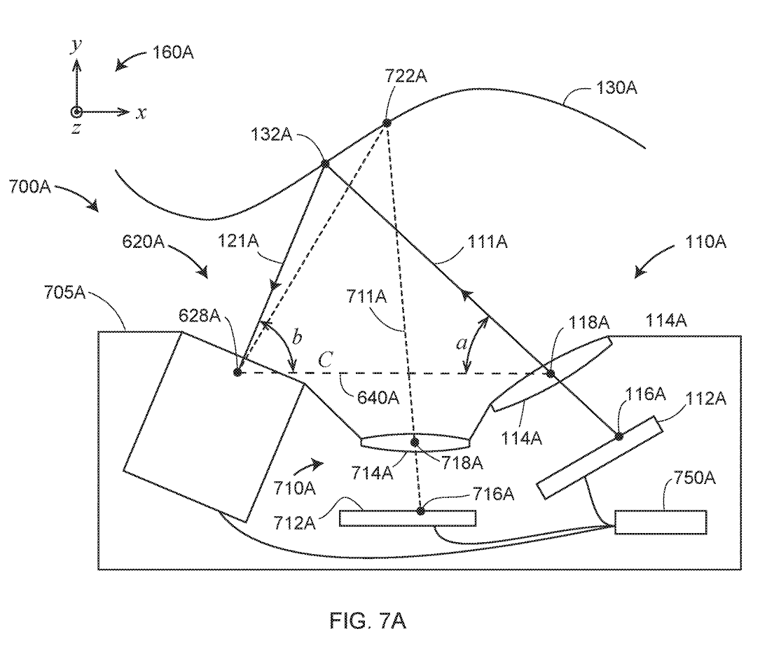

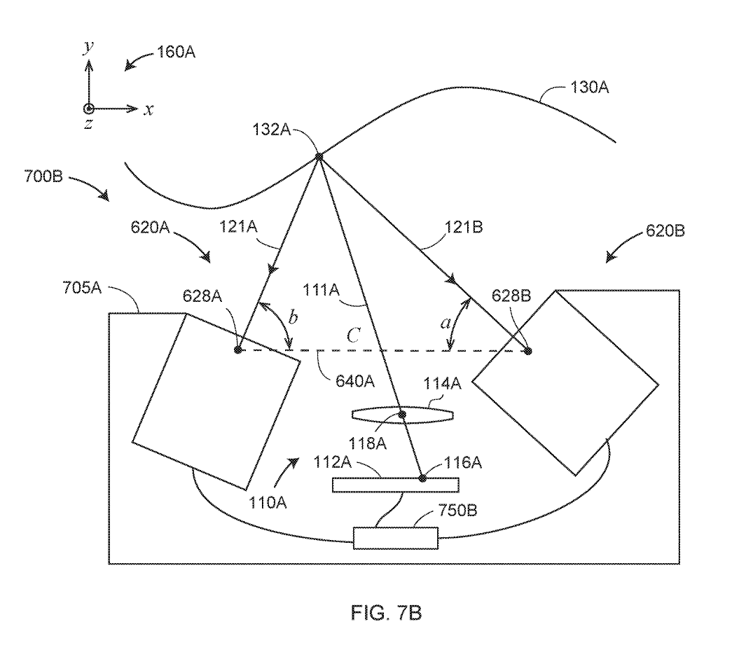

FIG. 7A is a schematic representation of a 3D imager 700A similar to the 3D imager of 600A of FIG. 6A except that it further includes an auxiliary projector 710A. In an embodiment, the dichroic camera assembly 620A, the projector 110A, and the auxiliary projector 710A are all fixedly attached to a body 705A. The auxiliary projector 710A includes an illuminated projector pattern generator 712A, an auxiliary projector lens 714A, and a perspective center 718A through which a ray of light 711A emerges. The ray of light 711A emerges from a corrected point 716A having a corrected position on the pattern generator 712A. The lens 714A may include several lens elements and an aperture. In an embodiment, the point 716A has been corrected to account for aberrations of the projector, including aberrations of the lens 714A, in order to cause the ray 711A to pass through the perspective center 718A, thereby placing the projected light at the desired location on the object surface 130A.

The pattern of light projected from the auxiliary projector 710A may be configured to convey information to the operator. In an embodiment, the pattern may convey written information such as numerical values of a measured quantity or deviation of a measured quantity in relation to an allowed tolerance. In an embodiment, deviations of measured values in relation to specified quantities may be projected directly onto the surface of an object. In some cases, the information conveyed may be indicated by projected colors or by “whisker marks,” which are small lines that convey scale according to their lengths. In other embodiments, the projected light may indicate where assembly operations are to be performed, for example, where a hole is to be drilled or a screw is to be attached. In other embodiments, the projected light may indicate where a measurement is to be performed, for example, by a tactile probe attached to the end of an articulated arm CMM or a tactile probe attached to a six-DOF accessory of a six-DOF laser tracker. In other embodiments, the projected light may be a part of the 3D measurement system. For example, a projected spot or patch of light may be used to determine whether certain locations on the object produce significant reflections that would result in multi-path interference. In other cases, the additional projected light pattern may be used to provide additional triangulation information to be imaged by the camera having the perspective center 628A.

FIG. 7B is schematic representation of a 3D imager 700B that includes two dichroic camera assemblies 620A, 620B in addition to a projector 110A. In an embodiment, the 3D imager 700B is implemented as the 3D imager 200 of FIG. 2. In an alternative embodiment, the 3D imager 700B is implemented as the 3D imager 300 of FIG. 3.

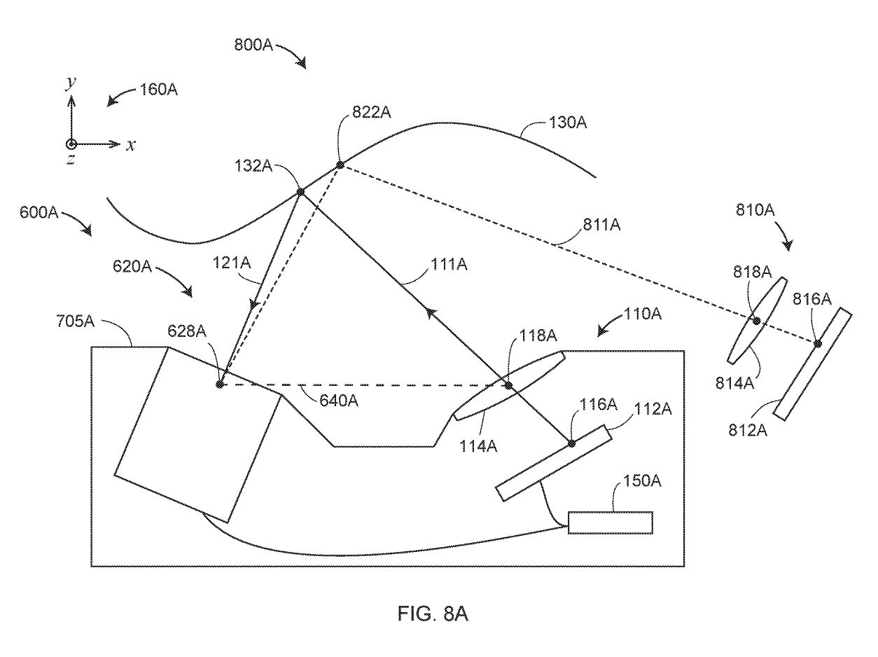

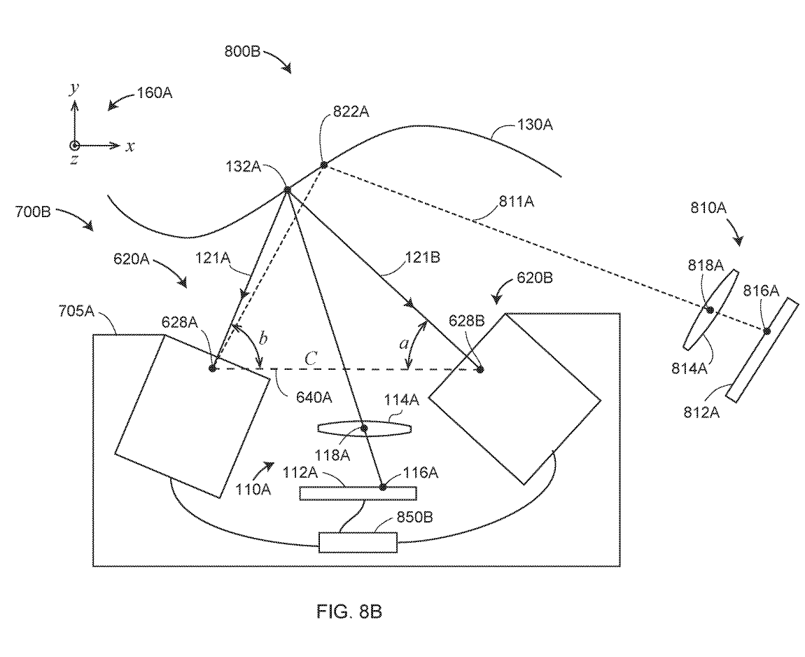

FIG. 8A is a schematic representation of a system 800A that includes a 3D imager 600A as described herein above in reference to FIG. 6A and further includes an external projector 810A, which is detached from the 3D imager 600A. The external projector 810A includes an illuminated projector pattern generator 812A, an external projector lens 814A, and a perspective center 818A through which a ray of light 811A emerges. The ray of light 811A emerges from a corrected point 816A having a corrected position on the pattern generator 812A. The lens 814A may include several lens elements and an aperture. In an embodiment, the position of the point 816A has been corrected to account for aberrations of the projector, including aberrations of the lens 814A, in order to cause the ray 811A to pass through the perspective center 818A, thereby placing the projected light at the desired location 822A on the object surface 130A.

In an embodiment, the external projector 810A is fixed in place and projects a pattern over a relatively wide FOV while the 3D imager 600A is moved to a plurality of different locations. The dichroic camera assembly 620A captures a portion of the pattern of light projected by the external projector 810A in each of the plurality of different locations to register the multiple 3D images together. In an embodiment, the projector 110A projects a first pattern of light at a first wavelength, while the projector 810A projects a second pattern of light at a second wavelength. In an embodiment, a first of the two cameras in the dichroic camera assembly 620A captures the first wavelength of light, while the second of the two cameras captures the second wavelength of light. In this manner interference between the first and second projected patterns can be avoided. In other embodiments, an additional color camera such as the camera 390 in FIG. 3 may be added to the system 800A to capture color (texture) information that can be added to the 3D image.

FIG. 8B is a schematic representation of a system 800B that includes a 3D imager 700B as described herein above in reference to FIG. 7B and further includes the external projector 810A, which is detached from the 3D imager 700B.

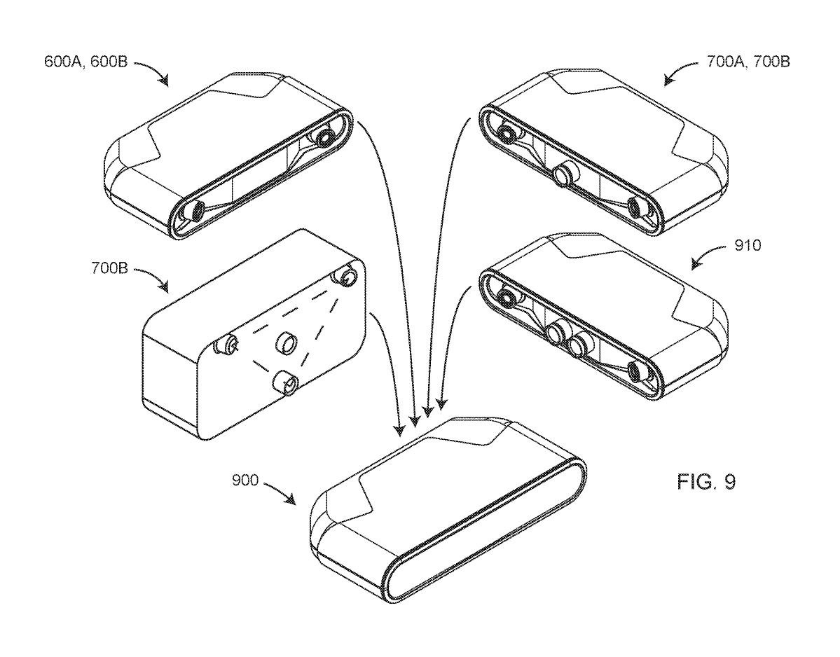

FIG. 9 shows some possible physical embodiments of the devices discussed herein above. These figures illustrate attachable lenses (for example, C-mount lenses), which are appropriate for dichroic cameras 500 in FIG. 5A. For the dichroic camera assembly 540 of FIG. 5B, the lenses would in most cases be internal to the body of the 3D imager, with the beam splitter the outermost element in the assembly. The drawings of FIG. 9, however, are intended to include 3D imagers and stereo cameras that make use of dichroic cameras, including dichroic cameras 540.

The device in the upper left of FIG. 9 may represent a 3D imager such as 600A or a stereo camera such as 600B. The device in the upper right of FIG. 9 may represent 3D imagers such as 700B and stereo cameras with auxiliary projector such as 700A. The 3D imager in the middle left of FIG. 9 may be a device 300 described with reference to FIG. 3. In this device, one or both of the cameras in the 3D imagers may be dichroic cameras such as the dichroic cameras 500, 540. The 3D imager 700B is an imager of this type. The 3D imager in the middle right of FIG. 9 may be a 3D imager 910 represented by FIG. 700B with an additional element such as an auxiliary projector. The element 900 in FIG. 9 is intended to represent all of these 3D imager or 3D stereo devices that include at least one dichroic camera element. The element 900 is used in subsequent figures to represent any device of the types shown in FIG. 9. The element 900, which may be a 3D imager, stereo camera, or combination of the two, is referred to herein below as the 3D triangulation device 900.

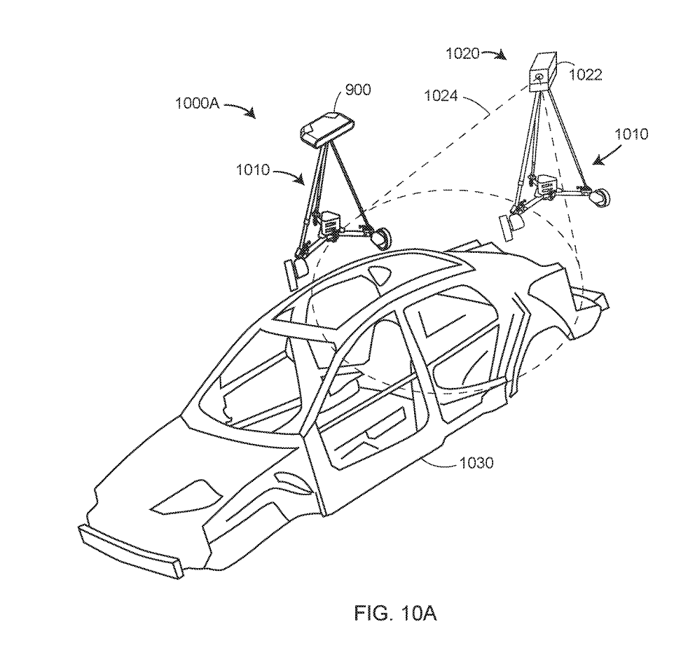

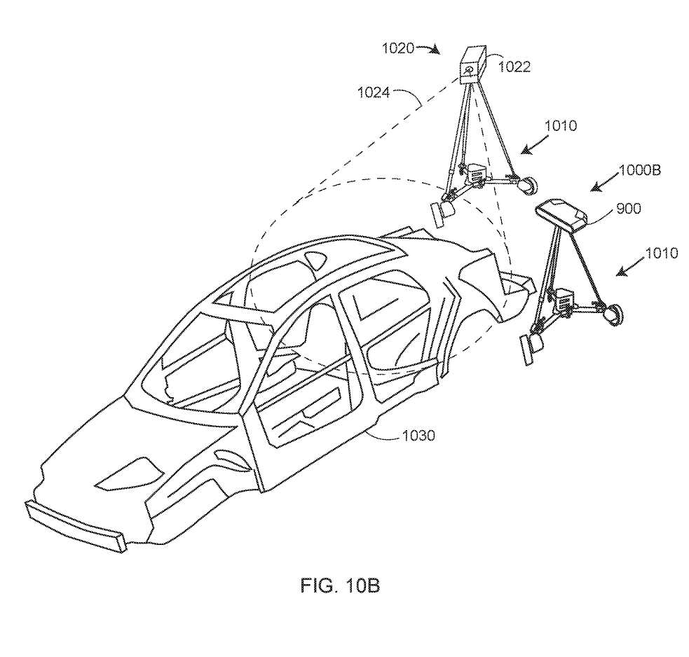

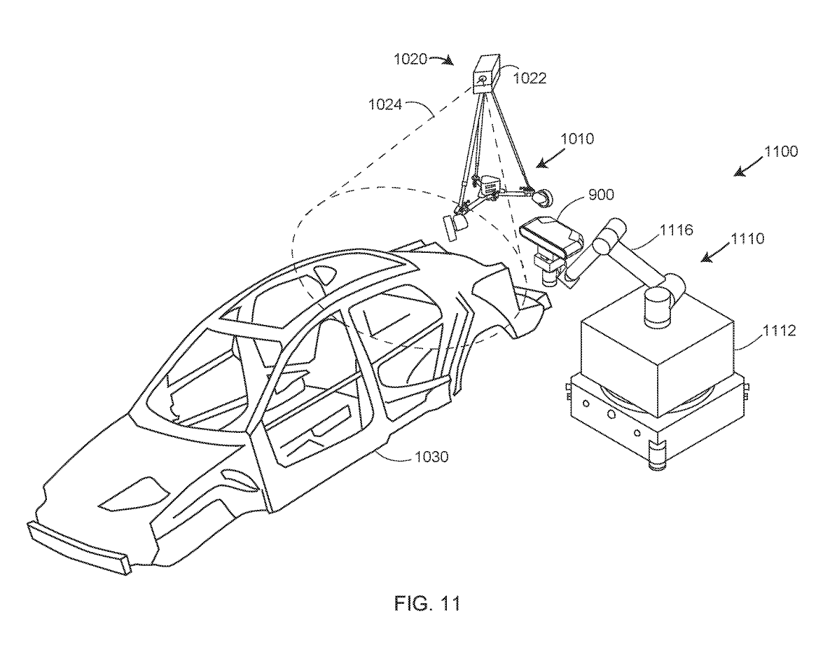

FIG. 10A is a perspective view of a mobile 3D triangulation system 1000A, an external projector system 1020, and an object under test 1030. In an embodiment, the 3D triangulation system 1000A includes a 3D triangulation device 900 and a motorized base 1010. In other embodiments, the 3D triangulation device is mounted on a stationary platform or a platform that is mobile but not motorized. The external projector system 1020 includes an external projector 1022 and a motorized base 1010. The external projector is configured to project a pattern of light 1024. In other embodiments, a fixed or mobile base may replace the motorized base 1010. In an embodiment, the external projector 1020 is implemented as the external projector 810A of FIGS. 8A and 8B. The illuminated projector pattern generator 812A may be implemented through the use of a diffractive optical element, a digital micromirror device (DMD), a glass slide having a pattern, or by other methods. With the diffractive optical element approach, a laser beam is sent through a diffractive optical element configured to project a 2D array of laser spots—for example, an array of 100×100 spots. With the DMD approach, the DMD may be configured to project any pattern. This pattern might be, for example, an array of spots with some of the spots specially marked to provide a quick way to establish the correspondence of the projected spots with the imaged spots captured by a camera in the 3D triangulation device 900. The object under test 1030 in the example of FIG. 10A is an automobile body-in-white (BiW). In FIG. 10A, the 3D triangulation device 900 is measuring 3D coordinates of the surface of the object 1030. Periodically the 3D triangulation device 900 is moved to another position by the motorized base 1010. At each position of the 3D triangulation device 900, the 3D triangulation device captures with the two channels of its dichroic camera two types of data: (1) 3D coordinates based on a triangulation calculation and (2) an image of the pattern projected by the external projector 1022. By matching the patterns projected by the external projector 1022 for each of the plurality of 3D data sets obtained from the 3D triangulation device 900, the 3D data sets may be more easily and accurately registered.

FIG. 10B is a perspective view of a 3D triangulation system 1000B, the external projector system 1020, and the object under test 1030. The 3D triangulation system 1000B is like the 3D triangulation system 1000A except that it has been moved to a different position. In both positions, a portion of the pattern projected by the external projector system 1020 is visible to at least one channel of the dichroic camera assembly within the 3D triangulation device 900, thereby enabling efficient and accurate registration of the multiple data sets obtained by 3D triangulation device 900.

FIG. 11 is a perspective view of a 3D triangulation system 1100, the external projector system 1020, and the object under test 1030. The 3D triangulation system 1100 includes a motorized robotic base 1110 and a 3D triangulation device 900. The motorized robotic base 1110 includes a mobile platform 1112 on which is mounted a robotic arm 1116 that holds the 3D triangulation device 900. The motorized robotic platform 1112 includes wheels that are steered under computer or manual control to move the 3D triangulation system 1100 to a desired position. In an embodiment, the robotic arm 1116 includes at least five degrees of freedom, enabling the 3D triangulation device 900 to be moved up and down, side-to-side, and rotated in any direction. The robotic arm 1116 enables measurement of 3D coordinates at positions high and low on the object 1030. The robotic arm also enables rotation of the 3D triangulation device 900 so as to capture features of interest from the best direction and at a preferred standoff distance. As in the case of the 3D triangulation systems 1000A and 1000B, the 3D triangulation system 1100 may be moved to multiple positions, taking advantage of the pattern of light projected by the external projector system 1020 to enable fast and accurate registration of multiple 3D data sets. In an embodiment, a first channel of the dichroic camera within the 3D triangulation system 1100 is used to capture the pattern projected by the external projector, while the second channel is used to determine 3D data points based on a triangulation calculation.

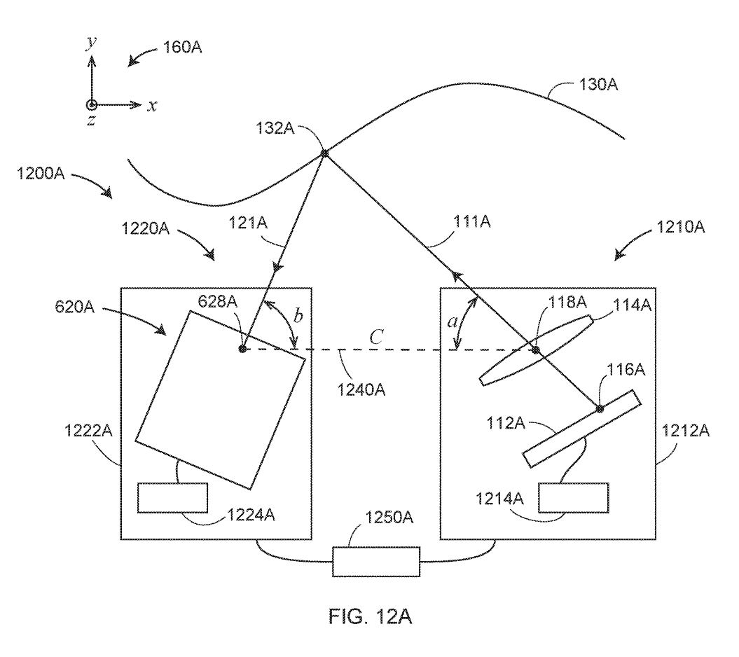

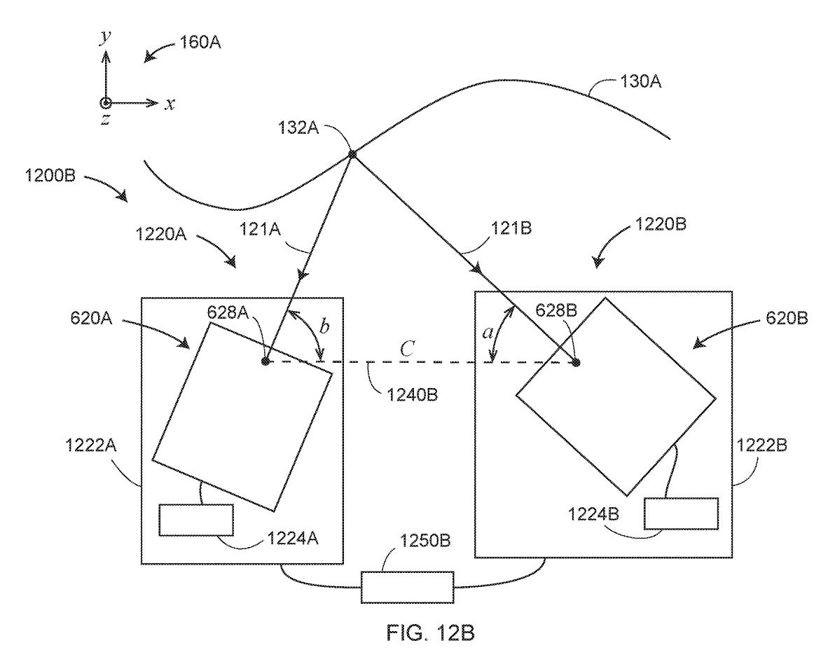

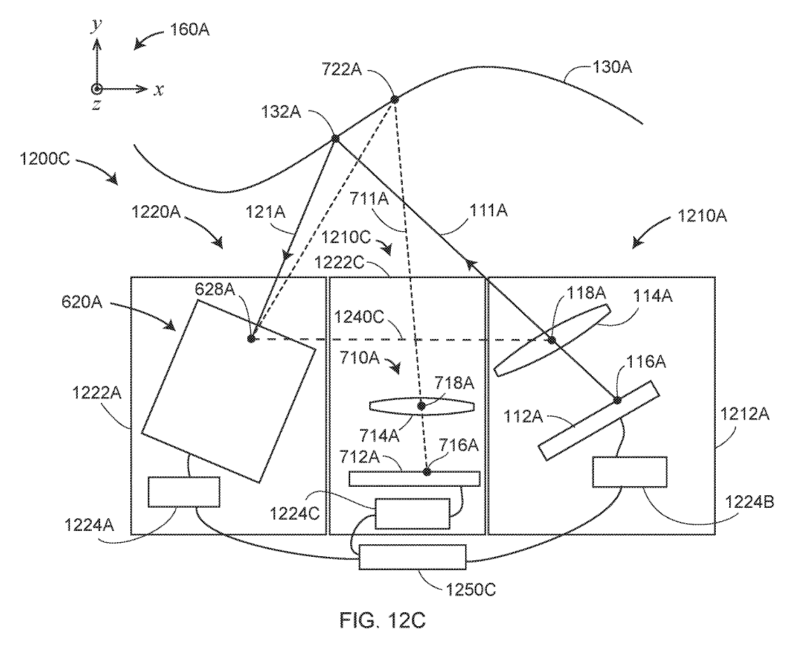

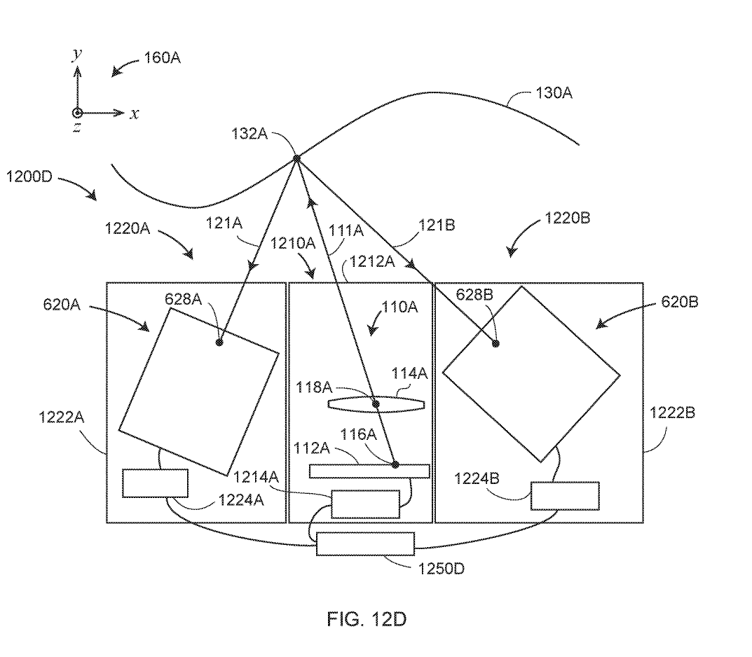

FIG. 12A is a schematic representation of a 3D triangulation system 1200A that includes a projection unit 1210A, a dichroic camera unit 1220A, and a processor 1250A. The projection unit 1210A includes a projection base 1212A, an illuminated projector pattern generator 112A, a projector lens 114A, a perspective center 118A through which a ray of light 111A emerges, and a processor 1214A. The ray of light 111A emerges from a corrected point 116A having a corrected position on the pattern generator 112A. In an embodiment, the point 116A has been corrected to account for aberrations of the projector, including aberrations of the lens 114A, in order to cause the ray to pass through the perspective center 118A, thereby simplifying triangulation calculations. The ray of light 111A intersects the surface 130A in a point 132A. In an embodiment, the processor 1214A cooperates with the illuminated projector pattern generator 112A to form the desired pattern.

The dichroic camera unit 1220A includes a camera base 1222A, a dichroic camera assembly 620A, a camera perspective center 628A, and a processor 1224A. Light reflected (scattered) off the object surface 130A from the point 132A passes through the camera perspective center 628A of the dichroic camera assembly 620A. The dichroic camera assembly was discussed herein above in reference to FIG. 6A. The distance between the camera perspective center 628A and the projector perspective center 118A is the baseline distance 1240A. Because the projection base 1212A and the camera base 1222A are not fixedly attached but may each be moved relative to the other, the baseline distance 1240A varies according to the setup. A processor 1224A cooperates with the dichroic camera assembly 620A to capture the image of the illuminated pattern on the object surface 130A. The 3D coordinates of points on the object surface 130A may be determined by the camera internal processor 1224A or by the processor 1250A. Likewise, either the internal processor 1224A or the external processor 1250A may provide support to obtain color 3D images, to register multiple images, and so forth.

FIG. 12B is a schematic representation of a 3D triangulation system 1200B that includes a first dichroic camera unit 1220A, a second dichroic camera unit 1220B, and a processor 1250B. The first dichroic camera unit 1220A includes a camera base 1222A, a first dichroic camera assembly 620A, a first perspective center 628A, and a processor 1224A. A ray of light 121A travels from the object point 132A on the object surface 130A through the first perspective center 628A. The processor 1224A cooperates with the dichroic camera assembly 620A to capture the image of the illuminated pattern on the object surface 130A.

The second dichroic camera unit 1220B includes a camera base 1222B, a first dichroic camera assembly 620B, a second perspective center 628B, and a processor 1224B. A ray of light 121B travels from the object point 132A on the object surface 130A through the second perspective center 628B. The processor 1224B cooperates with the dichroic camera assembly 620B to capture the image of the illuminated pattern on the object surface 130B. The 3D coordinates of points on the object surface 130A may be determined by any combination of the processors 1224A, 1224B, and 1250B. Likewise, any of the processors 1224A, 1224B, and 1250B may provide support to obtain color 3D images, to register multiple images, and so forth. The distance between the first perspective center 628A and the second perspective center 628B is the baseline distance 1240B. Because the projection base 1222A and the camera base 1222B are not fixedly attached but may each be moved relative to the other, the baseline distance 1240B varies according to the setup.

The 3D coordinates of points on the object surface 130A may be determined by the camera internal processor 1224A or by the processor 1250A. Likewise, either the internal processor 1224A or the external processor 1250A may provide support to obtain color 3D images, to register multiple images, and so forth.

FIG. 12C is a schematic representation of a 3D triangulation system 1200C that includes a projection unit 1210A, a dichroic camera unit 1220A, an auxiliary projection unit 1210C, and a processor 1250C. The projection unit 1210C includes a projection base 1212A, an illuminated projector pattern generator 112A, a projector lens 114A, a perspective center 118A through which a ray of light 111A emerges, and a processor 1224B. The ray of light 111A emerges from a corrected point 116A having a corrected position on the pattern generator 112A. In an embodiment, the point 116A has been corrected to account for aberrations of the projector, including aberrations of the lens 114A, in order to cause the ray to pass through the perspective center 118A, thereby simplifying triangulation calculations. The ray of light 111A intersects the surface 130A in a point 132A. In an embodiment, the processor 1224B cooperates with the illuminated projector pattern generator 112A to create the desired pattern.

The dichroic camera unit 1220A includes a camera base 1222A, a dichroic camera assembly 620A, a camera perspective center 628A, and a processor 1224A. Light reflected (scattered) off the object surface 130A from the point 132A passes through the camera perspective center 628A of the dichroic camera assembly 620A. The dichroic camera assembly was discussed herein above in reference to FIG. 6A. The distance between the camera perspective center 628A and the projector perspective center 118A is the baseline distance 1240C. Because the projection base 1212A and the camera base 1222A are not fixedly attached but may each be moved relative to the other, the baseline distance 1240A varies according to the setup. A processor 1224A cooperates with the dichroic camera assembly 620A to capture the image of the illuminated pattern on the object surface 130A. The 3D coordinates of points on the object surface 130A may be determined by the camera internal processor 1224A or by the processor 1250A. Likewise, either the internal processor 1224A or the external processor 1250A may provide support to obtain color 3D images, to register multiple images, and so forth. The distance between the first perspective center 628A and the second perspective center 118A is the baseline distance 1240C. Because the projection base 1212A and the camera base 1222A are not fixedly attached but may each be moved relative to the other, the baseline distance 1240C varies according to the setup.

The auxiliary projection unit 1210C includes an auxiliary projector base 1222C, an auxiliary projector 710A, and a processor 1224C. The auxiliary processor 710A was discussed herein above in reference to FIG. 7A. The auxiliary projector 710A includes an illuminated projector pattern generator 712A, an auxiliary projector lens 714A, and a perspective center 718A through which a ray of light 711A emerges from the point 716A.

The pattern of light projected from the auxiliary projector unit 1210C may be configured to convey information to the operator. In an embodiment, the pattern may convey written information such as numerical values of a measured quantity or deviation of a measured quantity in relation to an allowed tolerance. In an embodiment, deviations of measured values in relation to specified quantities may be projected directly onto the surface of an object. In some cases, the information conveyed may be indicated by projected colors or by whisker marks. In other embodiments, the projected light may indicate where assembly operations are to be performed, for example, where a hole is to be drilled or a screw is to be attached. In other embodiments, the projected light may indicate where a measurement is to be performed, for example, by a tactile probe attached to the end of an articulated arm CMM or a tactile probe attached to a six-DOF accessory of a six-DOF laser tracker. In other embodiments, the projected light may be a part of the 3D measurement system. For example, a projected spot or patch of light may be used to determine whether certain locations on the object produce significant reflections that would result in multi-path interference. In other cases, the additional projected light pattern may be used to provide additional triangulation information to be imaged by the camera having the perspective center 628A. The processor 1224C may cooperate with the auxiliary projector 710A and with the processor 1250C to obtain the desired projection pattern.

FIG. 12D is a schematic representation of a 3D triangulation system 1200D that includes a projection unit 1210A, a first dichroic camera unit 1220A, a second dichroic camera unit 1220B, and a processor 1250D. The projection unit 1210A was described herein above in reference to FIG. 12A. It includes a projection base 1212A, an illuminated projector pattern generator 112A, a projector lens 114A, a perspective center 118A through which a ray of light 111A emerges, and a processor 1214A. The ray of light 111A emerges from a corrected point 116A having a corrected position on the pattern generator 112A.

The first dichroic camera unit 1220A includes a camera base 1222A, a dichroic camera assembly 620A, a first perspective center 628A, and a processor 1224A. Light reflected (scattered) off the object surface 130A from the point 132A passes through the camera perspective center 628A of the dichroic camera assembly 620A. The dichroic camera assembly was discussed herein above in reference to FIG. 6A. As explained herein above with reference to FIGS. 2 and 3, there are three different baseline distances that may be used in determining 3D coordinates for a system that has two cameras and one projector.

The second dichroic camera unit 1220B includes a camera base 1222B, a first dichroic camera assembly 620B, a second perspective center 628B, and a processor 1224B. A ray of light 121B travels from the object point 132A on the object surface 130A through the second perspective center 628B. The processor 1224B cooperates with the dichroic camera assembly 620B to capture the image of the illuminated pattern on the object surface 130A.

Because the projection base 1212A and the camera bases 1222A, 1222B are not fixedly attached but may each be moved relative to the other, the baseline distances between these components varies according to the setup. The processors 1224A, 1224B cooperate with the dichroic camera assemblies 620A, 620B, respectively, to capture images of the illuminated pattern on the object surface 130A. The 3D coordinates of points on the object surface 130A are determined by a combination of the processors 1214A, 1224A, 1224B, and 1250D. Likewise, some combination of these processors may provide support to obtain color 3D images, to register multiple images, and so forth.

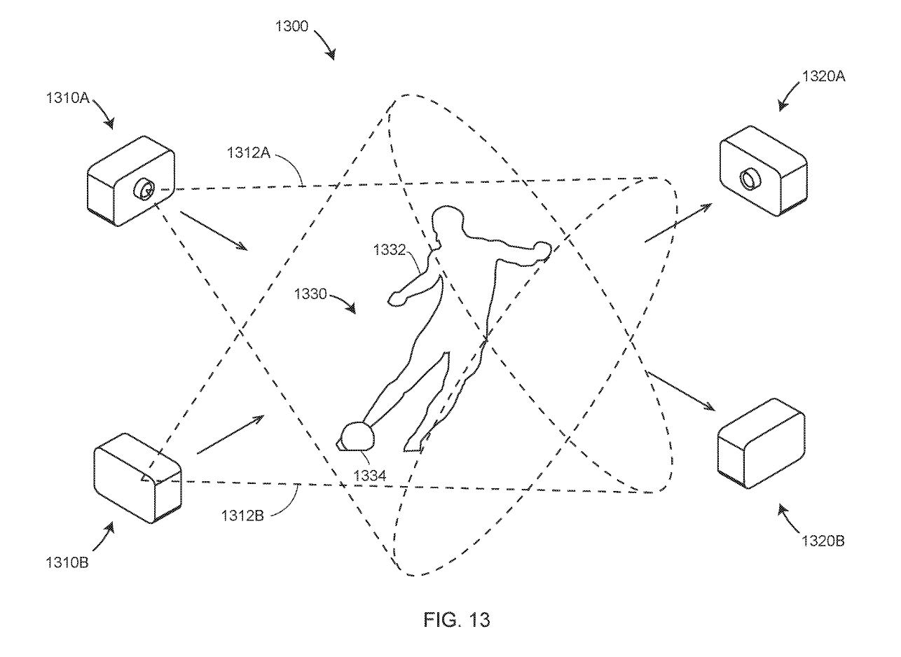

FIG. 13 illustrates a method of capturing dimensional aspects of an object 1330, which may be a moving object, with a system 1300 that includes one or more projectors 1310A, 1310B and one or more dichroic cameras 1320A, 1320B. Each of the one or more projectors 1310A, 1310B emits a light 1312A, 1312B, respectively. In an embodiment, the emitted light is an unstructured pattern of light such as a collection of dots. Such a pattern may be created, for example, by sending light through an appropriate diffractive optical element. In an alternative embodiment, the light is a structured pattern so as to enable identification of pattern elements in an image. Such a projector pattern may be created by a DMD or a patterned slide, for example. In another embodiment, the light is relatively uniform. Such light may illuminate a collection of markers on the object. Such markers might for example be small reflective dots.

The one or more dichroic cameras 1320A, 1320B may be for example the dichroic camera 500 described with reference to FIG. 5A or the dichroic camera 540 described with reference to FIG. 5B. In an embodiment, one of the two channels of the camera is configured to form a color image on a first photosensitive array, while the other channel is configured to form a second image on a second photosensitive array, the second image being used to determine 3D coordinates of the object 1330. In an embodiment, the dichroic beamsplitter is configured to minimize the overlap in wavelength ranges captured on each of the two photosensitive arrays, thereby producing distinct wavelength-dependent images on the two photosensitive arrays. In an alternative embodiment, the dichroic beamsplitter is configured to enable one of the two photosensitive arrays to capture at least a portion of the wavelengths captured by the other of the two photosensitive arrays.

In an embodiment, a plurality of projectors such as 1310A, 1310B are used. In an embodiment, the plurality of projectors project patterns at the same time. This approach is useful when the spots are used primarily to assist in registration or when there is not much chance of confusing overlapping projection patterns. In another embodiment, the plurality of projectors project light at different times so as to enable unambiguous identification of the projector that emits a particular pattern. In an alternative embodiment, each projector projects a slightly different wavelength. In one approach, each camera is configured to respond to only to wavelengths from selected projectors. In another approach, each camera is configured to separate multiple wavelengths of light, thereby enabling identification of the pattern associated with a particular projector that emits light of a particular wavelength. In a different embodiment, all of the projectors project light at the same wavelength so that each camera responds to any light within its FOV.

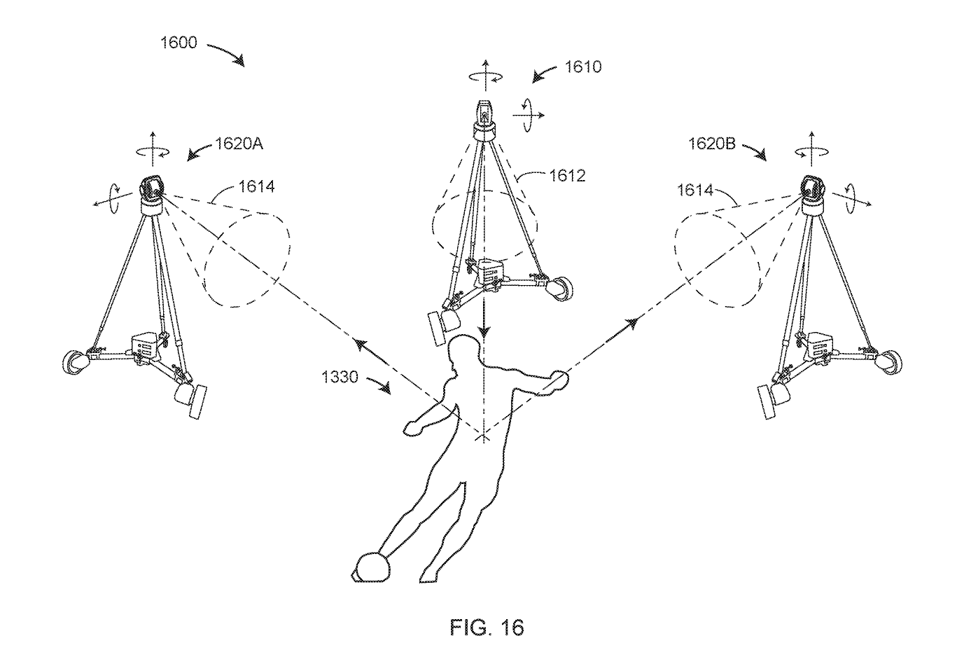

In an embodiment, 3D coordinates are determined based at least in part on triangulation. A triangulation calculation requires knowledge of the relative position and orientation of at least one projector such as 1310A and one camera such as 1320A. Compensation (calibration) methods for obtaining such knowledge are described herein below, especially in reference to FIGS. 16-22.

In another embodiment, 3D coordinates are obtained by identifying features or targets on an object and noting changes in the features or target as the object 1330 moves. The process of identifying natural features of an object 1330 in a plurality of images is sometimes referred to as videogrammetry. There is a well-developed collection of techniques that may be used to determine points associated with features of objects as seen from multiple perspectives. Such techniques are generally referred to as image processing or feature detection. Such techniques, when applied to determination of 3D coordinates based on relative movement between the measuring device and the measured object, are sometimes referred to as videogrammetry techniques.

The common points identified by the well-developed collection of techniques described above may be referred to as cardinal points. A commonly used but general category for finding the cardinal points is referred to as interest point detection, with the detected points referred to as interest points. According to the usual definition, an interest point has a mathematically well-founded definition, a well-defined position in space, an image structure around the interest point that is rich in local information content, and a variation in illumination level that is relatively stable over time. A particular example of an interest point is a corner point, which might be a point corresponding to an intersection of three planes, for example. Another example of signal processing that may be used is scale invariant feature transform (SIFT), which is a method well known in the art and described in U.S. Pat. No. 6,711,293 to Lowe. Other common feature detection methods for finding cardinal points include edge detection, blob detection, and ridge detection.

In a method of videogrammetry applied to FIG. 13, the one of more cameras 1320A, 1320B identify cardinal points of the object 1330, which in an embodiment is a moving object. Cardinal points are tagged and identified in each of multiple images obtained at different times. Such cardinal points may be analyzed to provide registration of the moving object 1330 over time. If the object being measured is nearly featureless, for example, having a large flat surface, it may not be possible to obtain enough cardinal points to provide an accurate registration of the multiple object images. However, if the object has a lot of features, as is the case for the person and ball comprising the object 1330, it is usually possible to obtain relatively good registration of the multiple captured 2D images.

A way to improve the registration of multiple 2D images or multiple 3D images using videogrammetry is to further provide object features by projecting an illuminated pattern onto the object. If the object 1330 and the projector(s) are stationary, the pattern on the object remains stationary even if the one or more cameras 1320A, 1320B are moving. If the object 1330 is moving while the one or more cameras 1320A, 1320B and the one or more projectors 1310A, 1310B remain stationary, the pattern on the object changes over time. In either case, a projected pattern can assist in the registration of the 2D or 3D images. Whether the pattern is stationary or moving on the object, it can be used to assist in registering the multiple images.

The use of videogrammetry techniques is particularly powerful when combined with triangulation methods for determining 3D coordinates. For example, if the pose of a first camera is known in relation to a second camera (in other words, the baseline between the cameras and the relative orientation of the cameras to the baseline are known), then common elements of a pattern of light from one or more projectors 1310A, 1310B may be identified and triangulation calculations performed to determine the 3D coordinates of the moving object.

Likewise if the pose of a first projector 1310A is known in relation to a first camera 1320A and if a processor is able to determine a correspondence among elements of the projected pattern and the captured 2D image, then 3D coordinates may be calculated in the frame of reference of the projector 1310A and the camera 1320A. The obtaining of a correspondence between cardinal points or projected pattern elements is enhanced if a second camera is added, especially if an advantageous geometry of the two cameras and the one projector, such as that illustrated in FIG. 3, is used.

As explained herein above with reference to FIG. 1B, methods of active triangulation or passive triangulation may be used to determine 3D coordinates of an object 1330. In an embodiment, one of the two channels of the one or more dichroic cameras 1320A, 1320B is used to collect videogrammetry information while the second of the two channels is used to collect triangulation information. The videogrammetry and triangulation data may be distinguished in the two channels according to differences in wavelengths collected in the 2D images of the two channels. In addition, or alternatively, one or the two channels may have a larger FOV than the other, which may make registration easier.

A useful capability of the one or more dichroic cameras 1220A, 1220B is in capturing object color (texture) and projecting this color onto a 3D image. It is also possible to capture color information with a separate camera that is not a dichroic camera. If the relative pose of the separate camera is known in relation to the dichroic camera, it may be possible to determine the colors for a 3D image. However, as explained herein above, such a mathematical determination from a separate camera is generally more complex and less accurate than determination based on images from a dichroic camera. The use one or more dichroic cameras 1220A, 1220B as opposed to single-channel cameras provides potential advantages in improving accuracy in determining 3D coordinates and in applying color (texture) to the 3D image.

In an embodiment, one or more artificial targets are mounted on the object 1330. In an embodiment, the one or more artificial targets are reflective spots that are illuminated by the one or more projectors 1310A, 1310B. In an alternative embodiment, the one or more artificial targets are illuminated points of light such as LEDs. In an embodiment, one of the two channels of the one or more dichroic cameras 1320A, 1320B are configured to receive light from the LEDs, while the other of the two channels is configured to receive a color image of the object. The channel that receives the signals from the reflective dots or LEDs may be optimized to block out light having wavelengths different than those returned by the reflective dots or the LEDs, thus simplifying calculation of 3D coordinates of the object surface. In an embodiment, a first channel of the one or more dichroic cameras 1320A, 1320B is configured to pass infrared light from the reflective dots or LEDs, while the second channel is configured to block infrared light while passing visible (colored) light.

In FIG. 13, the object 1330 includes two separate object elements, 1332 and 1334. In the instant shown in FIG. 13, the two object elements 1332 and 1334 are in physical contact, but a moment later the object 1334 will be separated from the object 1332. The volume the system 1300 is able to capture depends on the FOV and the number of the one or more projectors 1310A, 1310B and on the FOV and the number of the one or more cameras 1320A, 1320B.

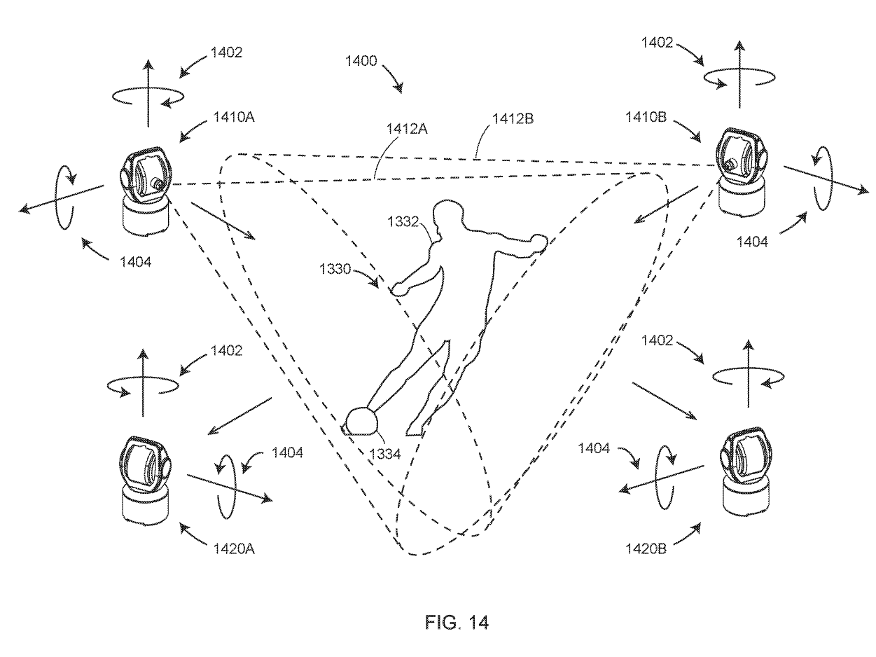

FIG. 14 illustrates a method of capturing dimensional aspects of an object 1330, which may be a moving object, with the system 1400 including one or more projectors 1410A, 1410B and one or more cameras 1420A, 1420B. Each of the one or more projectors 1410A, 1410B emits a light 1412A, 1412B, respectively. The one or more projectors 1410A, 1410B and the one or more cameras 1420A, 1420B are steerable about two axes 1402 and 1404. In an embodiment, the axis 1402 is a vertical axis and axis 1404 is a horizontal axis. Alternatively, the first axis 1402 is a vertical axis and the second axis 1404 is a horizontal axis. In an embodiment, a first motor (not shown) rotates the direction of the projector 1410A, 1410B or camera 1420A, 1420B about the first axis 1402, and a first angle transducer (not shown) measures the angle of rotation about the first axis 1402. In an embodiment, a second motor (not shown) rotates the direction of the projector 1410A, 1410B or camera 1420A, 1420B about the second axis 1404, and a second angle transducer (not shown) measures the angle of rotation about the second axis 1404. In an embodiment, the cameras 1420A, 1420B are dichroic cameras. In another embodiment, the cameras 1420A, 1420B are rotatable but not dichroic.

In an embodiment, the motors are configured to track the object 1330. In the event that multiple objects are separated, different projectors and cameras may be assigned different objects of the multiple objects to follow. Such an approach may enable tracking of the ball 1304 and the player 1302 following the kick of the ball by the player.

Another potential advantage of having motorized rotation mechanisms 1402, 1404 for the projectors and cameras is the possibility of reducing the FOV of the projectors and cameras to obtain higher resolutions. This will provide, for example, more accurate and detailed 3D and color representations. The angular accuracy of steering mechanisms of the sort shown in FIGS. 13 and 14 may be on the order of 5 microradians, which is to say that for an object at a distance of 5 meters from a projector or camera, the angle measurement error in the calculated transverse (side-to-side) position of an object point is about (5 m)(5 μm/m)=25 μm.

A number of different steering mechanisms and angle transducers may be used. The steering mechanisms 1402, 1404 illustrated in FIGS. 13 and 14 may comprise a horizontal shaft and a vertical shaft, each shaft mounted on a pair of bearings and each driven by a frameless motor. In the examples of FIGS. 13 and 14, the projector or camera may be directly mounted to the horizontal shaft 1404, but many other arrangements are possible. For example, a mirror may be mounted to the horizontal shaft to reflect projected light onto the object or reflect scattered light from the object onto a camera. In another embodiment, a mirror angled at 45 degrees rotates around a horizontal axis and receives or returns light along the horizontal axis. In other embodiments, galvanometer mirrors may be used to send or receive light along a desired direction. In another embodiment, a MEMS steering mirror is used to direct the light into a desired direction. Many other steering mechanisms are possible and may be used. In an embodiment, an angular encoder is used to measure the angle of rotation of the projector or camera along each of the two axes. Many other angle transducers are available and may be used.

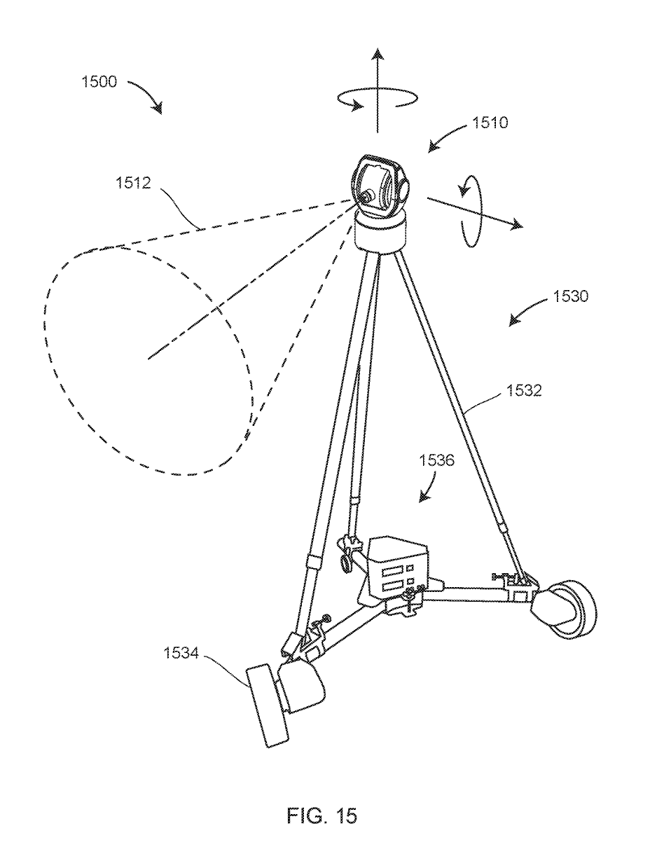

FIG. 15 is a perspective view of mobile device 1500 that includes a rotatable device 1510 on a mobile platform 1530. The rotatable device 1510 may be a rotatable projector such as 1410A, 1410B or a rotatable camera such as 1420A, 1420B. The rotatable device may have a FOV 1512. In an embodiment, the mobile platform 1530 is a tripod 1532 mounted on wheels 1534. In an embodiment, the mobile platform further includes motorized elements 1536 to drive the wheels.

Triangulation devices such as 3D imagers and stereo cameras have a measurement error approximately proportional to the Z²/B, where B is the baseline distance and Z is the perpendicular distance from the baseline to an object point being measured. This formula indicates that error varies as the perpendicular distance Z times the ratio of the perpendicular distance divided by the baseline distance. It follows that it is difficult to obtain good accuracy when measuring a relatively distant object with a triangulation device having a relatively small baseline. To measure a relatively distant object with relatively high accuracy, it is advantageous to position the projector and camera of a 3D imager relatively far apart or, similarly, to position the two cameras of a stereo camera relatively far apart. It can be difficult to achieve the desired large baseline in an integrated triangulation device in which projectors and cameras are attached fixedly to a base structure.

A triangulation system that supports flexible configuration for measuring objects at different distances, including relatively long distances, is now described with reference to FIGS. 16-21. FIG. 16 is a perspective view of a system 1600 that includes a rotatable projector 1610, a first rotatable camera 1620A, and a second rotatable camera 1620B. As illustrated in FIG. 16, the rotatable devices 1610, 1620A, and 1620B are special cases of the mobile device 1500. In other embodiments, the rotatable devices 1610, 1620A, and 1620B are replaced with devices 1410, 1420A, and 1420B, respectively, fixed in a building rather than mounted on a mobile platform 1530. In an embodiment, the projector 1610 projects a pattern of light 1612 onto an object 1330. The cameras 1520A, 1520B capture reflected light 1614 from the projected pattern and determine 3D coordinates of the object. As explained herein above, many types of patterns may be projected. Cameras may be dichroic cameras that capture color images and provide videogrammetry as well as images that provide information for determining 3D coordinates. In an embodiment, markers such as reflective spots or LEDs are placed on the object 1330.

In an embodiment, the projector 1610 and the cameras 1620A, 1620B are not arranged in a straight line but area rather arranged in a triangular pattern so as to produce two epipoles on each reference plane, as illustrated in FIG. 4B. In this case, it may be possible to determine to 3D coordinates based on the projection of an uncoded pattern of spots, for example, by projecting laser light through a diffractive optical element. Such a method is particularly valuable when the object is at long distances from the projector, especially when the distance from the projector is variable, as spots of laser light remain focused at near distances and at far distances, while spots of LED light do not.

In an embodiment, the two steering angles of the projector 1610 and the cameras 1620A, 1620B are known to high accuracy. For example, angular encoders used with shafts and bearings as described herein above in reference to FIG. 14 may have an angular accuracy of less than 10 microradians. With this relatively high angular accuracy, it is possible to steer the projector 1610 and cameras 1620A, 1620B to follow the object 1330 over a relatively large volume. This can be done even if the fields of view of the projector 1610 and the cameras 1620A, 1620B are relatively small. Hence it is possible to obtain relatively high accuracy over a relatively large volume while retaining a relatively high 3D and color resolution. In addition, if the mobile platform 1530 is motorized, the cameras and projector may be automatically positioned as required to capture objects over a particular volume and from a particular perspective.

To make a triangulation calculation based on measurements performed by a plurality of cameras in a stereo configuration or by a camera and a projector in a 3D imager configuration, it is important to know the relative pose of the cameras and projectors in a given arrangement. FIG. 17A shows a compensation method 1700A that may be used to determine the relative pose between two separated and moveable cameras 1420A and 1420B. A calibration plate 1710 includes a pattern having a known spacing of pattern elements 1712. The pattern is measured by each of cameras 1420A and 1420B. By comparing the recorded images to the measured positions of the spots in the images obtained by the cameras 1420A and 1420B to the known positions of the pattern elements, it is possible to determine the relative pose of the two cameras 1420A and 1420B. By collecting multiple images with the cameras 1420A and 1420B of the calibration plate moved to a number of different positions and orientations, it is further possible for the system to determine compensation parameters, which might include correction coefficients or correction maps (values). In an embodiment, the calibration plate 1710 is mounted on a mobile platform 1530, which in an embodiment includes motorized elements 1536 to drive wheels 1534. An advantage of providing the mobile platform 1530 with motorized wheels is that the calibration plate 1710 can be moved any desired distance from the cameras 1420A, 1420B according to the rotation angle of the cameras. Hence the overall stereo camera arrangement 1700A of FIG. 17A may be configured to measure relatively large objects or relatively small objects and be further configured to be readily compensated for the selected baseline distance and orientations of the cameras 1420A, 1420B.

FIG. 17B shows a compensation method 1700B that may be used to determine the relative pose between a camera 1420A and a separated projector 1410A. In an embodiment, in a first step, the camera 1420A measures the positions of each of the spots on the calibration plate 1710. In a second step, the projector 1410A projects a pattern onto the calibration plate, which is measured by the camera 1420A. The results of the measurements performed in the first step and the second step are combined to determine the relative pose of the camera 1420A and the projector 1410A. In an embodiment, the calibration plate is moved to additional positions and orientations, and the first and second steps of the measurement procedure are repeated. By analyzing the collected images and comparing these to the programmed projection patterns of the projector 1410A, coefficients or maps may be determined to correct for aberrations in the camera 1420A and the projector 1410A.

FIG. 17C shows a compensation method 1700C that may be used to determine the relative pose between a first camera 1420A, a second camera 1420B, and a projector 1410A in a triangular arrangement 1702. The two cameras 1420A, 1420B and one projector 1410A in this triangular arrangement are similar in function to the two cameras 310, 330 and one projector 350 of FIG. 3. The arrangement of FIG. 17C has epipolar constraints described herein above in reference to FIG. 4B. In an embodiment of a compensation method, in a first step, the cameras 1420A, 1420B determine the 3D coordinates of each of the spots on the calibration plate. Each of these 3D coordinates can be compared to the calibrated position of the spots, previously obtained using a high accuracy 2D measuring device. In a second step, the projector 1410A projects a pattern onto the calibration plate. The pattern as projected onto the spots is measured by the cameras 1420A and 1420B. The results of the measurements performed in the first step and the second step are combined to determine the relative pose of the cameras 1420A, 1420B and the projector 1410A. In an embodiment, the calibration plate is moved to additional positions and orientations, and the first and second steps of the measurement are repeated in each case. These additional positions and orientations help provide information on the aberrations of the lens systems in the cameras 1420A, 1420B and the projector 1410A.

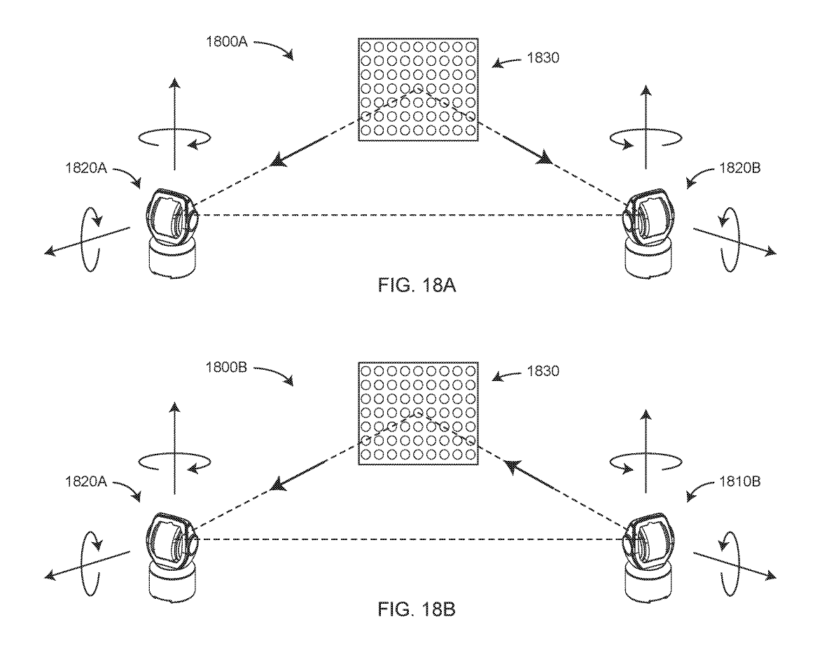

In some cases, the separated cameras and projectors of a 3D triangulation measurement system may be located mounted on a fixed stand. In this case, it may be convenient to mount the calibration artifact (for example, calibration plate 1710) fixed in place, for example, on a wall. FIG. 18A is a perspective view of a stereoscopic camera system 1800A that includes two separated but fixed cameras 1820A, 1820B and a fixed calibration target 1830 having target elements 1832. In an embodiment, the cameras 1820A, 1820B include a motorized rotation mechanism. In an embodiment, the cameras are capable of rotation about two axes—for example, a horizontal axis and a vertical axis. In an embodiment, the cameras 1820A, 1820B rotate to a plurality of different directions to complete the compensation procedure.

FIG. 18B is a perspective view of a 3D imager 1800B that includes a rotatable camera 1820A, a rotatable projector 1810A, and a fixed calibration target 1830 having target elements 1832. In an embodiment, the rotatable projector 1810A and rotatable camera 1820A each include a motorized rotation mechanism, each motorized rotation mechanism capable of rotation about two axes.

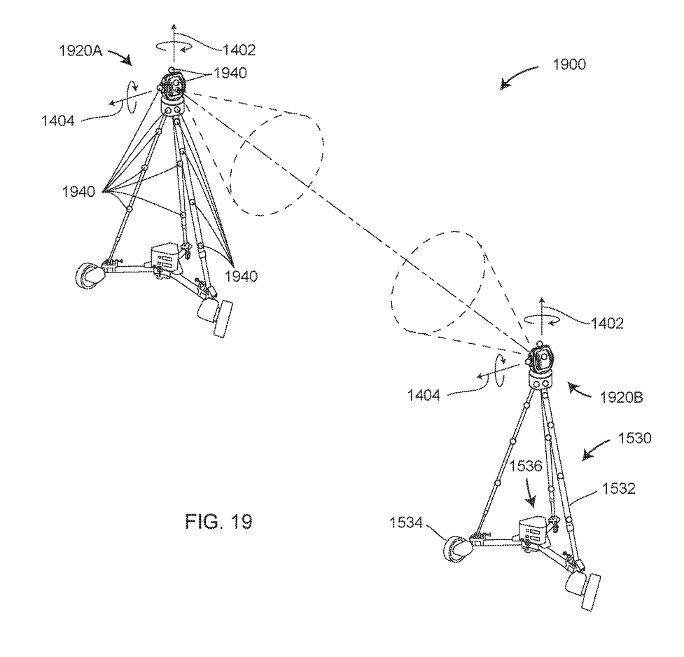

FIG. 19 illustrates a method 1900 to learn the relative pose (i.e., six degree-of-freedom pose) of two camera systems 1920A, 1920B, which might be needed, for example, to perform triangulation measurements. The camera systems 1920A, 1920B include cameras 1420A, 1420B, respectively, each camera system mounted on a mobile platform 1530 having a tripod 1532 mounted on wheels 1534. In an embodiment, the wheels are motorized by a motor assembly 1536. The camera systems 1920A, 1920B further include light spots 1940 that may be reflective spots or light sources such as LEDs. In an embodiment, a rotation mechanism rotates each camera about two axes such as the axes 1402 and 1404. In an embodiment, the angle of rotation about each axis is measured by an angular transducer such as an angular encoder, which is internal to the camera system. In an embodiment, the angles are measured to a relatively high accuracy, for example, to 10 microradians or better. In an embodiment, a compensation method includes rotating each of the cameras to capture the light spots 1940 on the opposing camera and evaluating the images obtained by the cameras 1920A, 1920B to determine the relative pose of the cameras. In an embodiment, the motorized wheels permit the cameras to be moved to any selected location and the light spots measured afterwards by each camera 1920A, 1920B to determine the relative pose.

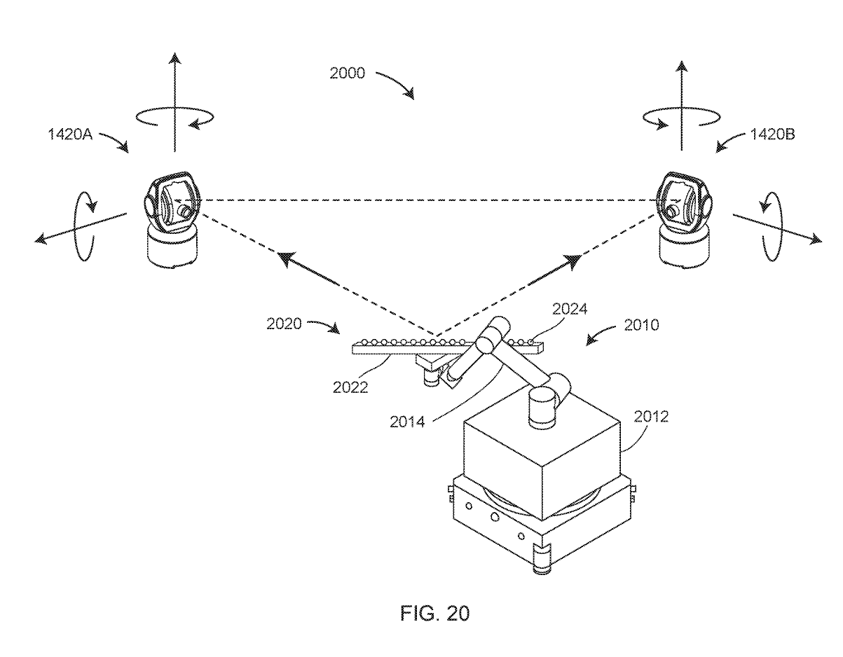

FIG. 20 illustrates another method 2000 for automatically compensating stereo cameras 1420A, 1420B. A mobile robotic device 2010 includes a mobile base 2012 configured to move on wheels and a robotic arm 2014. A scale bar 2020, which includes target marks 2024, is moved to a number of positions and orientations by the mobile robotic device 2010. The marks 2024 may for example be points of light such as LEDs or reflective elements such as reflective dots. In an embodiment, the system determines the relative pose of the cameras 1420A, 1420B based at least in part on the images of the marks obtained from the different positions of the scale bar 2020. The pose information is sufficient for the two cameras 1420A, 1420B to carry out triangulation calculations to determine 3D coordinates of an object surface. An advantage of the arrangement of FIG. 20 is that a compensation procedure can be automatically carried out to determine the relative pose of the cameras, even if the cameras are moved to new positions and if the baseline or camera angles are changed.

FIG. 21A is a cross-sectional schematic representation of internal camera assembly 2100A that is part of the rotating camera 2100A. The internal camera assembly 2100B includes a camera lens assembly 2110B having a perspective center 2112B, which is the center of the lens entrance pupil. The entrance pupil is defined as the optical image of the physical aperture stop as seen through the front of the lens system. The ray that passes through the center of the entrance pupil is referred to as the chief ray, and the angle of the chief ray indicates the angle of an object point as received by the camera. A chief ray may be drawn from one of the target points 2120A through the entrance pupil. For example, the ray 2114B is a possible chief ray that defines the angle of an object point (on the ray) with respect to the camera lens 2110B. This angle of the object point is defined with respect to an optical axis 2116B of the lens 2110B.

The exit pupil is defined as the optical image of the physical aperture stop as seen through the back of the lens system. The point 2118B is the center of the exit pupil. The chief ray travels from the point 2118B to a point on the photosensitive array 2120B. In general, the angle of the chief ray as it leaves the exit pupil is different than the angle of the chief ray as it enters the perspective center (the entrance pupil). To simplify analysis, the ray path following the entrance pupil is adjusted to enable the beam to travel in a straight line through the perspective center 2112B to the photosensitive array 2120B as shown in FIG. 21B. Three mathematical adjustments are made to accomplish this. First, the position of each imaged point on the photosensitive array is corrected to account for lens aberrations and other systematic error conditions. This may be done by performing compensation measurements of the lens 2110B, for example, using methods described in reference to FIGS. 17A, 18A, and 19. Second, the angle of the ray 2122B is changed to equal the angle of the ray 2114B that passes through the perspective center 2112B. The distance from the exit pupil 2118B to the photosensitive array 2120B is adjusted accordingly to place the image points at the aberration-corrected points on the photosensitive array 2120B. Third, the point 2118B is collapsed onto the perspective center 2112B to remove the space 2124B, enabling all rays of light 2114B emerging from the object to pass in a straight line through the point 2112B onto the photosensitive array 2120B, as shown in FIG. 21B. By this approach, the exact path of each beam of light passing through the optical system of the camera 2100B may be simplified for rapid mathematical analysis. This mathematical analysis may be performed by the electrical circuit and processor 2126B in a mount assembly 2128B or by processors elsewhere in the system or in an external network. In the discussion herein below, the term perspective center is taken to be the center of the entrance pupil with the lens model revised to enable rays to be drawn straight through the perspective center to a camera photosensitive array or straight through the perspective center to direct rays from a projector pattern generator device.

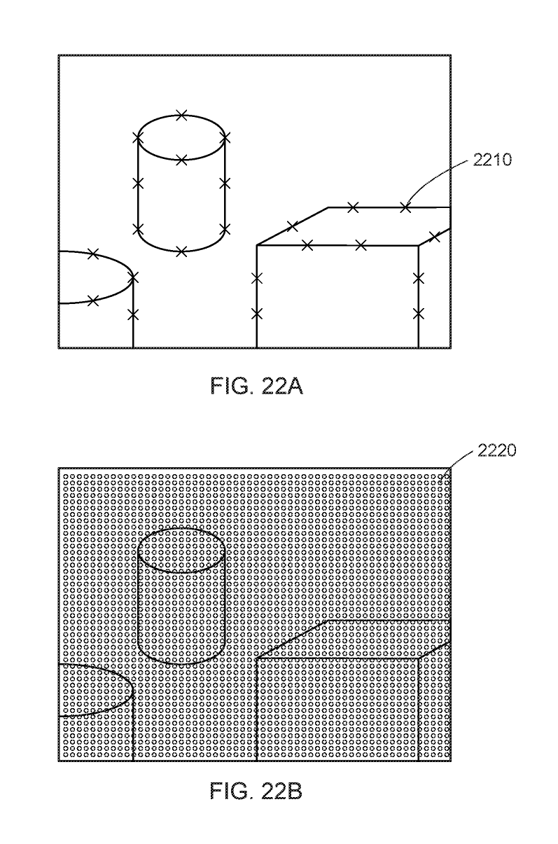

As explained herein above, a videogrammetry system that includes a camera may be used in combination with a 3D imager that includes at least one camera and one projector. The projector may project a variety of patterns, as described herein above. FIG. 22A shows a 2D image that includes two cylinders and a cube. Cardinal points of the objects in the 2D image of FIG. 22A have been tagged with marks 2210. Common marks seen in successive images provide a way to register the successive images. FIG. 22B shows a 2D image of the same objects onto which a pattern of light has been projected from a projector of a 3D imager. For example, a possible type of projected pattern includes a collection of simple dot elements 2220. In an embodiment, 3D measurements of objects such as those represented in FIGS. 22A and 22B are performed using a 3D triangulation device 900 that use dichroic cameras to perform a combination of videogrammetry and 3D imaging based on projected patterns of light.

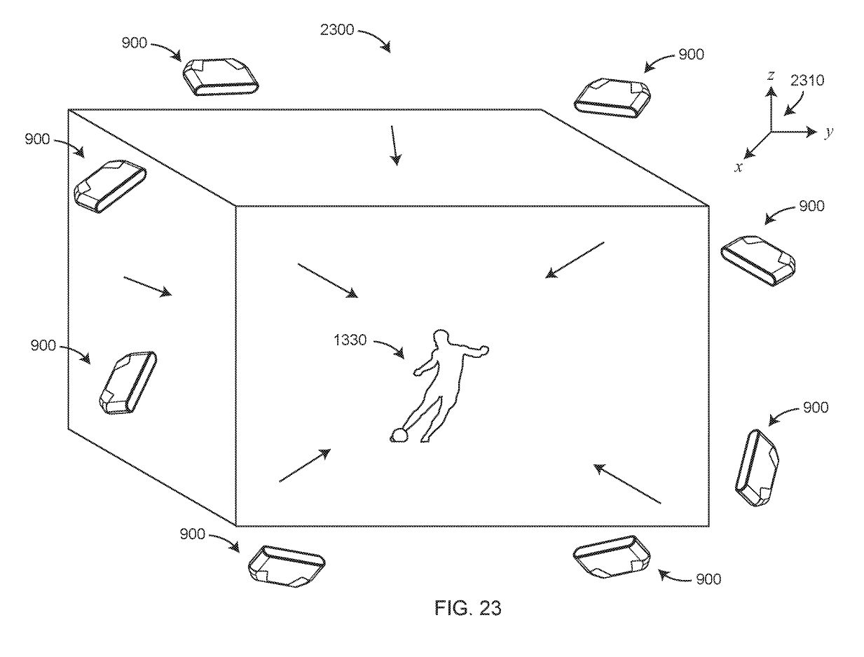

In the measurement scenario 1300 of FIG. 13, a number of individual cameras and projectors are used to capture a moving object 1330. This approach is extended and made more powerful in the measurement scenario 2300 of FIG. 23 by replacing the individual cameras and projectors with 3D triangulation devices 900. An advantage of this approach is that a moving object 1330 may be captured in 3D and in color from all directions. In an embodiment, the 3D triangulation devices 900 project a pattern of infrared (IR) light and at the same time capture color images with a videogrammetry camera. This enables the 3D color images to be obtained without needing to remove unwanted projection artifacts in post-processing steps.

The accuracy of the composite 3D image of the object 1330 is improved if the pose of each of the 3D triangulation systems 900 in the measurement scenario 2300 is known within a common frame of reference 2310. A way to determine the pose of each system 900 is now described.

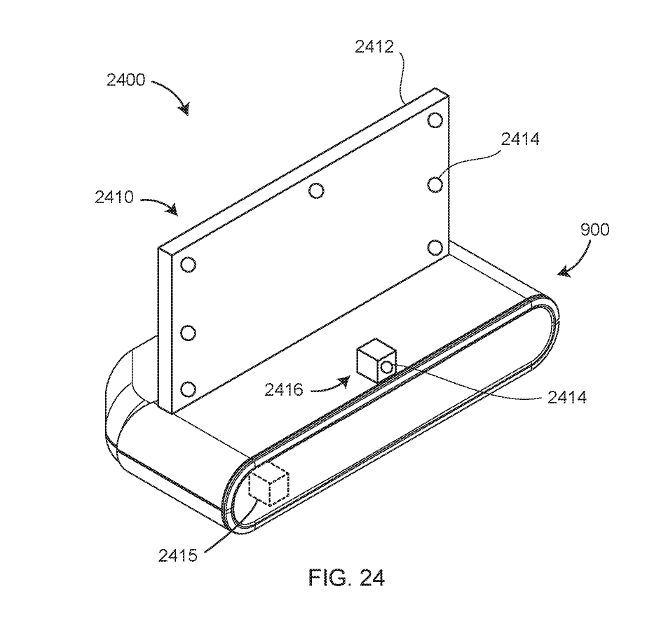

FIG. 24 shows an enhanced 3D triangulation device 2400 that includes a 3D triangulation device 900 to which has been added a registration apparatus 2410. As will be explained herein below, the addition of the registration apparatus 2410 allows a rotating camera to determine the pose of the device 2400. In an embodiment, the apparatus 2410 includes a mounting plate 2412 on which are attached a collection of light marks 2414. The light marks might be, for example, light sources such as LEDs or reflective spots or reflective spots or passive marks like printed dots. The light marks may be placed on both sides and on the edges of the mounting plate 2412. The apparatus 2410 may include one or more separated light-mark elements 2414 having a separate structure 2416. In general, any combination of light marks that may be recognized by a camera may be used in the apparatus 2410. In other embodiments, the apparatus includes light marks positioned around or placed directly on the 3D triangulation device 900 without use of a plate 2412.

Although this sort of monitoring enables continual movement of the 3D triangulation system 1100B, use of the phase-shift method requires that the 3D measuring device 2500A be held stationary until a complete sequence of phase measurements is completed.

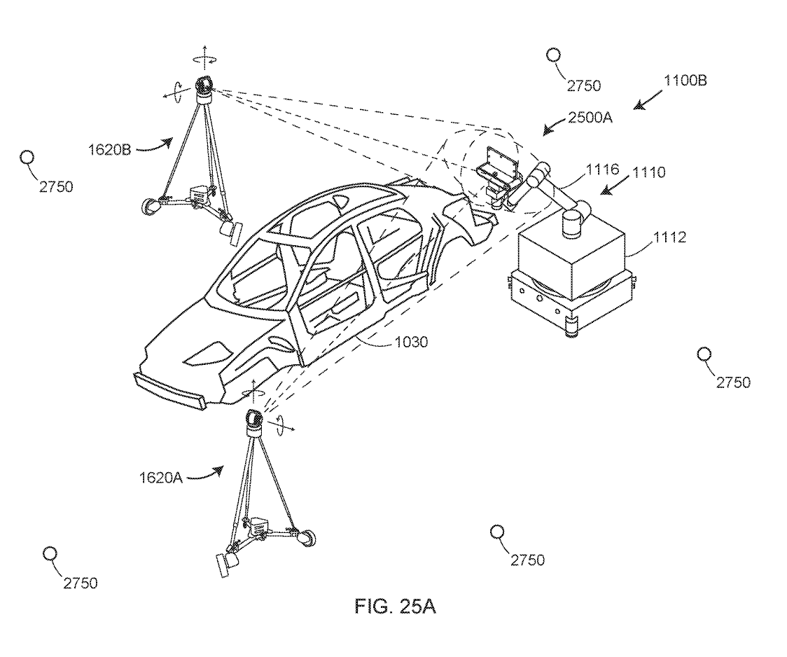

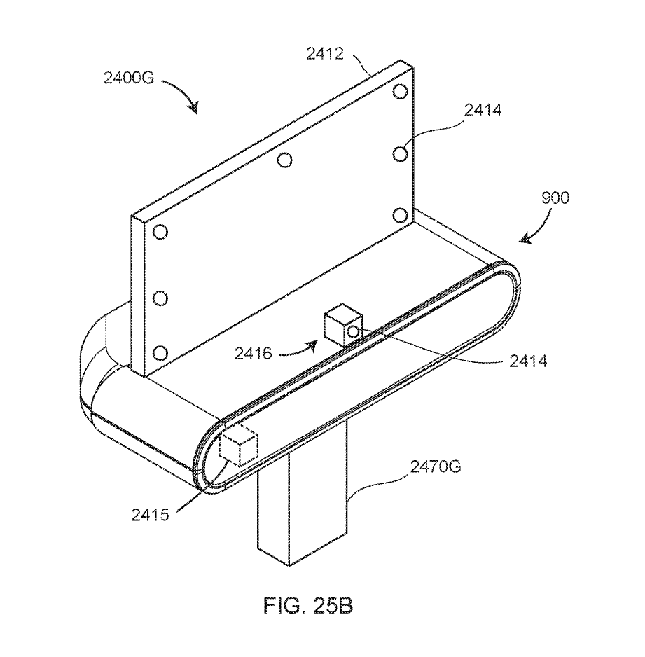

FIG. 25A illustrates a measurement scenario in which a 3D triangulation system 1100B includes a motorized robotic base 1110 and 3D measuring device 2500A. The motorized robotic base 1110 includes a mobile platform 1112 on which is mounted a robotic arm 1116 that holds the 3D measuring device 2500A. The motorized robotic platform 1112 includes wheels that are steered under computer or manual control to move the 3D triangulation system 1100B to a desired position. The robotic arm 1116 is capable of moving the 3D measuring device 2500A up and down and left and right. It can tilt the 3D measuring device into any desired position and can extend the 3D measuring device 2500A, for example, inside the interior of an object 1030, which in an embodiment is an automotive body-in-white. Furthermore the motorized robotic base 1110 is capable of moving the 3D triangulation system 1100B side-to-side under computer control to automatically complete measurement of the object.

In an embodiment illustrated in FIG. 25B, the pose of the 3D measuring device 2500A is continually monitored by the rotating cameras 1620A, 1620B, which are used in a stereo configuration similar to that of FIG. 25A. Because the two rotating camera assemblies continually measure at least three light marks in common on the 3D measuring device 1620A, the relative pose of the device 2400 is known at all times. In an embodiment, the 3D measuring device measures 3D coordinates of an object 1030 continually while the motorized wheels move the motorized robotic base 1110 continually. Hence it is possible for the cameras 1620A, 1620B to measure the pose of the device 2400 continually, for example, at 30 frames per second or faster. In an embodiment, the frame capture times of the cameras in the rotating camera assemblies 1620A, 1620B are synchronized with the exposure capture times of the cameras and projectors in the device 2400, thereby enabling accurate locating of the 3D measuring device 2400 as it is moved continually from point to point. In an embodiment, the accuracy of the tracking is further improved through the use of a Kalman filter, which monitors the calculated pose of the device 2400 and anticipates movements in the future. In so doing, the Kalman filter is able to apply intelligent filtering of data while further accounting for anticipated movements, thereby improving accuracy and reducing noise in the measured pose of the device 2400.

In an alternative embodiment illustrated in FIG. 25B, the enhanced 3D triangulation device 2400 is included as part of a handheld measurement device such as the device 2400G, which is the same as the device 2400 except that it further includes a handle 2470G that an operator may use to move the device 2400G freely from location to location.

In another embodiment illustrated in FIG. 25A, the 3D measuring device 2500A uses a sequential imaging method that provides higher accuracy than single-shot methods. Sequential imaging methods require that the measuring 3D measuring device 2500A be held stationary during the projection and imaging of a sequence of patterns. In an embodiment described herein below in reference to FIGS. 26A-D and FIG. 27, the sequential imaging method is based on projection of a phase-shifted sinusoidal pattern.

Although FIGS. 25A and 25B illustrate measurements in which the 3D measuring device includes one of the 3D triangulation devices 900 that include a dichroic camera, the methods described with reference to FIGS. 25A and 25B can equally well be applied to 3D triangulation devices that do not include a dichroic camera assembly. In other words, any of the devices illustrated in FIG. 1A, 1B, 2, or 3, for example, may be used in place of the 3D triangulation device 900 embedded in FIGS. 25A and 25B.

To determine 3D coordinates based on stereo triangulation calculations such as those illustrated in FIG. 25A, it is necessary to determine the relative pose of the rotating camera assemblies 1620A, 1620B. One way to determine the relative pose of the rotating cameras 1620A, 1620B is by using the method described herein above with respect to FIG. 19. Alternatively, the methods of FIG. 17A, 18, or 20 could be used. It may sometimes happen that the 3D measuring device 2500A is moved to a position not within the FOV of one of the rotating camera assemblies 1620A, 1620B. When this happens, one of the rotating camera assemblies may be moved to new location. In this case, it is necessary to re-establish the relative pose of the two cameras 1620A, 1620B in relation to their original pose so that the 3D coordinates provided by the 3D measuring device 2500A can be put into the same frame of reference as before the moving of the rotating camera assembly. A convenient way to do this is to establish a pose within the frame of reference of the environment by providing a collection of targets 2750 viewable by the rotating camera assemblies 1620A, 1620B. When the rotating cameras are first moved into position, they each measure at least three of the same targets. The 3D coordinates measured by the cameras are enough to determine the pose of the cameras 1620A, 1620B in the frame of reference of the environment. Later, when one or both of the cameras 1620A, 1620B are moved, the targets 2750 can be measured again to re-establish the positions of the cameras in the frame of reference of the environment.

To establish the pose within a frame of reference of the environment, it is also necessary to measure a known reference length with the cameras 1620A, 1620B to provide a length scale for the captured images. Such a reference length may be provided for example by a scale bar having a known length between two reference targets. In another embodiment, a scale may be provided by two reference targets measured by another method. For example, a laser tracker may be used to measure the distance between an SMR placed in each of two kinematic nests. The SMR may then be replaced by a reference target placed in each of the two kinematic nests. Each reference target in this case, may include a spherical surface element that rotates within the kinematic nest and in addition include a reflective or illuminated element centered on the sphere.

An explanation is now given for a known method of determining 3D coordinates on an object surface using a sequential sinusoidal phase-shift method, as described with reference to FIGS. 26A-D and FIG. 27. FIG. 26A illustrates projection of a sinusoidal pattern by a projector 30 in a device 2600. In an embodiment, the sinusoidal pattern in FIG. 26A varies in optical power from completely dark to completely bright. A minimum position on the sine wave in FIG. 26A corresponds to a dark projection and a maximum position on the sine wave corresponds to a bright projection. The projector 30 projects light along rays that travel in constant lines emerging from the perspective center of the projector lens. Hence in FIG. 26A, a line along the optical axis 34 in FIG. 26A represents a point neither at a maximum nor minimum of the sinusoidal pattern and hence represents an intermediate brightness level. The relative brightness will be the same for all points lying on a ray projected through the perspective center of the projector lens. So, for example, all points along the ray 2615 are at maximum brightness level of the sinusoidal pattern. A complete sinusoidal pattern occurs along the lines 2610, 2612, and 2614, even though the lines 2610, 2612, and 2614 have different lengths.

In FIG. 26B, a given pixel of a camera 70 may see any of a collection of points that lie along a line drawn from the pixel through the perspective center of the camera lens assembly. The actual point observed by the pixel will depend on the object point intersected by the line. For example, for a pixel aligned to the optical axis 74 of the lens assembly 70, the pixel may see a point 2620, 2622, or 2624, depending on whether the object lies along the lines of the patterns 2610, 2612, or 2614, respectively. Notice that the position on the sinusoidal pattern is different in each of these three cases. In this example, the point 2620 is brighter than the point 2622, which is brighter than the point 2624.

FIG. 26C illustrates projection of a sinusoidal pattern by the projector 30, but with more cycles of the sinusoidal pattern projected into space. FIG. 26C illustrates the case in which ten sinusoidal cycles are projected rather than one cycle. The cycles 2630, 2633, and 2634 are projected at the same distances from the scanner 2600 as the lines 2610, 2612, and 2614, respectively, in FIG. 26A. In addition, FIG. 26C shows an additional sinusoidal pattern 2633.

In FIG. 26D, a pixel aligned to the optical axis 74 of the lens assembly 70A sees the optical brightness levels corresponding to the positions 2640, 2642, 2644, and 2646 for the four sinusoidal patterns illustrated in FIG. 26D. Notice that the brightness level at a point 2640 is the same as at the point 2644. As an object moves farther away from the scanner 2600, from the point 2640 to the point 2644, it first gets slightly brighter at the peak of the sine wave, and then drops to a lower brightness level at position 2642, before returning to the original relative brightness level at 2644.

In a phase-shift method of determining distance to an object, a sinusoidal pattern is shifted side-to-side in a sequence of at least three phase shifts. For example, consider the situation illustrated in FIG. 27. In this figure, a point 2702 on an object surface 2700 is illuminated by the projector 30. This point is observed by the camera 70 and the camera 60. Suppose that the sinusoidal brightness pattern is shifted side-to-side in four steps to obtained shifted patterns 2712, 2714, 2716, and 2718. At the point 2702, each of the cameras 70 and 60 measures the relative brightness level at each of the four shifted patterns. If for example the phases of the sinusoids for the four measured phases are 0={160°, 250°, 340°, 70° } for the positions 2722, 2724, 2726, and 2728, respectively, the relative brightness levels measured by the cameras 70 and 60 at these positions are (1+sin(θ))/2, or 0.671, 0.030, 0.329, and 0.969, respectively. A relatively low brightness level is seen at position 2724, and a relatively high brightness level is seen at the position 2728.

By measuring the amount of light received by the pixels in the cameras 70 and 60, the initial phase shift of the light pattern 2712 can be determined. As suggested by FIG. 26D, such a phase shift enables determination of a distance from the scanner 2600, at least as long as the observed phases are known to be within a 360 degree phase range, for example, between the positions 2640 and 2644 in FIG. 26D. A quantitative method is known in the art for determining a phase shift by measuring relative brightness values at a point for at least three different phase shifts (side-to-side shifts in the projected sinusoidal pattern). For a collection of N phase shifts of sinusoidal signals resulting in measured relative brightness levels xᵢ, a general expression for the phase φ is given by φ=tan⁻¹(−bᵢ/aᵢ)^{0.5}, where aᵢ=Σxⱼ cos(2πj/N) and bᵢ=Σxⱼ sin(2πj/N), the summation being taken over integers from j=0 to N−1. For special cases, simpler formulas may be used. For example, for the special case of four measured phases each shifted successively by 90 degrees, the initial phase value is given by tan⁻¹ ((x₄−x₂)/(x₁−x₃)).

The phase shift method of FIG. 27 may be used to determine the phase to within one sine wave period, or 360 degrees. For a case such as in FIG. 26D wherein more than one 360 interval is covered, the procedure may further include projection of a combination of relatively coarse and relatively fine phase periods. For example, in an embodiment, the relatively coarse pattern of FIG. 26A is first projected with at least three phase shifts to determine an approximate distance to the object point corresponding to a particular pixel on the camera 70. Next the relatively fine pattern of FIG. 26C is projected onto the object with at least three phase shifts, and the phase is calculated using the formulas given above. The results of the coarse phase-shift measurements and fine phase-shift measurements are combined to determine a composite phase shift to a point corresponding to a camera pixel. If the geometry of the scanner 2600 is known, this composite phase shift is sufficient to determine the three-dimensional coordinates of the point corresponding to a camera pixel using the methods of triangulation, as discussed herein above with respect to FIG. 1A. The term “unwrapped phase” is sometimes used to indicate a total or composite phase shift.

An alternative method of determining 3D coordinates using triangulation methods is by projecting coded patterns. If a coded pattern projected by the projector is recognized by the camera(s), then a correspondence between the projected and imaged points can be made. Because the baseline and two angles are known for this case, the 3D coordinates for the object point can be calculated.

An advantage of projecting coded patterns is that 3D coordinates may be obtained from a single projected pattern, thereby enabling rapid measurement, which is usually needed for example in handheld scanners. One disadvantage of projecting coded patterns is that background light can contaminate measurements, reducing accuracy. The problem of background light is avoided in the sinusoidal phase-shift method since background light, if constant, cancels out in the calculation of phase.

One way to preserve accuracy using the phase-shift method while minimizing measurement time is to use a scanner having a triangular geometry, as in FIG. 3. The three combinations of projector-camera orientation provide redundant information that may be used to eliminate some of the ambiguous intervals. For example, the multiple simultaneous solutions possible for the geometry of FIG. 3 may eliminate the possibility that the object lies in the interval between the positions 2744 and 2746 in FIG. 26D. This knowledge may eliminate a need to perform a preliminary coarse measurement of phase, as illustrated for example in FIG. 26B. An alternative method that may eliminate some coarse phase-shift measurements is to project a coded pattern to get an approximate position of each point on the object surface.

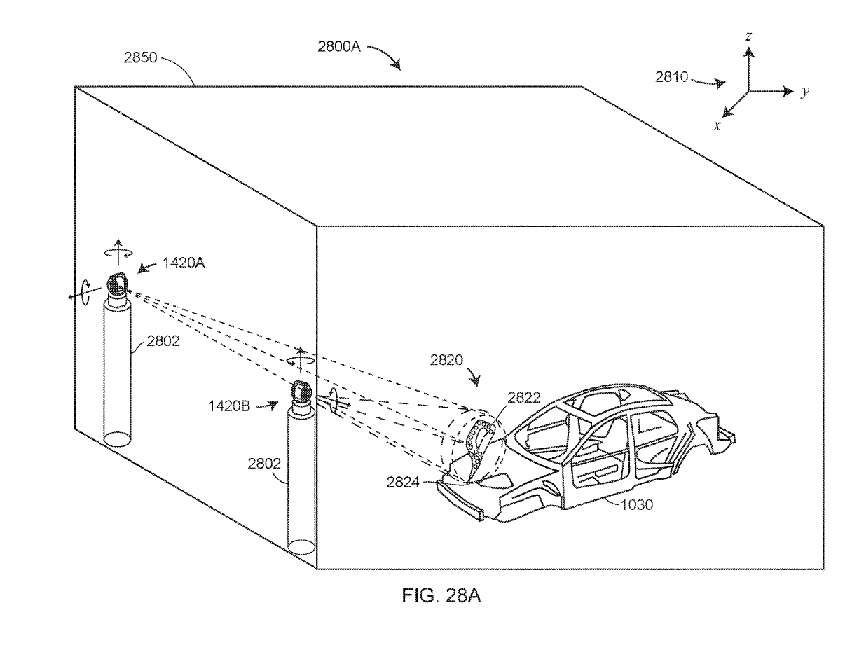

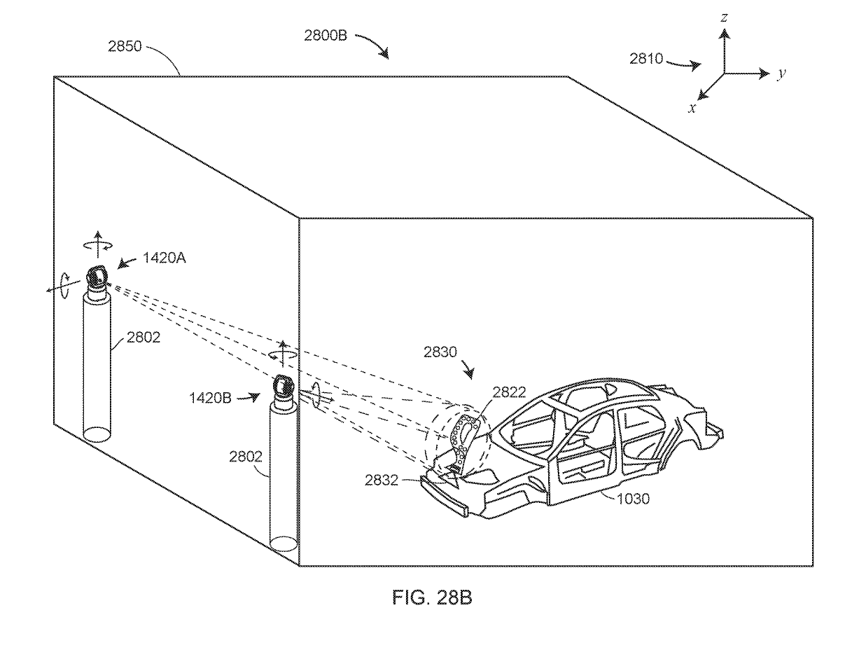

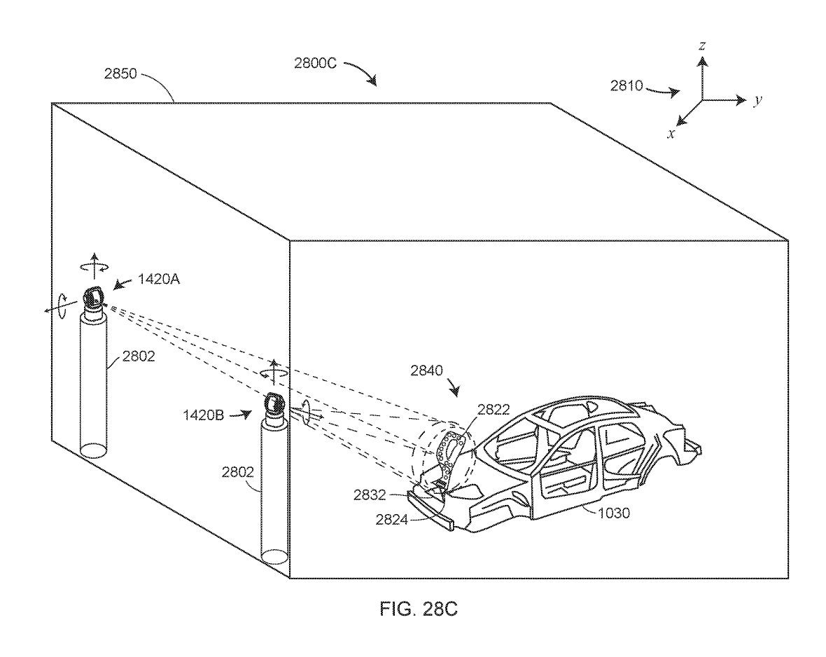

FIG. 28A illustrates a related inventive embodiment for a system 2800A in which a handheld measuring device 2820 is tracked by two rotating camera assemblies 1420A, 1420B placed in a stereo camera configuration. As in the case of the device 2400G, the handheld 3D measuring device 2820 includes a collection of light marks 2822, which might be LEDs or reflective dots, for example. The handheld measuring device 2820 includes a tactile probe brought into contact with the surface of an object 1030. In an embodiment, the tactile probe includes a probe tip in the shape of a sphere. The system 2800A determines the 3D coordinates of the center of the spherical probe tip 2824 in a frame of reference 2810. By getting a collection of such 3D coordinates, the collection of 3D coordinates may be corrected to remove the offset of the probe tip sphere radius, thereby giving the 3D coordinates of the object 1030. The rotating camera assemblies 1420A, 1420B each rotate about two axes, with an angular transducer provided to measure the angle of rotation of each axis. In an embodiment, the angular transducer is an angular encoder having a relatively high angular accuracy, for example, 10 microradians or less.

In an embodiment, the rotating camera assemblies 1420A, 1420B have a FOV large enough to capture the light marks 2822 on the handheld measuring device 2820. By rotating the camera assemblies 1420A, 1420B to track the handheld measuring device 2820, the system 2800A is made capable of measuring 3D coordinates over a relatively large measuring environment 2850 even though the FOV is relatively small for each of the camera assemblies 1420A, 1420B. The consequence of this approach is improved measurement accuracy over a relatively large measurement volume. In an embodiment, the rotating cameras 1420A, 1420B are raised in a fixed position, for example, on pillars 2802.

FIG. 28B illustrates an inventive embodiment for a system 2800B similar to the system 2800A except that the handheld 3D measuring device 2830 replaces the handheld 3D measuring device. The handheld 3D measuring device includes a line scanner 2832 in place of the tactile probe 2824. The line scanner 2832 has accuracy similar to that of a triangulation scanner that uses a sequential phase-shift method, but with the advantage that measurements may be made in a single shot. However, the line scanner 2832 collects 3D coordinates only over a projected line and hence must be swept to obtain 3D coordinates over an area. For the system 2800B, the handheld 3D measuring device 2830 may be tracked in real time. For example, in an embodiment, the capturing of the light marks 2822 by the rotating cameras 1420A, 1420B may be synchronized to the capturing of the line of light by the line scanner 2832. With this approach, 3D coordinates may be collected between 30 and 100 frames per second, for example.

In an embodiment illustrated in FIG. 28C, a system 2800C is similar to the systems 2800A and 2800B except that measurements are made with a handheld 3D measuring device 2840 having both a tactile probe tip 2824 and the line scanner 2832 mounted on a handheld body having the collection of light marks 2822. An advantage of the handheld measuring device 2840 is that it enables measurements of a surface to be collected at relatively high density at relatively high speed by the line scanner, while also enabling measurement of holes and edges with the tactile probe. The tactile probe is particularly useful in measuring features that would otherwise be inaccessible such as deep holes. It is also useful in measuring sharp edges, which might get smeared out slightly by measurement with a line scanner.

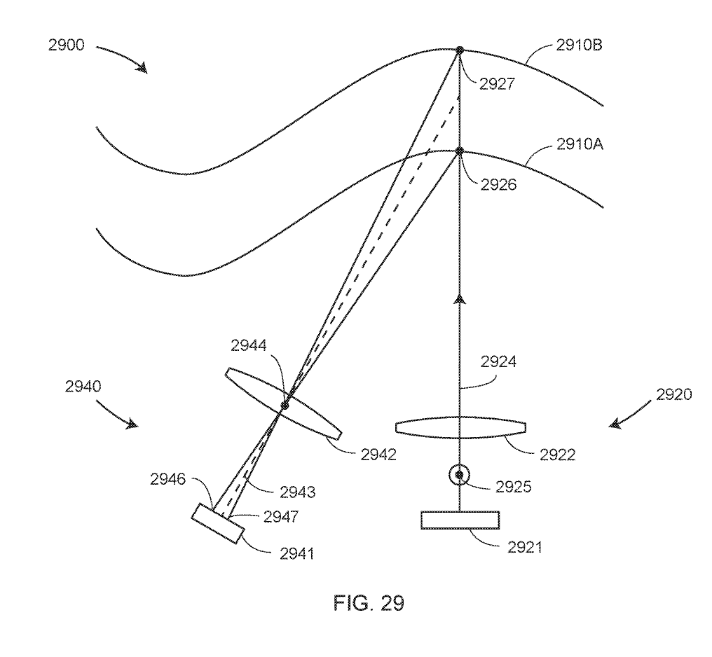

The operation of the laser line scanner (also known as a laser line probe or simply line scanner) such as the line scanner 2832 of FIGS. 28B and 28C is now described with reference to FIG. 29. The line scanner system 2900 includes a projector 2920 and a camera 2940. The projector 2920 includes a source pattern of light 2921 and a projector lens 2922. The source pattern of light includes an illuminated pattern in the form of a line. The projector lens includes a projector perspective center and a projector optical axis that passes through the projector perspective center. In the example of FIG. 29, a central ray of the beam of light 2924 is aligned with the perspective optical axis. The camera 2940 includes a camera lens 2942 and a photosensitive array 2941. The lens has a camera optical axis 2943 that passes through a camera lens perspective center 2944. In the exemplary system 2900, the projector optical axis, which is aligned to the beam of light 2924, and the camera lens optical axis 2943 are perpendicular to the line of light 2925 projected by the source pattern of light 2921. In other words, the line 2925 is in the direction perpendicular to the paper in FIG. 29. The line of light 2925 strikes an object surface, which at a first distance from the projector is object surface 2910A and at a second distance from the projector is object surface 2910B. It is understood that at different heights above or below the paper of FIG. 29, the object surface may be at a different distance from the projector than the distance to either object surface 2910A or 2910B. For a point on the line of light 2925 that also lies in the paper of FIG. 29, the line of light intersects surface 2910A in a point 2926 and it intersects the surface 2910B in a point 2927. For the case of the intersection point 2926, a ray of light travels from the point 2926 through the camera lens perspective center 2944 to intersect the photosensitive array 2941 in an image point 2946. For the case of the intersection point 2927, a ray of light travels from the point 2927 through the camera lens perspective center to intersect the photosensitive array 2941 in an image point 2947. By noting the position of the intersection point relative to the position of the camera lens optical axis 2943, the distance from the projector (and camera) to the object surface can be determined. The distance from the projector to other points on the intersection of the line of light 2925 with the object surface, that is points on the line of light that do not lie in the plane of the paper of FIG. 29, may similarly be found. In the usual case, the pattern on the photosensitive array will be a line of light (in general, not a straight line), where each point in the line corresponds to a different position perpendicular to the plane of the paper, and the position perpendicular to the plane of the paper contains the information about the distance from the projector to the camera. Therefore, by evaluating the pattern of the line in the image of the photosensitive array, the three-dimensional coordinates of the object surface along the projected line can be found. Note that the information contained in the image on the photosensitive array for the case of a line scanner is contained in a (not generally straight) line.

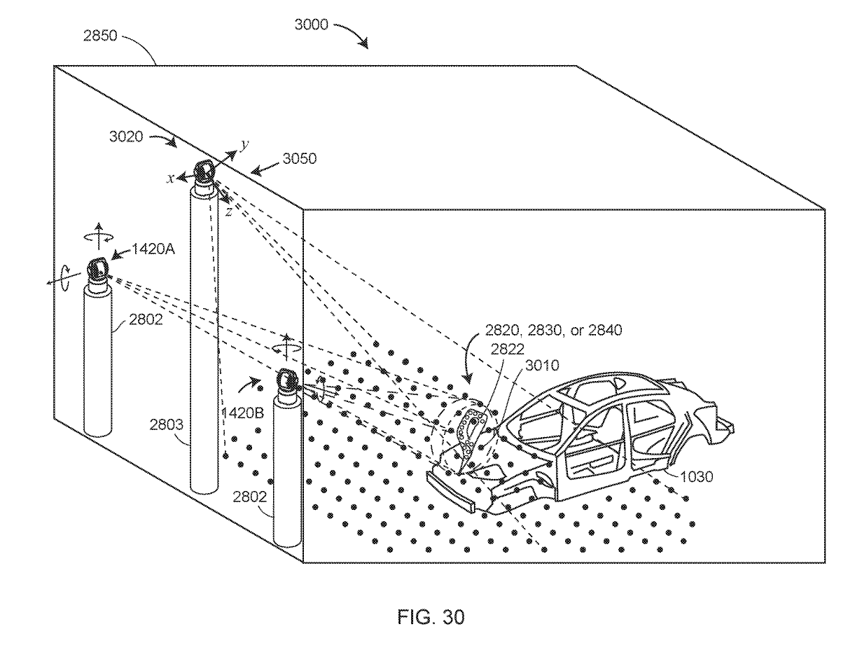

The methods described in FIGS. 28A-C are relatively accurate if the angular transducers that measure the angles of rotation of the rotating cameras 1420A, 1420B are accurate, for example, having an error less than 10 microradians. They work less well if there is no angle measuring system or if the angular transducers are not very accurate. FIG. 30 illustrates a method for determining 3D coordinates of the object 1030 to relatively high accuracy using the device 2820, 2830, or 2840 even if the rotating cameras 1420A, 1420B do not include an accurate angle measuring system.

In an embodiment illustrated in FIG. 30, a system 3000 is similar to the systems 2800A, 2800B, and 2800C of FIGS. 28A, 28B, and 28C, respectively, except that a projector 3020 has been added to project a light pattern, which might be a collection of light spots 3010. In an embodiment, the projector 3020 is mounted fixed on a pedestal 2803 project the pattern elements 3010 without rotation. In an embodiment, two rotating camera assemblies 1420A, 1420B include rotation mechanisms but do not include accurate angle measuring transducers. Instead, the cameras 1420A, 1420B use the imaged spots to determine each of their angles of rotation. In other respects the system 3000 of FIG. 30 operates in the same way as the systems 2800A, 2800B, and 2800C of FIGS. 28A, 28B, and 28C, respectively. In an embodiment, the origin of a system frame of reference 3050 coincides with the gimbal point of the projector 3020. In an embodiment, if the projected pattern is in the form of a grid, the z axis corresponds to the direction of propagation along the optical axis of the projector 3020 and the x and y axis correspond to the directions of the grid in a plane perpendicular to the z axis. Many other conventions for the frame of reference are possible. The projected pattern intersects the object 1030 in a collection of light elements 3010, which might be spots, for example. Each spot 1030 corresponds to a particular 2D angle emanating from the origin of the system frame of reference 3050. The 2D angles of each of the projected spots in the system frame of reference are therefore known to each of the rotating cameras 1420A, 1420B. The relative pose of the two cameras 1420A, 1420B, and the projector 3020 may be found by measuring a number of the projected spots with each of the camera systems 1420A, 1420B. Each of the observed angles of the projected spots must be consistent with triangulation calculations as discussed herein above with respect to FIGS. 1A, 1B, 2, 3, 4A, and 4B. The system uses the mathematical triangulation constraints to solve for the relative pose of the cameras 1420A, 1420B, and projector 3020. If all of the projected spots are identical, the handheld measuring device 2820, 2830, or 2840 may be brought into measuring position and the cameras 1420A, 1420B used to observe the light marks 2822 in relation to the projected pattern elements 3010. In another embodiment, an initial correspondence is established by bringing a distinctive light source or reflector in contact with one of the projected pattern elements 3010. After an initial correspondence is established for the grid of projected pattern elements 3010 as seen by the camera systems 1420A, 1420B, the cameras may track (monitor) the identity of the projected pattern elements 3010 as the cameras 1420A, 1420B are turned.

The angular values of the light marks 2822 are determined from the knowledge of the relative pose of the two cameras 1420A, 1420B and the projector 3020 as explained herein above. The cameras 1420A, 1420B may measure a large number of projected pattern elements 3010 over the measurement volume to determine an accurate value for the baseline distances between the cameras 1420A, 1420B and between each of the cameras and the projector 3020. The angles of rotation of the cameras 1420A, 1420B are recalculated following each rotation of one or both of the cameras 1420A, 1420B based on the need for self-consistency in the triangulation calculations. The accuracy of the calculated angular values is strengthened if the two cameras 1420A, 1420B and the projector 3020 are in a triangular configuration as illustrated in FIGS. 3 and 30, as explained herein above in reference to FIG. 4B. However, it is only necessary to know the relative pose between the two cameras 1420A, 1420B to determine the 3D coordinates of the object 1030 with the handheld 3D measuring device 2820, 2830, or 2840.

In an embodiment of FIG. 30, one of the two cameras 1420A, 1420B has a larger FOV than the other camera and is used to assist in tracking of the probe by viewing the probe within the background of fixed spots.

In an embodiment, the system determines the 3D coordinates of the object 1030 based at least in part on the images of the projected pattern obtained by the two cameras. The cameras 1420A, 1420B are able to match the patterns of light marks 2822 and, based on that initial orientation, are further able to match the projected spots 3010 near the probe 2820, 2830, or 2840 that are in the FOV of the two cameras 1420A, 1420B. Additional natural features on the object 1030 or on nearby stationary objects enable the system to use the images from the two cameras to determine 3D coordinates of the object 1030 within the frame of reference 2810.

In an alternative embodiment of FIG. 30, the cameras 1420A, 1420B include relatively accurate angular transducers, while the projector 3020 remains fixed. In another embodiment, the projector 3020 and the cameras 1420A, 1420B are placed in a triangular arrangement much like that of FIG. 3 so that through the use of epipolar constraints (as explained in reference to FIG. 4B, the correspondence between projected and imaged object points may be determined. With this approach, 3D coordinates may directly be determined, as explained herein above.

In another embodiment of FIG. 30, the cameras 1420A, 1420B and the projector 3020 all include relatively accurate angle transducers. In an embodiment, the FOV of each of the 1420A, 1420B and projector 3020 are all relatively small with the projected spots tracked with the rotating camera assemblies 1420A, 1420B. With this approach, high resolution and accuracy can be obtained while measuring over a relatively large volume.

In an embodiment of FIG. 30, the cameras 1420A, 1420B are configured to respond to the wavelengths of light emitted by the light marks 2822 and the projected light pattern from the projector 3020. In another embodiment of FIG. 30, the cameras 1420A, 1420B are dichroic cameras configured to respond to two different wavelengths of light. Examples of dichroic cameras that may be used are shown in FIGS. 5A and 5B.

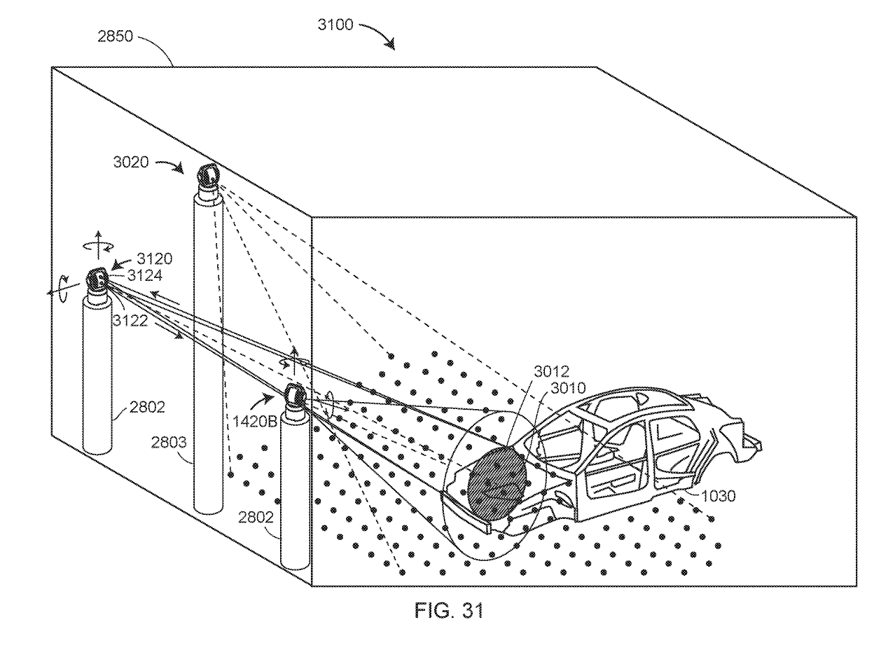

FIG. 31 illustrates a system 3100 that is similar to the system 3000 of FIG. 30 except that it obtains 3D coordinates of an object 1030 from a directly projected first pattern of light 3012 rather than from a handheld 3D measuring device 2820, 2830, or 2840. In an embodiment, a projector 3020 is mounted on a pedestal and projects a second pattern of light in a fixed direction onto the object 1030. In an embodiment, the rotating camera-projector 3120 includes a projector 3122 and a camera 3124 configured to rotate together. A rotating camera 1420B is configured to track the first projected pattern of light 3012 on the object 1030.

In an embodiment, the first projected pattern of light is a relatively fine pattern of light that provides relatively fine resolution when imaged by the cameras 3124 and 1420B. The projected pattern of light may be any of the types of light patterns discussed herein above, for example, sequential phase-shift patterns or single-shot coded patterns. In an embodiment, the triangulation calculation is performed based at least in part on the images obtained by the cameras 3124 and 1420B and by the relative pose of the cameras 3124 and 1420B. In another embodiment, the calculation is performed based at least in part on the image obtained by the camera 1420B, the first pattern projected by the projector 3122, and by the relative pose of the projector 3122 and the camera 1420B.

In one embodiment, the rotation angles of the rotating camera-projector 3120 and the rotating camera 1420B are not known to high accuracy. In this case, the method described with respect to FIG. 31 may be used to determine the angles to each of the projected spots 3010. In another embodiment, the angular transducers in the rotating camera-projector 3120 and the rotating camera 1420B provide accurate angular measurements, while the projector 3020 remains fixed. In this case, the projector 3020 may be omitted if desired.

In another embodiment of FIG. 31, the rotating camera-projector 3120, the rotating camera 1420B, and the projector 3020 all include relatively accurate angle transducers. In an embodiment, the FOV of each of the cameras 3124, 1420B and projectors 3122, 3020 are all relatively small, with the projected spots tracked with the rotating camera assemblies 1420A, 1420B. With this approach, high resolution and accuracy can be obtained while measuring over a relatively large volume.

In an embodiment of FIG. 31, the cameras 3124 and 1420B are configured to respond both to the wavelengths of light emitted by the projector 3122 and to the second light pattern from the projector 3020. In another embodiment of FIG. 31, the cameras 3124 and 1420B are dichroic cameras configured to respond to two different wavelengths of light. For example, the first projected pattern of light might be blue light and the second projected pattern of light might be IR light. Examples of dichroic cameras that may be used are shown in FIGS. 5A and 5B.

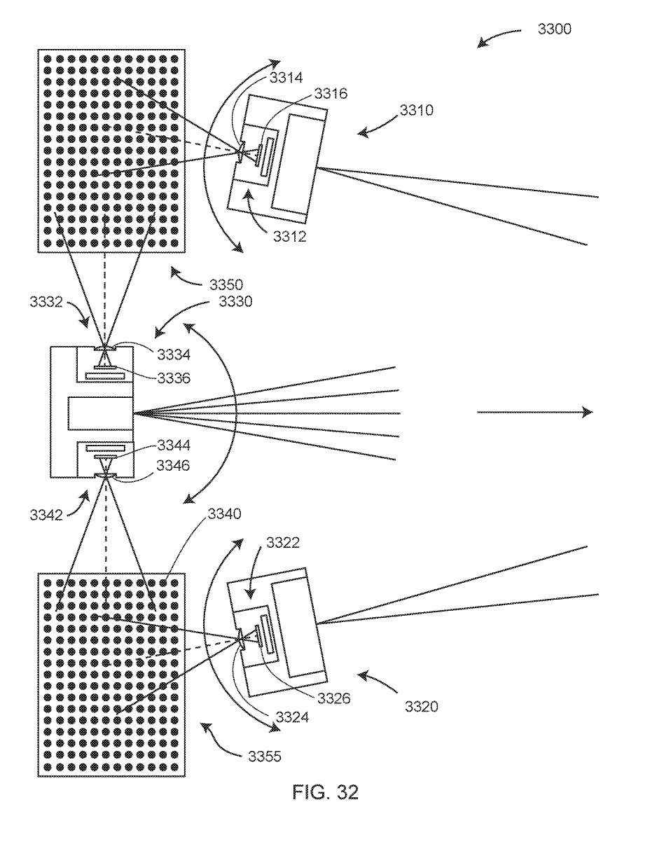

FIG. 32 illustrates a method of obtaining relatively high accuracy measurements for cameras and projectors within using an internally mounted angle transducer. A common type of angular transducer having relatively high accuracy is an angular encoder. A common type of angular encoder includes a disk mounted on a rotating shaft and one or more fixed read heads configured to determine an angle rotated by the shaft. In another approach the position of the disk and shaft are reversed. Such angular encoders can be relatively accurate if combined with good bearings to turn the shaft.

A potential disadvantage with such angular encoders or other high accuracy angular transducers is relatively high cost. A possible way around this problem is illustrated in FIG. 33. In an embodiment, a system includes a first camera 3310, second camera 3320, and a projector 3330, each configured to rotate about two axes. In an embodiment, a two dimensional grid of repeating elements such as dots 3340 are arranged on flat plates 3350, 3355. In an embodiment, the first camera 3310 and the projector 3330 measure dots on the first plate 3350, while the second camera 3320 and the projector 3330 measure dots on the second plate 3355. The measurements of the dots on the first plate 3350 by the first camera 3310 and the projector 3330 are obtained with cameras 3312, 3332 using lenses 3314, 3334 and photosensitive arrays 3316, 3336, respectively. The measurement of the dots on the second plate 3355 by the second camera 3320 and the projector 3330 are obtained with cameras 3322, 3342 using lenses 3324, 3344 and photosensitive arrays 3326, 3346, respectively. In an embodiment, the projector measures angles using a single camera 3332 rather than two cameras. The approach illustrated in FIG. 33 is suitable when two cameras and a projector are mounted together in a common physical structure. For the case in which the cameras and the projector are spaced far apart, as in FIGS. 30 and 31, a separate grid of points needs to be provided for each of the first camera, the second camera, and the projector.

FIG. 33 is a block diagram of a computing system 3300 that includes the internal electrical system 3310, one or more computing elements 3310, 3320, and a network of computing elements 3330, commonly referred to as the cloud. The cloud may represent any sort of network connection (e.g., the worldwide web or internet). Communication among the computing (processing and memory) components may be wired or wireless. Examples of wireless communication methods include IEEE 802.11 (Wi-Fi), IEEE 802.15.1 (Bluetooth), and cellular communication (e.g., 3G and 4G). Many other types of wireless communication are possible. A popular type of wired communication is IEEE 802.3 (Ethernet). In some cases, multiple external processors, especially processors on the cloud, may be used to process scanned data in parallel, thereby providing faster results, especially where relatively time-consuming registration and filtering may be required. The computing system 3300 may be used with any of the 3D measuring devices, mobile devices, or accessories described herein. The internal electrical system applies to processors, memory, or other electrical circuitry included with any of the 3D measuring devices, mobile devices, or accessories described herein.

In an embodiment, a three-dimensional (3D) measuring system includes: a body; an internal projector fixedly attached to the body, the internal projector configured to project an illuminated pattern of light onto an object; and a first dichroic camera assembly fixedly attached to the body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the illuminated pattern on the object, the second photosensitive array being configured to capture a second channel image of the illuminated pattern on the object, the first dichroic camera assembly having a first pose relative to the internal projector, wherein the 3D measuring system is configured to determine 3D coordinates of a first point on the object based at least in part on the illuminated pattern, the second channel image, and the first pose.

In a further embodiment, the first portion and the second portion are directed into the first channel and the second channel, respectively, based at least in part on the wavelengths present in the first portion and the wavelengths present in the second portion.

In a further embodiment, further including a first lens between the first beam splitter and the first photosensitive array and a second lens between the first beam splitter and the second photosensitive array.

In a further embodiment, the focal length of the first lens is different than the focal length of the second lens.

In a further embodiment, the field-of-view (FOV) of the first channel is different than the FOV of the second channel.

In a further embodiment, the 3D measuring system is configured to identify a first cardinal point in a first instance of the first channel image and to further identify the first cardinal point in a second instance of the first channel image, the second instance of the first channel image being different than the first instance of the first channel image.

In a further embodiment, the first cardinal point is based on a feature selected from the group consisting of: a natural feature on or near the object, a spot of light projected onto or near to the object from a light source not attached to the body, and a marker placed on or near the object, a light source placed on or near the object.

In a further embodiment, the 3D measuring system is further configured to register the first instance of the first channel image to the second instance of the first channel image.

In a further embodiment, the 3D measuring system is configured to determine a first pose of the 3D measuring system in the second instance relative to a first pose of the 3D measuring system in the first instance.

In a further embodiment, the first channel has a larger field-of-view (FOV) than the second channel.

In a further embodiment, the first photosensitive array is configured to capture a color image.

In a further embodiment, the 3D measuring system is further configured to determine 3D coordinates of the first point on the object based at least in part on the first channel image.

In a further embodiment, the illuminated pattern includes an infrared wavelength.

In a further embodiment, the illuminated pattern includes a blue wavelength.

In a further embodiment, the illuminated pattern is a coded pattern.

In a further embodiment, the 3D measuring system is configured to emit a first instance of the illuminated pattern, a second instance of the illuminated pattern, and a third instance of the illuminated pattern, the 3D measuring system being further configured to capture a first instance of the second channel image, a second instance of the second channel image, and a third instance of the second channel image.

In a further embodiment, the 3D measuring system is further configured to determine the 3D coordinates of a point on the object based at least in part on the first instance of the first illuminated pattern image, the second instance of the first illuminated pattern image, and the third instance of the first illuminated pattern image, the first instance of the second channel image, the second instance of the second channel image, and the third instance of the second channel image.

In a further embodiment, the first illuminated pattern, the second illuminated pattern, and the third illuminated patterns are all sinusoidal patterns, each of the first illuminated pattern, the second illuminated pattern, and the third illuminated pattern being shifted side-to-side relative to the other two illuminated patterns.

In a further embodiment, further including a second camera assembly fixedly attached to the body, the second camera assembly receiving a third portion of incoming light in a third channel leading to a third photosensitive array, the third photosensitive array configured to capture a third channel image of the illuminated pattern on the object, the second camera assembly having a second pose relative to the internal projector, wherein the 3D measuring system is further configured to determine the 3D coordinates of the object based on the third channel image.

In a further embodiment, the 3D measuring system is further configured to determine the 3D coordinates of the object based on epipolar constraints, the epipolar constraints based at least in part on the first pose and the second pose.

In a further embodiment, the 3D measuring system is further configured to determine 3D coordinates of the first point on the object based at least in part on the first channel image.

In a further embodiment, the 3D measuring system is configured to assign a color to the first point based at least in part on the first channel image.

In a further embodiment, the illuminated pattern is an uncoded pattern.

In a further embodiment, the illuminated pattern includes a grid of spots.

In a further embodiment, the internal projector further includes a laser light source and a diffractive optical element, the laser light source configured to shine through the diffractive optical element.

In a further embodiment, the second camera assembly further includes a second beam splitter configured to direct the third portion into the third channel and to direct a fourth portion of the incoming light into a fourth channel leading to a fourth photosensitive array.

In a further embodiment, further including an external projector detached from the body, the external projector configured to project an external pattern of light on the object.

In a further embodiment, the 3D measuring system is further configured to register a first instance of the first channel image to a second instance of the first channel image.

In a further embodiment, the external projector is further attached to a second mobile platform.

In a further embodiment, the second mobile platform further includes second motorized wheels.

In a further embodiment, the external projector is attached to a second motorized rotation mechanism configured to rotate the direction of the external pattern of light.

In a further embodiment, the body is attached to a first mobile platform.

In a further embodiment, the first mobile platform further includes first motorized wheels.

In a further embodiment, the first mobile platform further includes a robotic arm configured to move and rotate the body.

In a further embodiment, further including an external projector detached from the body, the external projector configured to project an external pattern of light on the object, the external projector including a second mobile platform having second motorized wheels.

In a further embodiment, the 3D measuring system is configured to adjust a pose of the body under computer control.

In a further embodiment, the 3D measuring system is further configured to adjust a pose of the external projector under the computer control.

In a further embodiment, further including an auxiliary projector fixedly attached to the body, the auxiliary projector configured to project an auxiliary pattern of light onto or near to the object.

In a further embodiment, the auxiliary pattern is selected from the group consisting of: a numerical value of a measured quantity, a deviation of a measured quantity in relation to an allowed tolerance, information conveyed by a pattern of color, and whisker marks.

In a further embodiment, the auxiliary pattern is selected from the group consisting of: a location at which an assembly operation is to be performed and a location at which a measurement is to be performed.

In a further embodiment, the auxiliary pattern is projected to provide additional triangulation information.

In a further embodiment, the 3D measuring system is configured to produce a 3D color representation of the object.

In a further embodiment, further including a first lens placed to intercept the incoming light before reaching the first beam splitter.

In a further embodiment, the internal projector further includes a pattern generator, an internal projector lens, and an internal projector lens perspective center.

In a further embodiment, the internal projector further includes a light source and a diffractive optical element.

In a further embodiment, the auxiliary projector further includes an auxiliary picture generator, an auxiliary projector lens, and an auxiliary projector lens perspective center.

In a further embodiment, the auxiliary projector further includes an auxiliary light source and an auxiliary diffractive optical element.

In an embodiment, a three-dimensional (3D) measuring system includes: a body; a first dichroic camera assembly fixedly attached to the body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the object, the second photosensitive array being configured to capture a second channel image of the object; and a second camera assembly fixedly attached to the body, the second camera assembly having a third channel configured to direct a third portion of the incoming light into a third channel leading to a third photosensitive array, the third photosensitive array being configured to capture a third channel image of the object, the second camera assembly having a first pose relative to the first dichroic camera assembly, wherein the 3D measuring system is configured to determine 3D coordinates of a first point on the object based at least in part on the second channel image, the third channel image, and the first pose.

In a further embodiment, the first portion and the second portion are directed into the first channel and the second channel, respectively, based at least in part on wavelengths present in the first portion and on wavelengths present in the second portion.

In a further embodiment, further including a first lens between the first beam splitter and the first photosensitive array and a second lens between the first beam splitter and the second photosensitive array.

In a further embodiment, the focal length of the first lens is different than the focal length of the second lens.

In a further embodiment, the field-of-view (FOV) of the first channel is different than the FOV of the second channel.

In a further embodiment, the 3D measuring system is configured to identify a first cardinal point in a first instance of the first channel image and to further identify the first cardinal point in a second instance of the first channel image, the second instance of the first channel image being different than the first instance of the first channel image.

In a further embodiment, the first cardinal point is based on a feature selected from the group consisting of: a natural feature on or near the object, a spot of light projected onto or near to the object from a light source not attached to the body, a marker placed on or near the object, and a light source placed on or near the object.

In a further embodiment, the 3D measuring system is further configured to register the first instance of the first channel image to the second instance of the first channel image.

In a further embodiment, the 3D measuring system is configured to determine a first pose of the 3D measuring system in the second instance relative to a first pose of the 3D measuring system in the first instance.

In a further embodiment, the first channel has a larger field-of-view (FOV) than the second channel.

In a further embodiment, the first photosensitive array is configured to capture a color image.

In a further embodiment, the first photosensitive array is configured to capture an infrared image.

In a further embodiment, the 3D measuring system is further configured to determine 3D coordinates of the first point on the object based at least in part on the first channel image.

In a further embodiment, the 3D measuring system is configured to assign a color to the first point based at least in part on the first channel image.

In a further embodiment, the second camera assembly further includes a second beam splitter configured to direct the third portion into the third channel and to direct a fourth portion of the incoming light into a fourth channel leading to a fourth photosensitive array.

In a further embodiment, further including an external projector detached from the body, the external projector configured to project an external.

In a further embodiment, the external projector is further attached to a second mobile platform.

In a further embodiment, the second mobile platform further includes second motorized wheels.

In a further embodiment, the external projector is attached to a second motorized rotation mechanism configured to rotate the direction of the external pattern of light.

In a further embodiment, the body is attached to a first mobile platform.

In a further embodiment, the first mobile platform further includes first motorized wheels.

In a further embodiment, the first mobile platform further includes a robotic arm configured to move and rotate the body.

In a further embodiment, further including an external projector detached from the body, the external projector configured to project an external pattern of light on the object, the external projector including a second mobile platform having second motorized wheels.

In a further embodiment, the 3D measuring system is configured to adjust a pose of the body under computer control.

In a further embodiment, the 3D measuring system is further configured to adjust a pose of the external projector under the computer control.

In a further embodiment, further including an auxiliary projector configured to project an auxiliary pattern of light onto or near to the object.

In a further embodiment, the auxiliary pattern is selected from the group consisting of: a numerical value of a measured quantity, a deviation of a measured quantity in relation to an allowed tolerance, information conveyed by a pattern of color, and whisker marks.

In a further embodiment, the auxiliary pattern is selected from the group consisting of: a location at which an assembly operation is to be performed and a location at which a measurement is to be performed.

In a further embodiment, the auxiliary pattern is projected to provide additional triangulation information.

In a further embodiment, the 3D measuring system is configured to produce a 3D color representation of the object.

In a further embodiment, further including a first lens placed to intercept the incoming light before reaching the first beam splitter.

In a further embodiment, the auxiliary projector further includes an auxiliary picture generator, an auxiliary projector lens, and an auxiliary projector lens perspective center.

In a further embodiment, the auxiliary projector further includes an auxiliary light source and an auxiliary diffractive optical element.

In an embodiment, a three-dimensional (3D) measuring system includes: a first body and a second body independent of the first body; an internal projector configured to project an illuminated pattern of light onto an object; and a first dichroic camera assembly fixedly attached to the second body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the illuminated pattern on the object, the second photosensitive array being configured to capture a second channel image of the illuminated pattern on the object, the first dichroic camera assembly having a first pose relative to the internal projector, wherein the 3D measuring system is configured to determine 3D coordinates of a first point on the object based at least in part on the illuminated pattern, the second channel image, and the first pose.

In a further embodiment, the first portion and the second portion are directed into the first channel and the second channel, respectively, based at least in part on wavelengths present in the first portion and on wavelengths present in the second portion.

In a further embodiment, further including a first lens between the first beam splitter and the first photosensitive array and a second lens between the first beam splitter and the second photosensitive array.

In a further embodiment, the focal length of the first lens is different than the focal length of the second lens.

In a further embodiment, the field-of-view (FOV) of the first channel is different than the FOV of the second channel.

In a further embodiment, the 3D measuring system is configured to identify a first cardinal point in a first instance of the first channel image and to further identify the first cardinal point in a second instance of the first channel image, the second instance of the first channel image being different than the first instance of the first channel image.

In a further embodiment, the first cardinal point is based on a feature selected from the group consisting of: a natural feature on or near the object, a spot of light projected onto or near to the object from a light source not attached to the first body or the second body, a marker placed on or near the object, and a light source placed on or near the object.

In a further embodiment, the 3D measuring system is further configured to register the first instance of the first channel image to the second instance of the first channel image.

In a further embodiment, the 3D measuring system is configured to determine a first pose of the 3D measuring system in the second instance relative to a first pose of the 3D measuring system in the first instance.

In a further embodiment, the first channel has a larger field-of-view (FOV) than the second channel.

In a further embodiment, the first photosensitive array is configured to capture a color image.

In a further embodiment, the 3D measuring system is further configured to determine 3D coordinates of the first point on the object based at least in part on the first channel image.

In a further embodiment, the illuminated pattern includes an infrared wavelength.

In a further embodiment, the illuminated pattern includes a blue wavelength.

In a further embodiment, the illuminated pattern is a coded pattern.

In a further embodiment, the 3D measuring system is configured to emit a first instance of the illuminated pattern, a second instance of the illuminated pattern, and a third instance of the illuminated pattern, the 3D measuring system being further configured to capture a first instance of the second channel image, a second instance of the second channel image, and a third instance of the second channel image.

In a further embodiment, the 3D measuring system is further configured to determine the 3D coordinates of a point on the object based at least in part on the first instance of the first illuminated pattern image, the second instance of the first illuminated pattern image, and the third instance of the first illuminated pattern image, the first instance of the second channel image, the second instance of the second channel image, and the third instance of the second channel image.

In a further embodiment, the first illuminated pattern, the second illuminated pattern, and the third illuminated patterns are all sinusoidal patterns, each of the first illuminated pattern, the second illuminated pattern, and the third illuminated pattern being shifted sideways relative to the other two illuminated patterns.

In a further embodiment, further including a second camera assembly fixedly attached to a third body, the second camera assembly receiving a third portion of incoming light in a third channel leading to a third photosensitive array, the third photosensitive array configured to capture a third channel image of the illuminated pattern on the object, the second camera assembly having a second pose relative to the internal projector, wherein the 3D measuring system is further configured to determine the 3D coordinates of the object based on the third channel image.

In a further embodiment, the 3D measuring system is further configured to determine the 3D coordinates of the object based on epipolar constraints, the epipolar constraints based at least in part on the first pose and the second pose.

In a further embodiment, the 3D measuring system is further configured to determine 3D coordinates of the first point on the object based at least in part on the first channel image.

In a further embodiment, the 3D measuring system is configured to assign a color to the first point based at least in part on the first channel image.

In a further embodiment, the illuminated pattern is an uncoded pattern.

In a further embodiment, the illuminated pattern includes a grid of spots.

In a further embodiment, the internal projector further includes a laser light source and a diffractive optical element, the laser light source configured to shine through the diffractive optical element.

In a further embodiment, the second camera assembly further includes a second beam splitter configured to direct the third portion into the third channel and to direct a fourth portion of the incoming light into a fourth channel leading to a fourth photosensitive array.

In a further embodiment, further including an external projector detached from the first body, the second body, and the third body, the external projector configured to project an external pattern of light on the object.

In a further embodiment, the 3D measuring system is further configured to register a first instance of the first channel image to a second instance of the first channel image

In a further embodiment, the external projector is further attached to a second mobile platform.

In a further embodiment, the second mobile platform further includes second motorized wheels.

In a further embodiment, the external projector is attached to a second motorized rotation mechanism configured to rotate the direction of the external pattern of light.

In a further embodiment, the first body and the second body are attached to a first mobile platform and a second mobile platform, respectively.

In a further embodiment, the first mobile platform and the second mobile platform further include first motorized wheels and second motorized wheels, respectively.

In a further embodiment, further including an external projector detached from the body, the external projector configured to project an external pattern of light on the object, the external projector including a third mobile platform having third motorized wheels.

In a further embodiment, the 3D measuring system is configured to adjust a pose of the first body and the second body under computer control.

In a further embodiment, the 3D measuring system is further configured to adjust a pose of the external projector under the computer control.

In a further embodiment, further including an auxiliary projector configured to project an auxiliary pattern of light onto or near to the object.

In a further embodiment, the auxiliary pattern is selected from the group consisting of: a numerical value of a measured quantity, a deviation of a measured quantity in relation to an allowed tolerance, information conveyed by a pattern of color, and whisker marks.

In a further embodiment, the auxiliary pattern is selected from the group consisting of: a location at which an assembly operation is to be performed and a location at which a measurement is to be performed.

In a further embodiment, the auxiliary pattern is projected to provide additional triangulation information.

In a further embodiment, the 3D measuring system is configured to produce a 3D color representation of the object.

In a further embodiment, further including a first lens placed to intercept the incoming light before reaching the first beam splitter.

In a further embodiment, the internal projector further includes a pattern generator, an internal projector lens, and an internal lens perspective center.

In a further embodiment, the internal projector further includes a light source and a diffractive optical element.

In a further embodiment, the auxiliary projector further includes an auxiliary picture generator, an auxiliary projector lens, and an auxiliary projector lens perspective center.

In a further embodiment, the auxiliary projector further includes an auxiliary light source and an auxiliary diffractive optical element.

In an embodiment, a three-dimensional (3D) measuring system includes: a first body and a second body independent of the first body; a first dichroic camera assembly fixedly attached to the first body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the object, the second photosensitive array being configured to capture a second channel image of the object; and a second camera assembly fixedly attached to the second body, the second camera assembly having a third channel configured to direct a third portion of the incoming light into a third channel leading to a third photosensitive array, the third photosensitive array being configured to capture a third channel image of the object, the second camera assembly having a first pose relative to the first dichroic camera assembly, wherein the 3D measuring system is configured to determine 3D coordinates of a first point on the object based at least in part on the second channel image, the third channel image, and the first pose.

In a further embodiment, the first portion and the second portion are directed into the first channel and the second channel, respectively, based at least in part on wavelengths present in the first portion and on wavelengths present in the second portion.

In a further embodiment, further including a first lens between the first beam splitter and the first photosensitive array and a second lens between the first beam splitter and the second photosensitive array.

In a further embodiment, the focal length of the first lens is different than the focal length of the second lens.

In a further embodiment, the field-of-view (FOV) of the first channel is different than the FOV of the second channel.

In a further embodiment, the 3D measuring system is configured to identify a first cardinal point in a first instance of the first channel image and to further identify the first cardinal point in a second instance of the first channel image, the second instance of the first channel image being different than the first instance of the first channel image.

In a further embodiment, the first cardinal point is based on a feature selected from the group consisting of: a natural feature on or near the object, a spot of light projected onto or near to the object from a light source not attached to the body, a marker placed on or near the object, and a light source placed on or near the object.

In a further embodiment, the 3D measuring system is further configured to register the first instance of the first channel image to the second instance of the first channel image.

In a further embodiment, the 3D measuring system is configured to determine a first pose of the 3D measuring system in the second instance relative to a first pose of the 3D measuring system in the first instance.

In a further embodiment, the first channel has a larger field-of-view (FOV) than the second channel.

In a further embodiment, the first photosensitive array is configured to capture a color image.

In a further embodiment, the first photosensitive array is configured to capture an infrared image.

In a further embodiment, the 3D measuring system is further configured to determine 3D coordinates of the first point on the object based at least in part on the first channel image.

In a further embodiment, the 3D measuring system is configured to assign a color to the first point based at least in part on the first channel image.

In a further embodiment, the second camera assembly further includes a second beam splitter configured to direct the third portion into the third channel and to direct a fourth portion of the incoming light into a fourth channel leading to a fourth photosensitive array.

In a further embodiment, further including an external projector detached from the body, the external projector configured to project an external pattern of light on the object.

In a further embodiment, the external projector is further attached to a third mobile platform.

In a further embodiment, the third mobile platform further includes third motorized wheels.

In a further embodiment, the external projector is attached to a second motorized rotation mechanism configured to rotate the direction of the external pattern of light.

In a further embodiment, the first body is attached to a first mobile platform and the second body is attached to a second mobile platform.

In a further embodiment, the first mobile platform further includes first motorized wheels and the second mobile platform further includes second motorized wheels.

In a further embodiment, the first mobile platform further includes a first motorized rotation mechanism configured to rotate the first body and a second motorized rotation mechanism configured to rotate the second body.

In a further embodiment, further including an external projector detached from the body, the external projector configured to project an external pattern of light on the object, the external projector including a second mobile platform having second motorized wheels.

In a further embodiment, the 3D measuring system is configured to adjust a pose of the first body and the pose of the second body under computer control.

In a further embodiment, the 3D measuring system is further configured to adjust a pose of the external projector under the computer control.

In a further embodiment, further including an auxiliary projector configured to project an auxiliary pattern of light onto or near to the object.

In a further embodiment, the auxiliary pattern is selected from the group consisting of: a numerical value of a measured quantity, a deviation of a measured quantity in relation to an allowed tolerance, information conveyed by a pattern of color, and whisker marks.

In a further embodiment, the auxiliary pattern is selected from the group consisting of: a location at which an assembly operation is to be performed and a location at which a measurement is to be performed.

In a further embodiment, the auxiliary pattern is projected to provide additional triangulation information.

In a further embodiment, the 3D measuring system is configured to produce a 3D color representation of the object.

In a further embodiment, further including a first lens placed to intercept the incoming light before reaching the first beam splitter.

In a further embodiment, the auxiliary projector further includes an auxiliary picture generator, an auxiliary projector lens, and an auxiliary projector lens perspective center.

In a further embodiment, the auxiliary projector further includes an auxiliary light source and an auxiliary diffractive optical element.

In an embodiment, a measurement method includes: placing a first rotating camera assembly at a first environment location in an environment, the first rotating camera assembly including a first camera body, a first camera, a first camera rotation mechanism, and a first camera angle-measuring system; placing a second rotating camera assembly at a second environment location in the environment, the second rotating camera assembly including a second camera body, a second camera, a second camera rotation mechanism, and a second camera angle-measuring system; in a first instance: moving a three-dimensional (3D) measuring device to a first device location in the environment, the 3D measuring device having a device frame of reference, the 3D measuring device fixedly attached to a first target and a second target; rotating with the first camera rotation mechanism the first rotating camera assembly to a first angle to face the first target and the second target; measuring the first angle with the first camera angle-measuring system; capturing a first image of the first target and the second target with the first camera; rotating with the second camera rotation mechanism the second rotating camera assembly to a second angle to face the first target and the second target; measuring the second angle with the second camera angle-measuring system; capturing a second image of the first target and the second target with the second camera; measuring, with the 3D measuring device, first 3D coordinates in the device frame of reference of a first object point on an object; determining 3D coordinates of the first object point in a first frame of reference based at least in part on the first image, the second image, the measured first angle, the measured second angle, and the measured first 3D coordinates, the first frame of reference being different than the device frame of reference; in a second instance: moving the 3D measuring device to a second device location in the environment; capturing a third image of the first target and the second target with the first camera; capturing a fourth image of the first target and the second target with the second camera; measuring, with the 3D measuring device, second 3D coordinates in the device frame of reference of a second object point on the object; determining 3D coordinates of the second object point in the first frame of reference based at least in part on the third image, the fourth image, and the measured second 3D coordinates; and storing the 3D coordinates of the first object point and the second object point in the first frame of reference.

In a further embodiment, in the step of moving a three-dimensional (3D) measuring device to a first device location in the environment, the 3D measuring device is further fixedly attached to a third target; in the first instance: the step of rotating with the first camera rotation mechanism further includes rotating the first rotating camera assembly to face the third target; in the step of capturing a first image of the first target and the second target with the first camera, the first image further includes the third target; the step of rotating with the second camera rotation mechanism further includes rotating the second rotating camera assembly to face the third target; in the step of capturing a second image of the first target and the second target with the second camera, the second image further includes the third target; in the second instance: in the step of capturing a third image of the first target and the second target with the first camera, the third image further includes the third target; and in the step of capturing a fourth image of the first target and the second target with the second camera, the fourth image further includes the third target.

In a further embodiment, in the second instance: a further step includes rotating with the first camera rotation mechanism the first rotating camera assembly to a third angle to face the first target and the second target; a further step includes rotating with the second camera rotation mechanism the second rotating camera assembly to a fourth angle to face the first target and the second target; in the step of determining 3D coordinates of the second object point in the first frame of reference, the 3D coordinates of the second object point in the first frame of reference are further based on the third angle and the fourth angle.

In a further embodiment, in the step of moving a three-dimensional (3D) measuring device to a first device location in the environment, the 3D measuring device further includes a two-axis inclinometer; in the first instance: a further step includes measuring a first inclination with the two-axis inclinometer; the step of determining 3D coordinates of the first object point in a first frame of reference is further based on the measured first inclination; in the second instance: a further step includes measuring a second inclination with the two-axis inclinometer; and the step of determining 3D coordinates of the second object point in the first frame of reference is further based on the measured second inclination.

In a further embodiment, in the step of placing a first rotating camera assembly at a first environment location in an environment, the first camera includes a first camera lens, a first photosensitive array, and a first camera perspective center; in the step of placing a first rotating camera assembly at a first environment location in an environment, the first camera rotation mechanism is configured to rotate the first rotating camera assembly about a first axis by a first rotation angle and about a second axis by a second rotation angle; and in the step of placing a first rotating camera assembly at a first environment location in an environment, the first camera angle-measuring system further includes a first angle transducer configured to measure the first rotation angle and a second angle transducer configured to measure the second rotation angle.

In a further embodiment, in the step of measuring the first angle with the first camera angle-measuring system, the first angle is based at least in part on the measured first rotation angle and the measured second rotation angle.

In a further embodiment, further including steps of: capturing with the first camera one or more first reference images of a plurality of reference points in the environment, there being a known distance between two of the plurality of reference points; capturing with the second camera one or more second reference images of the plurality of reference points; determining a first reference pose of the first rotating camera assembly in an environment frame of reference based at least in part on the one or more first reference images and on the known distance; and determining a second reference pose of the second rotating camera assembly in an environment frame of reference based at least in part on the one or more second reference images and on the known distance.

In a further embodiment, further including determining 3D coordinates of the first object point and the second object point in the first frame of reference further based on the first reference pose and the second reference pose.

In a further embodiment, in the step of moving a three-dimensional (3D) measuring device to a first device location in the environment, the 3D measuring device is attached to a first mobile platform.

In a further embodiment, the first mobile platform further includes first motorized wheels.

In a further embodiment, the first mobile platform further includes a robotic arm configured to move and rotate the 3D measuring device.

In a further embodiment, in the second instance the step of moving the 3D measuring device to a second location in the environment includes moving the first motorized wheels.

In a further embodiment, the step of moving the 3D measuring device to a second device location in the environment further includes moving the robotic arm.

In a further embodiment, in the step of moving the first motorized wheels, the motorized wheels are moved under computer control.

In a further embodiment, the step of moving the 3D measuring device to a second device location in the environment further includes moving the robotic arm under computer control.

In a further embodiment, the 3D measuring device is a 3D imager having an imager camera and a first projector, the first projector configured to project a pattern of light onto an object, the imager camera configured to obtain a first pattern image of the pattern of light on the object, the 3D imager configured to determine 3D coordinates of the first object point based at least in part on the pattern of light, the first pattern image, and on a relative pose between the imager camera and the first projector.

In a further embodiment, in a third instance: moving the first rotating camera assembly to a third environment location in the environment; capturing with the first rotating camera one or more third reference images of the plurality of reference points in the environment, the third reference image including the first reference point and the second reference point; and determining a third pose of the first rotating camera in the environment frame of reference based at least in part on the third reference image.

In a further embodiment, further including determining 3D coordinates of the first object point and the second object point in the first frame of reference further based on the third pose.

In a further embodiment, further including projecting an auxiliary pattern of light onto or near to the object from an auxiliary projector.

In a further embodiment, the auxiliary pattern is selected from the group consisting of: a numerical value of a measured quantity, a deviation of a measured quantity in relation to an allowed tolerance, information conveyed by a pattern of color, and whisker marks.

In a further embodiment, the auxiliary pattern is selected from the group consisting of: a location at which an assembly operation is to be performed and a location at which a measurement is to be performed.

In a further embodiment, the auxiliary pattern is projected to provide additional triangulation information.

In an embodiment, a method includes: placing a first rotating camera assembly and a rotating projector assembly in an environment, the first rotating camera assembly including a first camera body, a first camera, a first camera rotation mechanism, and a first camera angle-measuring system, the rotating projector assembly including a projector body, a projector, a projector rotation mechanism, and a projection angle-measuring system, the projector body independent of the camera body, the projector configured to project a first illuminated pattern onto an object; placing a calibration artifact in the environment, the calibration artifact having a collection of calibration marks at calibrated positions; rotating with the first camera rotation mechanism the first rotating camera assembly to a first angle to face the calibration artifact; measuring the first angle with the first camera angle-measuring system; capturing a first image of the calibration artifact with the first camera; rotating with the projector rotation mechanism the rotating projector assembly to a second angle to face the calibration artifact; projecting with the projector the first illuminated pattern of light onto the object; measuring the second angle with the second projector angle-measuring system; capturing with the first camera a second image of the calibration artifact illuminated by the first illumination pattern; determining a first relative pose of the rotating projector assembly to the first rotating camera assembly based at least in part on the first image, the second image, the first angle, the second angle, and the calibrated positions of the calibration marks; and storing the first relative pose.

In a further embodiment, in the step of placing a first rotating camera assembly and a rotating projector assembly in an environment, the first camera includes a first camera lens, a first photosensitive array, and a first camera perspective center.

In a further embodiment, in the step of placing a first rotating camera assembly and a rotating projector assembly in an environment, the rotating projector assembly includes a pattern generator, a projector lens, and a projector lens perspective center.

In a further embodiment, in the step of placing a first rotating camera assembly and a rotating projector assembly in an environment, the projector includes a light source and a diffractive optical element, the light source configured to send light through the diffractive optical element.

In a further embodiment, in the step of placing a calibration artifact in the environment, the calibration marks are a collection of dots arranged on a calibration plate in a two-dimensional pattern.

In a further embodiment, in the step of placing a calibration artifact in the environment, the calibration artifact is attached to a first mobile platform having first motorized wheels.

In a further embodiment, in the step of placing a calibration artifact in the environment, the first mobile platform is placed in the environment under computer control.

In a further embodiment, in the step of placing a calibration artifact in the environment, the calibration marks are a collection of dots arranged on a calibration bar in a one-dimensional pattern.

In an embodiment, a method includes: placing a first rotating camera assembly and a second rotating camera assembly in an environment, the first rotating camera assembly including a first camera body, a first camera, a first camera rotation mechanism, and a first camera angle-measuring system, the second rotating camera assembly including a second camera body, a second camera, a second camera rotation mechanism, and a second camera angle-measuring system; placing a calibration artifact in the environment, the calibration artifact having a collection of calibration marks at calibrated positions; rotating with the first camera rotation mechanism the first rotating camera assembly to a first angle to face the calibration artifact; measuring the first angle with the first camera angle-measuring system; capturing a first image of the calibration artifact with the first camera; rotating with the second camera rotation mechanism the second rotating camera assembly to a second angle to face the calibration artifact; measuring the second angle with the second camera angle-measuring system; capturing a second image of the calibration artifact with the second camera; determining a first relative pose of the second rotating camera assembly to the first rotating camera assembly based at least in part on the first image, the second image, the first angle, the second angle, and the calibrated positions of the calibration marks; and storing the first relative pose.

In a further embodiment, in the step of placing a first rotating camera assembly and a rotating projector assembly in an environment, the first camera includes a first camera lens, a first photosensitive array, and a first camera perspective center and the second camera includes a second camera lens, a second photosensitive array, and a second camera perspective center.

In a further embodiment, in the step of placing a calibration artifact in the environment, the calibration marks are a collection of dots arranged on a calibration plate in a two-dimensional pattern.

In a further embodiment, in the step of placing a calibration artifact in the environment, the calibration artifact is attached to a first mobile platform having first motorized wheels.

In a further embodiment, in the step of placing a calibration artifact in the environment, the first mobile platform is placed in the environment under computer control.

In a further embodiment, in the step of placing a calibration artifact in the environment, the calibration marks are arranged on a calibration bar in a one-dimensional pattern.

In a further embodiment, in the step of placing a calibration artifact in the environment, the calibration marks include light emitting diodes (LEDs).

In a further embodiment, in the step of placing a calibration artifact in the environment, the calibration marks include reflective dots.

In a further embodiment, in the step of placing a calibration artifact in the environment, the calibration artifact is attached to a first mobile platform having motorized wheels and a robotic mechanism; and in the step of placing a calibration artifact in the environment, the calibration artifact is moved by the motorized wheels to a plurality of locations and by the robotic mechanism to a plurality of rotation angles.

In an embodiment, a method includes: placing a first camera platform in an environment, the first camera platform including a first platform base, a first rotating camera assembly, and a first collection of calibration marks having first calibration positions, the first rotating camera assembly including a first camera body, a first camera, a first camera rotation mechanism, and a first camera angle-measuring system; placing a second camera platform in the environment, the second camera platform including a second platform base, a second rotating camera assembly, and a second collection of calibration marks having second calibration positions, the second rotating camera assembly including a second camera body, a second camera, a second camera rotation mechanism, and a second camera angle-measuring system; rotating the first camera rotating assembly with the first rotation mechanism to a first angle to face the first collection of calibration marks; measuring the first angle with the first camera angle-measuring system; capturing a first image of the second collection of calibration marks; rotating the second camera rotating assembly with the second rotation mechanism to a second angle to face the second collection of calibration marks; capturing a second image of the first collection of calibration marks; and determining a first pose of the second rotating camera assembly relative to the first rotating camera assembly based at least in part on the measured first angle, the first image, the measured second angle, the second image, the first calibration positions, and the second calibration positions.

In a further embodiment, in the step of placing a first camera platform in an environment, the first calibration marks include light-emitting diodes (LEDs).

In a further embodiment, in the step of placing a first camera platform in an environment, the first calibration marks include reflective dots.

In an embodiment, a measurement method includes: providing a three-dimensional (3D) measuring system in a device frame of reference, the 3D measuring system including a 3D measuring device, a first rotating camera assembly, and a second rotating camera assembly, the 3D measuring system including a body, a collection of light marks, and a measuring probe, the collection of light marks and the measuring probe attached to the body, the light marks having calibrated 3D coordinates in the device frame of reference, the measuring probe configured to determine 3D coordinates of points on an object in the device frame of reference; the first rotating camera assembly having a first camera, a first rotation mechanism, and a first angle-measuring system; the second rotating camera assembly having a second camera, a second rotation mechanism, and a second angle-measuring system; in a first instance: rotating the first camera with the first rotation mechanism to face the collection of light marks; rotating the second camera with the second rotation mechanism to face the collection of light marks; measuring with the first angle-measuring system the first angle of rotation of the first camera; measuring with the second angle-measuring system the second angle or rotation of the second camera; capturing with the first camera a first image of the collection of light marks; capturing with the second camera a second image of the collection of light marks; determining 3D coordinates of a first object point on the object in the device frame of reference; and determining 3D coordinates of the first object point in an environment frame of reference based at least in part on the first angle of rotation in the first instance, the second angle of rotation in the first instance, the first image in the first instance, the second image in the first instance, and the 3D coordinates of the first object point in the device frame of reference in the first instance.

In a further embodiment, the measurement method further includes: in a second instance: moving the 3D measuring device; rotating the first camera with the first rotation mechanism to face the collection of light marks; rotating the second camera with the second rotation mechanism to face the collection of light marks; measuring with the first angle-measuring system the first angle of rotation of the first camera; measuring with the second angle-measuring system the second angle or rotation of the second camera; capturing with the first camera a first image of the collection of light marks; capturing with the second camera a second image of the collection of light marks; determining 3D coordinates of a first object point on the object in the device frame of reference; and determining 3D coordinates of the second object point in the environment frame of reference based at least in part on the first angle of rotation in the second instance, the second angle of rotation in the second instance, the first image in the second instance, the second image in the second instance, and the 3D coordinates of the first object point in the device frame of reference in the second instance.

In a further embodiment, in the step of providing a 3D measuring system in a device frame of reference, the measuring probe is a tactile probe.

In a further embodiment, in the step of providing a 3D measuring system in a device frame of reference, the measuring probe includes a spherical probe tip.

In a further embodiment, in the step of providing a 3D measuring system in a device frame of reference, the measuring probe is a line scanner that measures 3D coordinates.

In a further embodiment, in the step of providing a 3D measuring system in a device frame of reference, the 3D measuring device is a handheld device.

In a further embodiment, in the step of providing a 3D measuring system in a device frame of reference, the 3D measuring device is attached to a motorized apparatus.

In an embodiment, a three-dimensional (3D) measuring system includes: a rotating camera-projector assembly including a camera-projector body, a projector, a first camera, a camera-projector rotation mechanism, and a camera-projector angle measuring system, the camera-projector assembly including a projector and a first camera, the projector configured to project a first illuminated pattern onto an object, the first camera including a first camera lens, a first photosensitive array, and a first camera perspective center, the first camera configured to capture a first image of first illuminated pattern on the object, the camera-projector rotation mechanism configured to rotate the first camera and the projector about a camera-projector first axis by a camera-projector rotation angle and about a camera-projector second axis by a camera-projector rotation angle, the camera-projector angle measuring system configured to measure a camera-projector first rotation angle and a camera-projector second rotation angle; and a second rotating camera assembly including a second camera body, a second camera, a second camera rotation mechanism, and a second camera angle measuring system, the second camera including a second camera lens, a second photosensitive array, and a second camera perspective center, the second camera configured to capture the a second image of the first illuminated pattern on the object, the second camera rotation mechanism configured to rotate the second camera about a second camera first axis by a second camera first rotation angle and a second camera second axis by a second camera second rotation angle, the second camera angle measuring system configured to determine a second camera first angle and a second camera second angle, wherein the 3D measuring system is configured to determine 3D coordinates of the object based at least in part on the first illuminated pattern, the first image, the second image, the camera-projector first angle of rotation, the camera-projector second angle of rotation, the second camera first angle of rotation, the second camera second angle of rotation, and a pose of the second camera relative to the first camera.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A three-dimensional (3D) measuring system comprising:
a body;
an internal projector fixedly attached to the body, the internal projector configured to project an illuminated pattern of light onto an object; and
a first dichroic camera assembly fixedly attached to the body, the first dichroic camera assembly having a first beam splitter configured to direct a first portion of incoming light into a first channel leading to a first photosensitive array and to direct a second portion of the incoming light into a second channel leading to a second photosensitive array, the first photosensitive array being configured to capture a first channel image of the illuminated pattern on the object, the second photosensitive array being configured to capture a second channel image of the illuminated pattern on the object, the first dichroic camera assembly having a first pose relative to the internal projector,
wherein the 3D measuring system is configured to determine 3D coordinates of a first point on the object based at least in part on the illuminated pattern, the second channel image, and the first pose.

2. The 3D measuring system of claim 1 wherein the first portion and the second portion are directed into the first channel and the second channel, respectively, based at least in part on the wavelengths present in the first portion and the wavelengths present in the second portion.

3. The 3D measuring system of claim 2 further comprising a first lens between the first beam splitter and the first photosensitive array and a second lens between the first beam splitter and the second photosensitive array.

4. The 3D measuring system of claim 3 wherein the focal length of the first lens is different than the focal length of the second lens.

5. The 3D measuring system of claim 3 wherein the field-of-view (FOV) of the first channel is different than the FOV of the second channel.

6. The 3D measuring system of claim 3 wherein the 3D measuring system is configured to identify a first cardinal point in a first instance of the first channel image and to further identify the first cardinal point in a second instance of the first channel image, the second instance of the first channel image being different than the first instance of the first channel image.

7. The 3D measuring system of claim 6 wherein the first cardinal point is based on a feature selected from the group consisting of: a natural feature on or near the object, a spot of light projected onto or near to the object from a light source not attached to the body, and a marker placed on or near the object, a light source placed on or near the object.

8. The 3D measuring system of claim 6 wherein the 3D measuring system is further configured to register the first instance of the first channel image to the second instance of the first channel image.

9. The 3D measuring system of claim 8 wherein the 3D measuring system is configured to determine a first pose of the 3D measuring system in the second instance relative to a first pose of the 3D measuring system in the first instance.

10. The 3D measuring system of claim 8 wherein the first channel has a larger field-of-view (FOV) than the second channel.

11. A measurement method comprising:
placing a first rotating camera assembly at a first environment location in an environment, the first rotating camera assembly including a first camera body, a first camera, a first camera rotation mechanism, and a first camera angle-measuring system;
placing a second rotating camera assembly at a second environment location in the environment, the second rotating camera assembly including a second camera body, a second camera, a second camera rotation mechanism, and a second camera angle-measuring system;
in a first instance:
moving a three-dimensional (3D) measuring device to a first device location in the environment, the 3D measuring device having a device frame of reference, the 3D measuring device fixedly attached to a first target and a second target;
rotating with the first camera rotation mechanism the first rotating camera assembly to a first angle to face the first target and the second target;
measuring the first angle with the first camera angle-measuring system;
capturing a first image of the first target and the second target with the first camera;
rotating with the second camera rotation mechanism the second rotating camera assembly to a second angle to face the first target and the second target;
measuring the second angle with the second camera angle-measuring system;
capturing a second image of the first target and the second target with the second camera;
measuring, with the 3D measuring device, first 3D coordinates in the device frame of reference of a first object point on an object;
determining 3D coordinates of the first object point in a first frame of reference based at least in part on the first image, the second image, the measured first angle, the measured second angle, and the measured first 3D coordinates, the first frame of reference being different than the device frame of reference;
in a second instance:
moving the 3D measuring device to a second device location in the environment;
capturing a third image of the first target and the second target with the first camera;
capturing a fourth image of the first target and the second target with the second camera;
measuring, with the 3D measuring device, second 3D coordinates in the device frame of reference of a second object point on the object;
determining 3D coordinates of the second object point in the first frame of reference based at least in part on the third image, the fourth image, and the measured second 3D coordinates; and
storing the 3D coordinates of the first object point and the second object point in the first frame of reference.

12. The measurement method of claim 11 wherein:
in the step of moving a three-dimensional (3D) measuring device to a first device location in the environment, the 3D measuring device is further fixedly attached to a third target;
in the first instance:
the step of rotating with the first camera rotation mechanism further includes rotating the first rotating camera assembly to face the third target;
in the step of capturing a first image of the first target and the second target with the first camera, the first image further includes the third target;
the step of rotating with the second camera rotation mechanism further includes rotating the second rotating camera assembly to face the third target;
in the step of capturing a second image of the first target and the second target with the second camera, the second image further includes the third target;
in the second instance:
in the step of capturing a third image of the first target and the second target with the first camera, the third image further includes the third target; and
in the step of capturing a fourth image of the first target and the second target with the second camera, the fourth image further includes the third target.

13. The measurement method of claim 11 wherein, in the second instance:
a further step includes rotating with the first camera rotation mechanism the first rotating camera assembly to a third angle to face the first target and the second target;
a further step includes rotating with the second camera rotation mechanism the second rotating camera assembly to a fourth angle to face the first target and the second target;
in the step of determining 3D coordinates of the second object point in the first frame of reference, the 3D coordinates of the second object point in the first frame of reference are further based on the third angle and the fourth angle.

14. The measurement method of claim 11 wherein:
in the step of moving a three-dimensional (3D) measuring device to a first device location in the environment, the 3D measuring device further includes a two-axis inclinometer;
in the first instance:
a further step includes measuring a first inclination with the two-axis inclinometer;
the step of determining 3D coordinates of the first object point in a first frame of reference is further based on the measured first inclination;
in the second instance:
a further step includes measuring a second inclination with the two-axis inclinometer; and
the step of determining 3D coordinates of the second object point in the first frame of reference is further based on the measured second inclination.

15. The measurement method of claim 11 wherein:
in the step of placing a first rotating camera assembly at a first environment location in an environment, the first camera includes a first camera lens, a first photosensitive array, and a first camera perspective center;
in the step of placing a first rotating camera assembly at a first environment location in an environment, the first camera rotation mechanism is configured to rotate the first rotating camera assembly about a first axis by a first rotation angle and about a second axis by a second rotation angle; and
in the step of placing a first rotating camera assembly at a first environment location in an environment, the first camera angle-measuring system further includes a first angle transducer configured to measure the first rotation angle and a second angle transducer configured to measure the second rotation angle.

16. The measurement method of claim 15 wherein, in the step of measuring the first angle with the first camera angle-measuring system, the first angle is based at least in part on the measured first rotation angle and the measured second rotation angle.

17. The measurement method of claim 11 further including steps of:
capturing with the first camera one or more first reference images of a plurality of reference points in the environment, there being a known distance between two of the plurality of reference points;
capturing with the second camera one or more second reference images of the plurality of reference points;
determining a first reference pose of the first rotating camera assembly in an environment frame of reference based at least in part on the one or more first reference images and on the known distance; and
determining a second reference pose of the second rotating camera assembly in an environment frame of reference based at least in part on the one or more second reference images and on the known distance.

18. The measurement method of claim 17 further comprising: determining 3D coordinates of the first object point and the second object point in the first frame of reference further based on the first reference pose and the second reference pose.

19. The measurement method of claim 11 wherein, in the step of moving a three-dimensional (3D) measuring device to a first device location in the environment, the 3D measuring device is attached to a first mobile platform.

20. The measurement method of claim 19 wherein the first mobile platform further comprises first motorized wheels.
